(19) United States
(12) Patent Application Publication
(10) Pub. No.: US 2025/0280891 A1
(43) Pub. Date: Sep. 11, 2025

(54) AEROSOL-GENERATING DEVICES AND METHODS FOR CONTROLLING THE SAME ACCORDING TO AUTHORIZED OPERATOR PROBABILITY

(71) Applicant: Altria Client Services LLC, Richmond, VA (US)

(72) Inventors: Rangaraj S. SUNDAR, Midlothian, VA (US); Raymond W. LAU, Glen Allen, VA (US); Terry BACHE, Richmond, VA (US); Eric HAWES, Midlothian, VA (US); Tristan HUGHES, Sandy (GB); James YORKSHADES, Gamlingay (GB)

(73) Assignee: Altria Client Services LLC, Richmond, VA (US)

(21) Appl. No.: 19/073,445

(22) Filed: Mar. 7, 2025

Related U.S. Application Data
(60) Provisional application No. 63/563,048, filed on Mar. 8, 2024.

(51) Int. Cl. A24F 40/49; A24F 40/50; A24F 40/65

(52) U.S. Cl. CPC A24F 40/49; A24F 40/50; A24F 40/65

(57) ABSTRACT

A device includes memory configured to store computer-readable instructions, and processing circuitry configured to execute the computer-readable instructions which causes the device to determine a plurality of behavior metrics based on behavior information, determine a probability that a current operator of an aerosol-generating device is an authorized operator based on the plurality of behavior metrics, and disable an aerosol-generation operation of the aerosol-generating device in response to determining the probability is less than a threshold.

### CROSS-REFERENCE TO RELATED APPLICATION

This application is based on and claims priority U.S. Provisional Application No. 63/563,048 filed on Mar. 8, 2024, the disclosure of which is incorporated by reference herein in its entirety.

### BACKGROUND

### Field

At least some example embodiments provide for aerosol-generating devices, systems including the aerosol-generating devices, methods for controlling an aerosol-generating device, and/or non-transitory computer readable media for controlling the aerosol-generating device.

### DESCRIPTION OF RELATED ART

Aerosol-generating devices are available that are capable of generating an aerosol by heating an aerosol generating substrate, such as a plant material, etc. It is desired that operation of such aerosol-generating devices may be limited to only authorized operators. For example, in accordance with various governmental statutory requirements, medical guidelines, prescription information, etc., approaches are being developed for guarding against operation of aerosol-generating devices by operators other that the authorized operators.

Existing approaches for controlling aerosol-generating devices to be operated by only authorized operators involve frequent connections by operators to external servers for validation and/or authentication (e.g., age validation). However, such existing approaches are burdensome on operators of the aerosol-generating devices and may not decrease and/or prevent operation of the aerosol-generating devices by unauthorized operators.

### SUMMARY

According to at least some example embodiments, a device is provided including memory configured to store computer-readable instructions, and processing circuitry configured to execute the computer-readable instructions which causes the device to determine a plurality of behavior metrics based on behavior information, determine a probability that a current operator of an aerosol-generating device is an authorized operator based on the plurality of behavior metrics, and disable an aerosol-generation operation of the aerosol-generating device in response to determining the probability is less than a threshold.

According to at least some example embodiments, a method for controlling an aerosol-generating device is provided, the method including determining a plurality of behavior metrics based on behavior information, determining a probability that a current operator of the aerosol-generating device is an authorized operator based on the plurality of behavior metrics, and disabling an aerosol-generation operation of the aerosol-generating device in response to determining the probability is less than a threshold.

### BRIEF DESCRIPTION OF THE DRAWINGS

The various features and advantages of some example embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a top right, front perspective view of an aerosol-generating device in accordance with some example embodiments.

FIG. 2 is a top right, front perspective view of the aerosol-generating device illustrated in FIG. 1, including a capsule.

FIG. 3 is a block diagram of an aerosol-generating device according to some example embodiments.

FIG. 4 is a diagram illustrating an example communication system in which the aerosol-generating device 100 may operate according to at least some example embodiments.

FIG. 5 is a block diagram illustrating a second server according to at least some example embodiments.

FIG. 6 is a block diagram illustrating a hardware and software architecture of the aerosol-generating device 100 according to at least some example embodiments.

FIG. 7 is a flowchart illustrating a method for controlling an aerosol-generating device according to a probability that a current operator of the aerosol-generating device is an authorized operator, according to at least some example embodiments.

FIG. 8, illustrates a process performed between a capsule 200 and the aerosol-generating device 100 for determining whether the capsule 200 is genuine using a key/identifier according to at least some example embodiments.

FIG. 9 illustrates a process for determining whether a capsule 200 is genuine based on a chain of custody of the capsule 200 according to at least some example embodiments.

FIG. 10 illustrates a graph for use in illustrating how a capsule 200 is determined to be genuine based on serial or batch information according to at least some example embodiments.

FIG. 11 illustrates a process for determining whether a capsule 200 is genuine based on a type and/or flavor of the capsule 200 according to at least some example embodiments.

FIG. 12 is a diagram illustrating time windows in connection with generating and updating the authorized operating pattern model according to at least some example embodiments.

FIG. 13 is a diagram illustrating a process for controlling the operation of an aerosol-generating device 100 using a plurality of thresholds according to at least some example embodiments.

FIG. 14 is a flowchart illustrating example triggers for performing operations 1910, 1920 and/or 1930, according to at least some example embodiments.

FIG. 15 a flowchart illustrating an example process for iteratively adjusting a behavior score according to various behavior metrics as discussed further in connection with operations 1910 and 1920, according to at least some example embodiments.

FIG. 16 is a flowchart illustrating an example process for iteratively adjusting a behavior score according to various behavior metrics in response to detection of a new capsule, according to at least some example embodiments.

FIG. 17 is a flowchart illustrating an example process for adjusting one or more behavior thresholds (as discussed further in connection with operation 1920), according to at least some example embodiments.

FIG. 18 is a flowchart illustrating an example process for determining the operation pattern metric based on the operating pattern model, and performing operation 1920 based on the operation pattern metric, according to at least some example embodiments.

FIG. 19 is a flowchart illustrating an example process for determining the operation pattern metric based on the puff profile model, and performing operation 1920 based on the operation pattern metric, according to at least some example embodiments.

FIG. 20 is a flowchart illustrating an example process for generating the puff profile model, and performing operations 1910 and 1920 based on the trained puff profile model, according to at least some example embodiments.

FIG. 21 is a flowchart illustrating an example process for determining the companion application connection metric, and performing operation 1920 based on the companion application connection metric, according to at least some example embodiments.

FIG. 22 is a flowchart illustrating an example process for restoring a disabled aerosol-generating device to operability, according to at least some example embodiments.

FIG. 23 is a diagram of a cloud system for use in implementing a blockchain, according to at least some example embodiments.

FIG. 24 is a diagram illustrating a process for generating blocks of a blockchain, according to at least some example embodiments.

FIG. 25 is a diagram illustrating a process for implementing a proof-of-stake blockchain validation, according to at least some example embodiments.

FIG. 26 is a diagram illustrating block validation using the cloud network, according to at least some example embodiments.

### DETAILED DESCRIPTION

According to at least some example embodiments, an aerosol-generating device and method for controlling the same may be provided. For example, the aerosol-generating device may determine a probability (e.g., a behavior score) that a current operator of the aerosol-generating device is an authorized operator based on a plurality of behavior metrics. The plurality of behavior metrics may be based on data (e.g., behavior information) collected by the aerosol-generating device. The aerosol-generating device may collect the data from sources internal and/or external with respect to the aerosol-generating device. According to at least some example embodiments, the aerosol-generating device may be configured to update (e.g., increase or decrease) the probability based on the behavior metrics. The behavior metrics may be based on, for example, an indication that an age verification has been performed, an amount of time elapsed, an indication of whether a capsule inserted into the aerosol-generating device is genuine, an indication of whether a capsule inserted into the aerosol-generating device was purchased from a trusted entity, one or more properties of an aerosol-forming substrate such as, for example, the type or amount of its components (e.g., type of compound(s), strength, or flavor), a determination of whether a recent operating pattern of the aerosol-generating device matches a historical operating pattern, a determination of whether signal traffic information from local communication networks/devices corresponds to stored identifiers of networks/devices, whether the aerosol-generating device has connected with an application operating on an external device (e.g., a mobile device), etc. The aerosol-generating device may compare the probability to a plurality of thresholds, and perform further functions according to a value of the probability with respect to respective values of the thresholds. The further functions may include, for example, enabling performance of an aerosol-generation operation, outputting a notification to a display, reducing a capability of the aerosol-generation device, disabling the aerosol-generation device, etc.

Existing aerosol-generating devices, and methods for controlling such devices, rely on the control of external devices to determine operability of the existing devices. For example, existing devices depend on an unlocking signal received from an external device, such an external server, in order to perform an aerosol-generation operation. Such an external server may provide the unlocking signal in response to, for example, a successful age validation process performed with the external server. As a result, the existing device may be locked via a signal received from the external device at a frequent rate, compelling an operator of the existing devices to frequently interact with the external device to restore aerosol-generation functionality. This interaction is excessively burdensome on the operator of the existing devices, resulting in an unsatisfactory experience in using the existing devices. Also, the existing devices rely on excessive network communications resulting in higher resource consumption (e.g., network bandwidth and/or signaling).

However, according to at least some example embodiments, improved aerosol-generating devices, and methods for controlling the same, are provided. For example, the improved devices may determine an authorized operator probability, representing a likelihood that a current operator of the improved devices is an authorized operator, and disable (e.g., prevent, block, lock, impede, etc.) aerosol-generating functionality when this probability falls below a behavior threshold. The improved devices may determine the authorized operator probability based on internal and/or external factors without having the operator interact and/or directly interact with an external server. For example, the improved devices may determine the authorized operator probability based on a determination of whether the operator's operation of the improved devices is consistent with previous operation of the device. Such determinations may be performed as background processes on the improved devices and may be invisible to the operator. Accordingly, the improved devices may maintain normal functionality without any (or with fewer and/or less frequent) inputs from the operator (for example, without the operator being compelled to perform age verification and/or authentication with an external server). Therefore, the improved devices and methods overcome the deficiencies of the existing devices and methods to at least reduce the interaction burden on the operator, thereby improving device operation experience, and/or reducing resource consumption associated with network communications (e.g., reduction of reliance on network connectivity, reduction of network bandwidth consumption and/or reduction of the number of signaling messages).

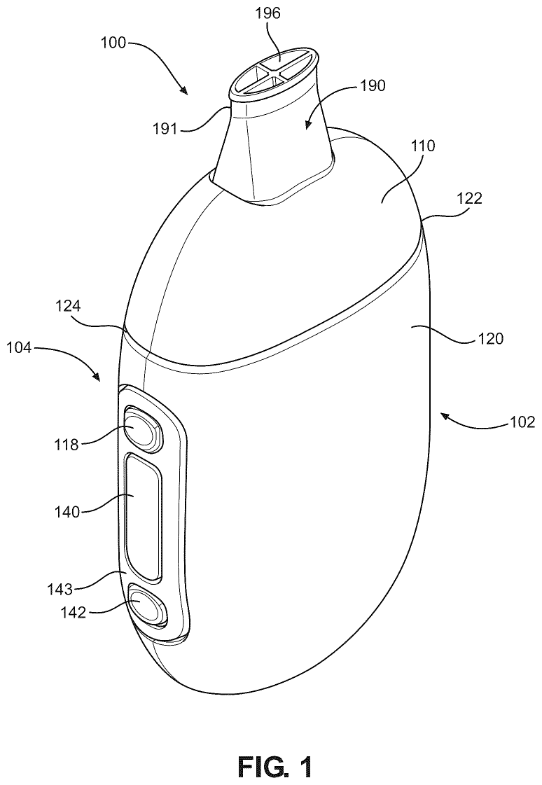

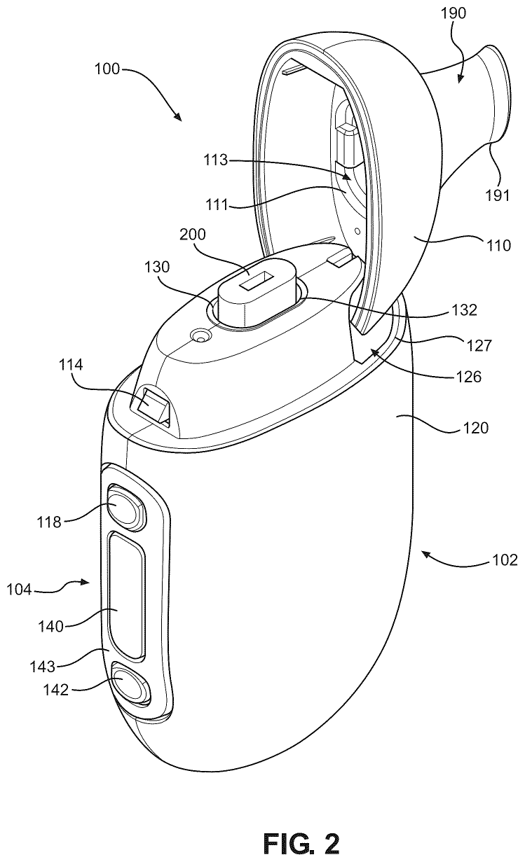

FIGS. 1-2 are illustrations of an aerosol-generating device 100 (e.g., a heat-not-burn (HNB) aerosol-generating device) in accordance with some example embodiments. While primary reference and illustration are made herein to the aerosol-generating device 100 being a heat-not-burn (HNB) aerosol-generating device, it is similarly contemplated that the aerosol-generating device 100 may additionally or alternatively be one or more other types of devices and/or inhalable devices for producing an inhalable substance from a consumable, such as, for example, an e-vapor device or a not-heated inhalable device. As used herein, a heat-not-burn device refers to a device configured to heat a consumable (e.g., an aerosol-forming substrate contained in a capsule) without igniting the consumable to yield the inhalable aerosol. As used herein, an e-vapor device refers to a device configured to vaporize a consumable (e.g., a pre-vapor formulation contained in a cartridge) to yield the inhalable aerosol (e.g., vapor). As used herein, a not-heated inhalable device refers to a device configured to disperse a material (e.g., a powder, a liquid, etc.) without using heat (e.g., via vibrations, pressurized release, etc.) to drive the generation of an inhalable dispersion of the material. For exemplary convenience, primary reference will now be made herein to the aerosol-generating device 100 as an aerosol-generating device 100 being a heat-not-burn aerosol-generating device, but the example embodiments are not limited thereto, and for example, the aerosol-generating device 100 may be an e-vapor device, a not-heated inhalable device, etc. For example, FIG. 1 is a top perspective view of the aerosol-generating device 100, where the lid 110 is closed. FIG. 2 is a bottom perspective view of the aerosol-generating device 100, where the lid 110 is closed.

As illustrated, in some example embodiments, the aerosol-generating device 100 has a general oblong or pebble shape and a replaceable mouthpiece 190 that extends from the main body of the aerosol-generating device 100. For example, the aerosol-generating device 100 may include a housing 120 that defines a capsule-receiving cavity 130 (as shown in FIG. 2). Additionally, a lid 110 is configured to open/close relative to the housing 120 and is coupleable to the replaceable mouthpiece 190. For example, the lid 110 may be fixedly coupled to the housing 120 at a first point 122 and releasably coupleable to the housing 120 at a second point 124. The first point 122 of the housing 120 may be on a first side 102 of the device 100. The second point 124 of the housing 120 may be on a second side 104 of the aerosol-generating device 100. In some instances, the lid 110 may also be referred to as a door. An exterior of the housing 120 and/or lid 110 may be formed from a metal (such as aluminum, stainless steel, and the like); an aesthetic, food contact rated plastic (such as, a polycarbonate (PC), acrylonitrile butadiene styrene (ABS) material, liquid crystalline polymer (LCP), a copolyester plastic, or any other suitable polymer and/or plastic); or any combination thereof. The replaceable mouthpiece 190 may be similarly formed from a metal (such as aluminum, stainless steel, and the like); an aesthetic, food contact rated plastic (such as, a polycarbonate (PC), acrylonitrile butadiene styrene (ABS) material, liquid crystalline polymer (LCP), a copolyester plastic, or any other suitable polymer and/or plastic); and/or plant-based materials (such as wood, bamboo, and the like). One or more interior surfaces or the housing 120 and/or lid 110 may be formed from or coated with a high temperature plastic (such as, polyetheretherketone (PEEK), liquid crystal polymer (LCP), or the like). The lid 110 and the housing 120 may be collectively regarded as the main body of the aerosol-generating device 100.

In at least one example embodiment, the replaceable mouthpiece 190 may be tapered between a first end and a second end thereof. For example, the diameter or average length/width dimensions of the first end may be smaller than the diameter or average length/width dimensions of the second end. Towards the first end, the taper may have a slight inward curvature 191 that is configured to receive the lips of an adult consumer and improve the comfort and experience.

The lid 110 may be fixedly coupled to the housing 120 at the first point 122 by a hinge, or other similar connector, that allows the lid 110 to move (e.g., swing and rotate) from an open position (such as illustrated in FIG. 2) to a closed position (such as illustrated in FIG. 1). In some example embodiments, such as illustrated in FIG. 2, the housing 120 includes a recess 126 at the first point 122. The recess 126 may be configured to receive a portion of the lid 110 so as to allow for an easy and smooth movement of the lid 110 from the open position to the closed position (and vice versa). The recess 126 may have a structure that corresponds with a relative portion of the lid 110. For example, as illustrated, the recess 126 may include a substantially curved portion 127 that has a general concave shape that corresponds with the curvature of the lid 110, which has a general convex shape.

The lid 110 may be releasably coupleable to the housing 120 at the second point 124 by a latch 114, or other similar connector, that allows the lid 110 to be fixed or secured in the closed position and easily releasable so as to allow the lid 110 to move from the secured closed position to the open position. In some example embodiments, the latch 114 may be coupled to a latch release mechanism. The latch release mechanism may be configured to move the latch 114 from a first or closed position to a second or open position.

In some example embodiments, such as illustrated in FIGS. 1-2, the latch release mechanism is in communication with a latch release button 118 that is configured to activate the latch release mechanism—i.e., to move the latch 114 from the first or closed or secured position to the second or pressure-applying position and to move/return the latch 114 from the open position to the secured or closed position. In some example embodiments, the latch release button 118 is an adult consumer interaction button disposed on the second side 104 of the aerosol-generating device 100. For example, when the latch release button 118 is pressed by the adult consumer, a latch release mechanism may move from the first or closed or secured position to the second or pressure-applying position so as to move the latch 114 from the secured or closed position to the open position. The latch release button 118 may have a substantially circular shape with a center depression or dimple configured to direct the pressure applied by the adult consumer, although some example embodiments are not limited thereto. One or more sensors (not shown) configured to detect the lid 110 opening and closure may be embedded or otherwise disposed within the housing 120 and/or one or more of the elements therein (e.g., latch 114, latch release mechanism and/or latch release button 118).

In some example embodiments, the housing 120 includes a consumer interface panel 143 disposed on the second side 104 of the device 100. For example, the consumer interface panel 143 may be an oval-shaped panel that runs along the second side 104 of the device 100. The consumer interface panel 143 may include the latch release button 118, such as discussed above, as well as a communication screen 140 and/or a power button 142. For example, in some example embodiments, the consumer interface panel 143 may include the communication screen 140 disposed between the latch release button 118 and the power button 142. As illustrated, the latch release button 118 may be disposed towards a top of the aerosol-generating device 100, and the power button 142 may be disposed towards the bottom of the aerosol-generating device 100. Like the latch release button 118, the power button 142 may also be an adult consumer interaction button. The power button 142 may have a substantially circular shape with a center depression or dimple configured to direct the pressure applied by the adult consumer, although some example embodiments are not limited thereto. The power button 142 may turn on and off the aerosol-generating device 100. Though only the two buttons are illustrated, it should be understood more or less buttons may be provided depending on the available features and desired adult consumer interface.

In some example embodiments, the communication screen 140 is an integrated thin-film transistor (“TFT”) screen. In some example embodiments, the communication screen 140 is an organic light emitting diode (“OLED”) or light emitting diode (“LED”) screen. The communication screen 140 is configured for adult consumer engagement and may have a generally oblong shape.

In some example embodiments, the housing 120 encloses a capsule connector 132. Additionally, in some instances, the capsule connector 132 may be mounted or otherwise secured to a printed circuit board (PCB) within the housing 120. In some example embodiments, the capsule connector 132 defines the capsule-receiving cavity 130.

In at least some example embodiments, the capsule connector 132 includes one or more electrical connectors or contacts. Such electrical contacts are configured to apply current or other electrical signals to a capsule 200 received by the capsule-receiving cavity 130. In some example embodiments, the electrical contacts may be in electrical communication with a power source and/or control circuitry disposed within the housing 120. The electrical contacts may be formed of copper or of a copper alloy (e.g., copper-titanium) with the option of also having a gold plating. In some example embodiments, the electrical contacts may extend into the capsule-receiving cavity 130, such that the electrical contacts may make contact with the capsule 200 therein.

The capsule 200 is loaded into the aerosol-generating device 100 by initially inserting the capsule 200 into the capsule-receiving cavity 130 defined by the capsule connector 132. In some example embodiments, the capsule 200 makes contact (e.g., full contact) with the electrical contacts within capsule-receiving cavity 130 only upon the application of force (e.g., downward/inward force) to the capsule 200. In some example embodiments, a force is applied to the capsule 200 by the closure and/or latching of the lid 110. In some example embodiments, a force is applied to the capsule 200 by an adult consumer. In some example embodiments, a force is applied by a combination of pressure applied by the adult consumer and the closure and/or latching of the lid 110. For example, in each instance, a forced is applied until a resistance is felt and/or a clicking sound is heard, which signals a complete engagement of the capsule 200 in the capsule-receiving cavity 130.

The underside of the lid 110 may include an impingement/engagement member or surface 113 configured to engage the capsule 200 when the lid 110 is pivoted to transition to a closed position. The impingement/engagement member or surface 113 of the lid 110 may include a recess (e.g., that corresponds to the size and shape of the capsule 200) and/or a resilient material to enhance an interface with the capsule 200 so as to provide the desired seal. The capsule 200 may simply rest on the exposed pins of the electrical contacts without any compression (or without any significant compression). Additionally, the weight of the lid 110 itself, when pivoted to transition to a closed position, may not compress the electrical contacts to any significant degree and, instead, may simply rest on the capsule 200 in an intermediate, partially open/closed position. In such an instance, a deliberate action (e.g., downward force) to close the lid 110 will cause the impingement/engagement member or surface 113 of the lid 110 to press down onto the capsule 200 to provide a seal and also cause the capsule 200 to compress and, thus, fully engage electrical contacts. Additionally, a full closure of the lid 110 will result in an engagement with the latch 114, which will maintain the closed position and mechanical/electrical engagements involving the capsule 200 until released (e.g., via the latch release button 118).

As discussed herein, an aerosol-forming substrate is a material or combination of materials that may yield an aerosol. An aerosol relates to the matter generated or output by the devices disclosed, claimed, and equivalents thereof. The material may include a compound (e.g., nicotine, cannabinoid), wherein an aerosol including the compound is produced when the material is heated. The heating may be below the combustion temperature so as to produce an aerosol without involving a substantial pyrolysis of the aerosol-forming substrate or the substantial generation of combustion byproducts (if any). Thus, in some example embodiments, pyrolysis does not occur during the heating and resulting production of aerosol. In other instances, there may be some pyrolysis and combustion byproducts, but the extent may be considered relatively minor and/or merely incidental.

The aerosol-forming substrate may be a fibrous material. For instance, the fibrous material may be a botanical material. The fibrous material is configured to release a compound when heated. The compound may be a naturally occurring constituent of the fibrous material. For instance, the fibrous material may be plant material such as tobacco, and the compound released may be nicotine. The term “tobacco” includes any tobacco plant material including tobacco leaf, tobacco plug, reconstituted tobacco, compressed tobacco, shaped tobacco, or powder tobacco, and combinations thereof from one or more species of tobacco plants, such as Nicotiana rustica and Nicotiana tabacum.

In some example embodiments, the tobacco material may include material from any member of the genus Nicotiana. In addition, the tobacco material may include a blend of two or more different tobacco varieties. Examples of suitable types of tobacco materials that may be used include, but are not limited to, flue-cured tobacco, Burley tobacco, Dark tobacco, Maryland tobacco, Oriental tobacco, rare tobacco, specialty tobacco, blends thereof, and the like. The tobacco material may be provided in any suitable form, including, but not limited to, tobacco lamina, processed tobacco materials, such as volume expanded or puffed tobacco, processed tobacco stems, such as cut-rolled or cut-puffed stems, reconstituted tobacco materials, blends thereof, and the like. In some example embodiments, the tobacco material is in the form of a substantially dry tobacco mass. Furthermore, in some instances, the tobacco material may be mixed and/or combined with at least one of propylene glycol, glycerin, sub-combinations thereof, or combinations thereof.

The compound released may also be a naturally occurring constituent of a medicinal plant that has a medically-accepted therapeutic effect. For instance, the medicinal plant may be a cannabis plant, and the compound may be a cannabinoid. Cannabinoids interact with receptors in the body to produce a wide range of effects. As a result, cannabinoids have been used for a variety of medicinal purposes (e.g., treatment of pain, nausea, epilepsy, psychiatric disorders). The fibrous material may include the leaf and/or flower material from one or more species of cannabis plants such as Cannabis sativa, Cannabis indica, and Cannabis ruderalis. In some instances, the fibrous material is a mixture of 60-80% (e.g., 70%) Cannabis sativa and 20-40% (e.g., 30%) Cannabis indica.

Examples of cannabinoids include tetrahydrocannabinolic acid (THCA), tetrahydrocannabinol (THC), cannabidiolic acid (CBDA), cannabidiol (CBD), cannabinol (CBN), cannabicyclol (CBL), cannabichromene (CBC), and cannabigerol (CBG). Tetrahydrocannabinolic acid (THCA) is a precursor of tetrahydrocannabinol (THC), while cannabidiolic acid (CBDA) is precursor of cannabidiol (CBD). Tetrahydrocannabinolic acid (THCA) and cannabidiolic acid (CBDA) may be converted to tetrahydrocannabinol (THC) and cannabidiol (CBD), respectively, via heating. In some example embodiments, heat from a heater may cause decarboxylation so as to convert the tetrahydrocannabinolic acid (THCA) in the capsule to tetrahydrocannabinol (THC), and/or to convert the cannabidiolic acid (CBDA) in the capsule to cannabidiol (CBD).

In instances where both tetrahydrocannabinolic acid (THCA) and tetrahydrocannabinol (THC) are present in the capsule, the decarboxylation and resulting conversion will cause a decrease in tetrahydrocannabinolic acid (THCA) and an increase in tetrahydrocannabinol (THC). At least 50% (e.g., at least 87%) of the tetrahydrocannabinolic acid (THCA) may be converted to tetrahydrocannabinol (THC) during the heating of the capsule. Similarly, in instances where both cannabidiolic acid (CBDA) and cannabidiol (CBD) are present in the capsule, the decarboxylation and resulting conversion will cause a decrease in cannabidiolic acid (CBDA) and an increase in cannabidiol (CBD). At least 50% (e.g., at least 87%) of the cannabidiolic acid (CBDA) may be converted to cannabidiol (CBD) during the heating of the capsule.

Furthermore, the compound released may be or may additionally include a non-naturally occurring additive that is subsequently introduced into the fibrous material. In one instance, the fibrous material may include at least one of cotton, polyethylene, polyester, rayon, combinations thereof, or the like (e.g., in a form of a gauze). In another instance, the fibrous material may be a cellulose material (e.g., non-tobacco and/or non-cannabis material). In either instance, the compound introduced may include nicotine, cannabinoids, and/or flavorants. The flavorants may be from natural sources, such as plant extracts (e.g., tobacco extract, cannabis extract), and/or artificial sources. In yet another instance, when the fibrous material includes tobacco and/or cannabis, the compound may be or may additionally include one or more flavorants (e.g., menthol, mint, vanilla). Thus, the compound within the aerosol-forming substrate may include naturally occurring constituents and/or non-naturally occurring additives. In this regard, it should be understood that existing levels of the naturally occurring constituents of the aerosol-forming substrate may be increased through supplementation. For example, the existing levels of nicotine in a quantity of tobacco may be increased through supplementation with an extract containing nicotine. Similarly, the existing levels of one or more cannabinoids in a quantity of cannabis may be increased through supplementation with an extract containing such cannabinoids.

As discussed above, while exemplary reference is made herein to a heat-not-burn device, the aerosol-generating device may additionally or alternatively be one or more other types of devices for producing an inhalable substance from a consumable, such as, for example, an e-vapor device or a not-heated inhalable device. In such instances, the aerosol-forming substrate discussed above may comprise one or more other formats, such as a pre-vapor formulation for an e-vapor device, a dispersion material for a not-heated inhalable device, etc. A pre-vapor formulation is a material or combination of materials that may be transformed into a vapor. For example, the pre-vapor formulation may be a liquid, solid, and/or gel formulation including, but not limited to, water, beads, solvents, active ingredients, ethanol, plant extracts, natural or artificial flavors, and/or vapor formers such as glycerin and propylene glycol. A dispersion material is a material or combination of materials that may be transformed into an inhalable dispersion. For example, the dispersion material may be a liquid, powder, solid, and/or gel formulation including, but not limited to, water, beads, solvents, active ingredients, ethanol, plant extracts, natural or artificial flavors, etc.

In some example embodiments, the aerosol-generating device in accordance with some example embodiments (such as, the aerosol-generating device 100 illustrated in FIGS. 1-2) is configured to heat a capsule (e.g., capsule 200) to generate an aerosol. In some example embodiments, a method of generating an aerosol may include initially loading a capsule 200 into the aerosol-generating device 100. To load the capsule 200, the lid 110 is pivoted to the open position, and the capsule 200 is inserted into the capsule-receiving cavity 130 defined by the capsule connector 132. Next, pivoting the lid 110 to the closed position such that the lid 110 engages the latch 114 and will maintain the closed position while pressing the capsule 200 further into the capsule-receiving cavity 130 to fully seat the capsule 200.

When the capsule 200 is fully seated within the capsule-receiving cavity 130, the end sections of the capsule 200 will be pressed against the electrical contacts. As a result, a relatively secure electrical connection and seal may be established with the capsule 200.

The aerosol-generating device 100 may be activated using the consumer interface panel 143 (e.g., by pressing the power button 142) and/or upon the detection of a draw event. Upon activation, an electrical current is supplied to the capsule 200 via the electrical contacts in the capsule-receiving cavity 130. Specifically, the capsule 200 includes a heater that is configured to undergo resistive heating in response to the electrical current. As a result of the resistive heating, the temperature of the aerosol-forming substrate within the capsule 200 will increase such that volatiles are released so as to generate an aerosol.

In some example embodiments, the heating of the aerosol-forming substrate within the capsule 200 may be below a combustion temperature of the aerosol-forming substrate so as to produce an aerosol without involving a substantial pyrolysis of the aerosol-forming substrate or the substantial generation of combustion byproducts (if any). Thus, in some example embodiments, pyrolysis does not occur during the heating and resulting production of aerosol. In other instances, there may be some pyrolysis and combustion byproducts, but the extent may be considered relatively minor and/or merely incidental.

Upon a draw or application of negative pressure to the aerosol-generating device 100 (e.g., via the mouthpiece 190), ambient air is drawn into the aerosol-generating device 100. The airflow enters inlet openings in the capsule 200. Inside the capsule 200, the air may flow (e.g., longitudinally) through the aerosol-forming substrate and along the plane of the heater so as to entrain the volatiles released by the aerosol-forming substrate, which results in an aerosol. Finally, the resulting aerosol passes through the outlet openings in the capsule 200 before exiting the aerosol-generating device 100 (e.g., via outlets 196 in the mouthpiece 190).

In some example embodiments, the method of use regarding the aerosol-generating device 100 may include securing the replaceable mouthpiece (e.g., replaceable mouthpiece 190) to the lid (e.g., 110). For example, the method may include inserting the replaceable mouthpiece into the opening (e.g., opening 111) of the lid when the lid is in an opened position until resistance is felt and/or a click is heard. In some example embodiments, the method of use may include replacing the replaceable mouthpiece (e.g., replaceable mouthpiece 190). Replacing the replaceable mouthpiece may including opening the lid (e.g., 110); removing a first replaceable mouthpiece from the opening (e.g., opening 111); and inserting a second replaceable mouthpiece into the opening until resistance is felt and/or a click is heard.

Although a capsule 200 has been illustrated as one example in connection with the aerosol-generating device 100, it should be understood other suitable examples are also available.

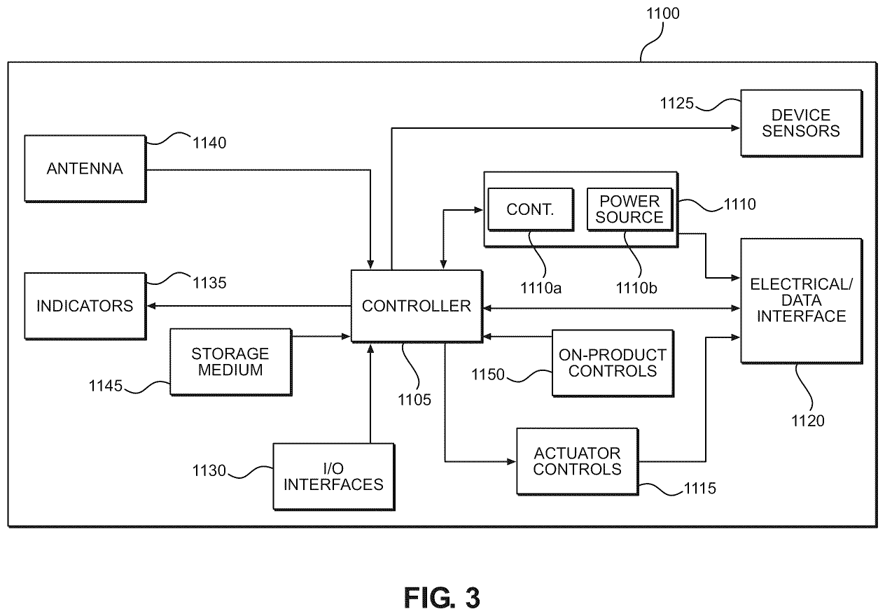

FIG. 3 is a block diagram of an aerosol-generating device according to example embodiments. The aerosol-generating device may be the aerosol-generating device 100.

As shown in FIG. 3, according to some example embodiments, a control subsystem 1100 of the aerosol-generating device 100 may include a controller 1105, a power supply 1110, actuator controls 1115, a capsule electrical/data interface 1120, device sensors 1125, input/output (I/O) interfaces 1130, aerosol indicators 1135, at least one antenna 1140, and/or a storage medium 1145, etc., but some example embodiments are not limited thereto. For example, the control subsystem 1100 may include additional elements. However, for the sake of brevity, the additional elements are not described. In some example embodiments, the capsule electrical/data interface 1120 may be an electrical interface only, etc.

The controller 1105 may be hardware including logic circuits; a hardware/software combination such as a processor executing software; or a combination thereof. For example, the controller 1105 may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

In the event where the controller 1105 is, or includes, a processor executing software, the controller 1105 is configured as a special purpose machine (e.g., a processing device) to execute the software, stored in memory accessible by the controller 1105 (e.g., the storage medium 1145 or another storage device), to perform the functions of the controller 1105. The software may be embodied as program code including instructions for performing and/or controlling any or all operations described herein as being performed by the controller 1105.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

The controller 1105 communicates with the power supply 1110, the actuator control 1115, the electrical/data interface 1120, the device sensors 1125, the input/output (I/O) interfaces 1130, the aerosol indicators 1135, on-product controls 1150, and/or the at least one antenna 1140, etc. According to some example embodiments, the on-product controls 1150 may include any device or devices capable of being manipulated manually by an adult operator to indicate a selection of a value. Example implementations include, but are not limited to, one or more buttons, a dial, a capacitive sensor, a slider, etc.

The controller 1105 (or storage medium 1145) stores key material and proprietary algorithm software for the encryption. For example, encryption algorithms rely on the use of random numbers. The security of these algorithms depends on how truly random these numbers are. These numbers are usually pre-generated and coded into the processor or memory devices. Some example embodiments may increase the randomness of the numbers used for the encryption by using aerosol drawing parameters e.g., durations of instances of aerosol drawing, intervals between instances of aerosol drawing, or combinations of thereof, to generate numbers that are more random and more varying from individual to individual than pre-generated random numbers. All communications between the controller 1105 and the capsule 200 may be encrypted.

The controller 1105 is configured to operate a real time operating system (RTOS), control the control subsystem 1100 and may be updated through reading and/or sensing update information from a tag, chip, and/or label (e.g., a security tag, a security chip, etc.) included on the capsule 200, and/or when the control subsystem 1100 is connected with other devices (e.g., a smart phone) through the I/O interfaces 1130 and/or the antenna 1140. For example, the update information may include parameter information related to the corresponding capsule, such as heater parameter information and/or heater profile information tailored and/or directed towards the aerosol-forming substrate contained within the installed capsule 200, capsule authentication update information with information relevant to the capsule authentication method (e.g., security settings related to the capsules, updates to the security keys used during authentication, etc.), programming updates, etc. Additionally, the I/O interfaces 1130 and the antenna 1140 allow the control subsystem 1100 to connect to various external devices such as smart phones, tablets, personal computers, etc. For example, the I/O interfaces 1130 may include a USB-C connector, a micro-USB connector, etc. The USB-C connector may be used by the control subsystem 1100 to charge the power source 1110b, and may also be used to transmit and/or receive data from at least one external device, such as aerosol profiles, heater profiles, device performance log data (e.g., controller performance data, memory performance data, battery performance data, heater performance data, etc.), firmware upgrades, software upgrades, etc., but some example embodiments are not limited thereto.

The controller 1105 may include on-board RAM and flash memory to store and execute code including analytics, diagnostics and software upgrades. As an alternative, the storage medium 1145 may store the code. Additionally, in another example embodiment, the storage medium 1145 may be on-board the controller 1105.

The controller 1105 may further include on-board clock, reset and power management modules to reduce an area covered by a PCB in the device body housing.

The device sensors 1125 may include a number of sensor transducers that provide measurement information to the controller 1105. The device sensors 1125 may include a power supply temperature sensor, an external capsule temperature sensor, a current sensor for the heater, power supply current sensor, airflow sensor and/or an accelerometer to monitor movement and orientation. The power supply temperature sensor and external capsule temperature sensor may be a thermistor or thermocouple and the current sensor for the heater and power supply current sensor may be a resistive based sensor or another type of sensor configured to measure current. The air flow sensor may be a pressure sensor (e.g., a capacitive pressure sensor, etc.) configured to detect positive or negative air pressure (e.g., a draw or a puff), a microelectromechanical system (MEMS) flow sensor, and/or another type of sensor configured to measure air flow such as a hot-wire anemometer. According to some example embodiments, the device sensors 1125 further includes a capsule detection sensor for detecting the presence of the capsule in the aerosol-generating device 100, and/or a door detection sensor for detecting the closure of a door and/or lid of the aerosol-generating device, but some example embodiments are not limited thereto.

The data generated from one or more of the device sensors 1125 may be detected based on a binary signal (e.g., on/off signal) using a general purpose input/output (GPIO) circuit, etc., and/or may be sampled at a sample rate appropriate to the parameter being measured using, for example, a discrete, multi-channel analog-to-digital converter (ADC), etc.

Additionally, according to some example embodiments, the device sensors may further include a tag sensor, such as a barcode sensor, a secure element (SE) reader, an optical reader, a physical parameter reader, etc. The tag sensor and/or the tag antenna (e.g., Radio-Frequency Identification (RFID) antenna, Near-Field Communication (NFC) antenna, etc.) may be used individually or in combination to detect information stored on a tag (e.g., a RFID tag, a NFC tag, a barcode tag, a SE, etc.) installed and/or attached to an exterior portion of the capsule 200, and/or may be used to detect and/or sense a physical parameter of the capsule 200, such as a resistance value of a heater included within the capsule 200, etc. The tag sensor and/or tag antenna may be arranged in physical proximity to a properly inserted capsule 200 such that information stored on the tag, such as electronic identity information, authentication information, hardware parameter information, aerosol-forming substrate information (such as aerosol-forming substrate expiration information, date of manufacture information, etc.), profile information, etc.

The controller 1105 may adapt heater profiles for an aerosol-forming substrate and other profiles based on the measurement information received from the controller 1105. For the sake of convenience, these are generally referred to as aerosol profiles. The heater profile identifies the power profile to be supplied to the heater during the few seconds when aerosol drawing takes place and/or the power profile to be supplied to the heater in between aerosol drawing instances in order to apply continual heating to the capsule (e.g., to provide an “oven mode” where a desired temperature is maintained within the capsule for a desired period of time). For example, a heater profile can deliver maximum power to the heater when an instance of aerosol drawing is initiated, but then after a second or so immediately (or promptly) reduce the power to half way or a quarter way. According to some example embodiments, the modulation of electrical power provided to the heater may be implemented using pulse width modulation, but is not limited thereto.

In addition, a heater profile can also be modified based on a detected draw and/or application of negative pressure on the aerosol-generating device 100. The use of the flow sensor allows aerosol drawing strength to be measured and used as feedback to the controller 1105 to adjust the power delivered to the heater of the capsule 200, which may be referred to as heating or energy delivery.

According to some example embodiments, when the controller 1105 recognizes the capsule 200 which is currently installed (e.g., via stock keeping unit (SKU), via a unique identifier included in a tag (e.g., RFID tag, NFC tag, etc.), etc.), the controller 1105 matches an associated heating profile that is designed for that particular capsule. The controller 1105 and the storage medium 1145 will store data and algorithms that allow the generation of heating profiles for all SKUs, capsule types, aerosol-forming substrate types, etc. In some example embodiments, the controller 1105 may read the heating profile from the capsule. Additionally, the adult operators may also adjust heating profiles to suit their preferences using the on-product controls 1150, using an external device wirelessly paired with the aerosol-generating device 100 and/or connected to the aerosol-generating device 100 via the I/O interfaces 1130, etc. In some example embodiments, the controller 1105 may use the heating profile applied for a previously installed capsule, which has been stored in memory, to a currently installed capsule based on the possibility that the current capsule may be of the same type as (or a similar type to) the previously installed capsule, etc.

The controller 1105 may send data to and receives data from the power supply 1110. The power supply 1110 includes a power source 1110b and a power controller 1110a to manage the power output by the power source 1110b.

The power source 1110b may be a Lithium-ion battery or one of its variants, for example a lithium-ion polymer battery. Alternatively, the power source 1110b may be a Nickel-metal hydride battery, a Nickel cadmium battery, a Lithium-manganese battery, a Lithium-cobalt battery or a fuel cell. Alternatively, the power source 1110b may be rechargeable and include circuitry allowing the battery to be chargeable by an external charging device. In that case, the circuitry, when charged, provides power for a desired (or alternatively a pre-determined or given) number of instances of aerosol drawing, after which the circuitry must be re-connected to an external charging device.

It should be understood that the shape of the battery (or batteries) for the power supply may vary. For example, the battery may be cylindrical, prismatic, disc-shaped, a pouch battery, or any other variation of battery shape known in the art. Additionally, it should be understood that the battery may be any of a variety of types. For example, in some example embodiments, the battery may be a rechargeable battery (e.g., lithium-ion). In some example embodiments, the battery may be a non-rechargeable battery (e.g., alkaline). In some example embodiments, the battery may include silver oxide, carbon zinc, cadmium, nickel, or any another material known in the art. Furthermore, the battery may include a primary cell and/or a secondary cell. It will be understood by those of ordinary skill in the art that various changes in form and details of the battery may be made without departing from the spirit and the scope of the inventive concepts.

The power controller 1110a provides commands to the power source 1110b based on instructions from the controller 1105. For example, the power supply 1110 may receive a command from the controller 1105 to provide power to the capsule (through the capsule electrical/data interface 1120) when the capsule is detected and the adult operator activates the control subsystem 1100 (e.g., by activating a switch such as a toggle button, capacitive sensor, IR sensor). Additionally, according to some example embodiments, the controller 1105 may transmit the command to the power supply 1110 based on the proper authentication of the capsule, but some example embodiments are not limited thereto.

In addition to supplying power to the capsule, the power supply 1110 also supplies power to the controller 1105. Moreover, the power controller 1110a may provide feedback to the controller 1105 indicating performance of the power source 1110b.

The controller 1105 sends data to and receives data from the at least one antenna 1140. The at least one antenna 1140 may include a NFC modem and a Bluetooth Low Energy (LE) modem and/or other modems for other wireless technologies (e.g., WiFi, Zigbee, Z-Wave, Matter, Thread, etc.). In some example embodiments, the communications stacks are in the modems, but the modems are controlled by the controller 1105. The Bluetooth LE modem is used for data and control communications with an application on an external device (e.g., smart phone, etc.). The NFC/Bluetooth LE/WiFi modem may be used for pairing of the aerosol-generating device 100 to the application and transmission of diagnostic information, data, profile information, capsule information, hardware parameter information, firmware updates, etc. Moreover, the Bluetooth LE/WiFi modem may be used to provide location information (for an adult operator to find the aerosol-generating device) or authentication during a purchase, etc. According to at least some example embodiments, the term “modem” as used herein may also refer to, for example, a network interface.

As described above, the control subsystem 1100 may generate and adjust various profiles for aerosol generation. The controller 1105 uses the power supply 1110 and the actuator controls 1115 to regulate the profile for the adult operator.

The actuator controls 1115 include passive and active actuators to regulate a desired aerosol profile. For example, the device body housing may include actuators within an air inlet path and/or air inlet channel of the device body housing, such as within the air flow subsystem of the aerosol-generating device 100. The actuator controls 1115 may control the flow of air within the air inlet channel using the actuators based on commands from the controller 1105 associated with the desired aerosol profile.

Moreover, the actuator controls 1115 are used to energize the heater in conjunction with the power supply 1110. More specifically, the actuator controls 1115 are configured to generate a drive waveform associated with the desired aerosol profile. As described above, each possible profile is associated with a drive waveform. Upon receiving a command from the controller 1105 indicating the desired aerosol profile, the actuator controls 1115 may produce the associated modulating waveform for the power supply 1110.

The controller 1105 supplies information to the aerosol indicators 1135 to indicate statuses and occurring operations to the adult operator. The indicators 1135 include a power indicator displayed on the display panel (e.g., communication screen 140), a separate indicator light (e.g., a LED indicator light, etc.) that may be activated when the controller 1105 senses a button pressed by the adult operator. The indicators 1135 may also include a haptic feedback motor, speaker, an indicator for a current state of an adult operator-controlled aerosol parameter (e.g., generated aerosol volume), and other feedback mechanisms.

In some example embodiments, the electrical contact pads of a power-receiving unit, such as a capsule, may become coated with an oxide layer. Such an oxide layer may occur naturally when certain metals are exposed to oxygen in the atmosphere. For instance, aluminum is reactive with the oxygen in the atmosphere and, as a result, has a naturally-occurring aluminum oxide layer on all oxygen-exposed surfaces of the aluminum. In another instance, stainless steel (e.g., 316 stainless steel) contains, inter alia, chromium, which is reactive with the oxygen in the atmosphere and, as a result, has a naturally-occurring chromium oxide layer on all oxygen-exposed surfaces of the stainless steel.

While a metal oxide layer may serve as a protective layer (e.g., corrosion resistance) for the underlying metal, the metal oxide layer is also an electrical insulator and, thus, may hinder the transmission of an electrical current. In particular, the presence of a metal oxide layer on the electrical contact pads of a capsule may interfere with the quality and consistency of an electrical connection with the connector elements (e.g., connector pins) of a power-supplying unit, such as the aerosol-generating device.

To mitigate/address the electrically-insulating effect of the metal oxide layer, an electrical contact arrangement may be configured such that an associated force between the engaging structures is focused on a relatively small surface area so as to increase the likelihood of penetrating (e.g., mechanically and/or electrically) the metal oxide layer and thereby improving the quality and consistency of an electrical connection with the underlying metal. In some example embodiments, an electrical contact pad may be fabricated/modified to introduce at least one surface discontinuity which provides for one or more focused points of contact (e.g., edge(s)) with a corresponding connector when electrically engaged. As used herein, a surface discontinuity should be understood to be disruption in an otherwise smooth and continuous surface. The surface discontinuity (or each of the surface discontinuities) may occupy a contiguous area of about 0.2 mm²-0.80 mm² (e.g., 0.4 mm²-0.6 mm²).

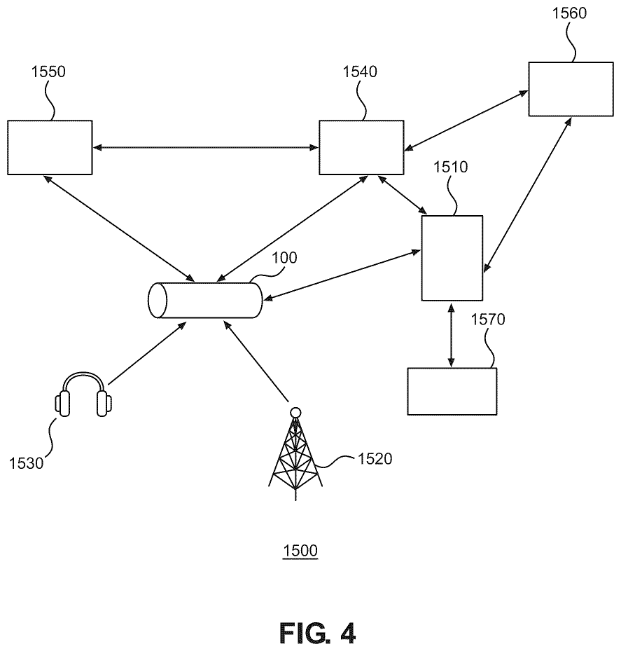

Referring to FIG. 4, a diagram is provided illustrating an example communication system in which the aerosol-generating device 100 may operate according to at least some example embodiments. As shown in FIG. 4, a communication system 1500 may include the aerosol-generating device 100, user equipment (UE) 1510, an access point 1520, a wireless device 1530, a point-of-sale (POS) device 1540, a capsule 1550 (e.g., a capsule 200), a first server 1560 and/or a second server 1570. While FIG. 4 depicts a single UE 1510, a single access point 1520, a single wireless device 1530, a single POS device 1540, a single capsule 1550, a single first server 1560 and a single second server 1570, at least some example embodiments are not limited thereto. In at least some example embodiments, the communication system 1500 may include greater or fewer quantities of the UE 1510, the access point 1520, the wireless device 1530, the POS device 1540, the capsule 1550, the first server 1560, the seconds server 1570, and/or additional elements, etc.

The UE 1510 may be fixed or mobile and may refer to any device that may communicate with an access point, such as the access point 1520, to transmit and receive data. For example, the UE 1510 may refer to a mobile device, a personal computer (PC), a laptop computer, a server, a smartphone, etc. According to at least some example embodiments, a companion application corresponding to the aerosol-generating device 100 may be installed and executed on the UE 1510. The aerosol-generating device 100 may connect with the companion application through a wireless communication link with the UE 1510 (e.g., using an RF device 1214 and/or a Bluetooth device 1218, etc., discussed further below), but is not limited thereto, and for example, the aerosol-generating device 100 may connect with the companion application through a wired communication link with the UE 1510 (e.g., a USB connection, etc.). An operator of the aerosol-generating device 100 may interact with the companion application on the UE 1510 to, for example, complete an age verification process, view notifications corresponding to the aerosol-generating device 100, etc. The companion application may, for example, provide a result of the age verification process, and/or relay information received from the POS device 1540, to the aerosol-generating device 100 via the communication link. However, the example embodiments are not limited thereto, and the age verification process may be performed without the companion application and/or the UE 1510, etc.

According to at least some example embodiments, the companion application may complete the age verification process based on information input by the operator of the aerosol-generating device 100 into the UE 1510 without communicating with an external device. For example, the companion application may cause the UE 1510 to capture an image of a face of a current operator of the aerosol-generating device 100 and compare this image to an image of a face on an authenticated identification document/card (e.g., an identification document/card issued by a governmental authority which includes authenticated and/or otherwise verified authentication and/or security features associated with the identification document/card by the governmental authority) of the current operator (or alleged to be assigned to the current operator). The image of the authenticated identification document/card may be captured (e.g., by the UE 1510) contemporaneous with the capture of the image of the current operator's face or may be previously stored on the UE 1510. The companion application may determine that the age verification is successful in response to determining that the image of the current operator's face matches the face on the authenticated identification document/card, and the authenticated identification document/card indicates that the current operator's age satisfied the threshold age. Otherwise, the companion application may determine that the age verification has failed. According to at least some example embodiments, the companion application may cause the UE 1510 to capture the image of the current operator's face and may analyze the image to detect an age of the current operator using an image processing algorithm (e.g., a 3rd party algorithm). Such an image processing algorithm may be implemented according to any algorithm configured to detect an age of a human depicted in an image, including but not limited to algorithms operating according to machine learning principles, known to those having ordinary skill in the art. The companion application may determine that the age verification is successful in response to determining that the image of the current operator's face is of an operator having an age that satisfies the threshold age. Otherwise, the companion application may determine that the age verification has failed. In at least some example embodiments, the companion application is not limited to the above examples for verifying the age of the current operator, and any age verification techniques performable by the companion application may be used. An indication of the success or failure of the age verification may be provided to the aerosol-generating device 100 via the communication link (e.g., wireless and/or wired) between the UE 1510 and the aerosol-generating device 100.

According to at least some example embodiments, the UE 1510 (e.g., the companion application executed on the UE 1510) may perform the age verification process in communication with the first server 1560. The UE 1510 may communicate with the first server 1560 through a wired and/or wireless communication link. The server first 1560 may be a third-party server (e.g., a Veritad or LexisNexus age verification server), a server of an entity related to the aerosol-generating device 100 (e.g., a manufacturer's server, a distributor's server, a retailer's server, etc.), and/or a government server providing age and/or identity verification services. The first server 1560 may perform the age verification process based on age verification information received from the UE 1510 (e.g., the companion application executed on the UE 1510). The age verification information may include the captured image of the face of the current operator and/or the image of the authenticated identification document/card. The age verification information received from the UE 1510 may be stored in the UE 1510 or entered into the UE 1510 (e.g., the companion application executed on the UE 1510) by the operator of the aerosol-generating device 100 during active communication with the first server 1560 (e.g., in real-time or near-real-time). The first server 1560 may determine a result of the age verification process by comparing the image of the current operator's face to that to the image of the face on the authenticated identification document/card, or by analyzing the image of the current operator's face to detect the age of the current operator, as discussed above in connection with the companion application. However, at least some example embodiments are not limited thereto and the first server 1560 may perform age verification of the current operator according to any age verification techniques performable by the first server 1560. The first server 1560 may provide the result of the age verification process (e.g., an indication of the success or failure of the age verification) to the UE 1510 through the wired and/or wireless communication link. The indication of the success or failure of the age verification may be provided to the aerosol-generating device 100 via the communication link (e.g., wireless and/or wired) between the UE 1510 and the aerosol-generating device 100.

The access point 1520 may be fixed and/or mobile and may communicate with other devices, such as the aerosol-generating device 100, the UE 1510 and/or the wireless device 1530, to exchange data and control information. The access point may wirelessly communicate with such other devices, and thereby provide the other devices with access to a communication network (e.g., the Internet, etc.), but is not limited thereto. For example, the access point 1520 may refer to a Wi-Fi access point, a base station (e.g., a 4G LTE Node B, a 4G LTE evolved-Node B (eNB), a 5G NR next generation Node B (gNB), etc.), a beacon, etc. The access point 1520 may communicate with the other devices within a coverage range of the access point 1520.

The wireless device 1530 may correspond to any device capable of communicating via wireless signals (and may also be referred to herein as communication-enabled devices). According to at least some example embodiments, for example, the wireless device 1530 may communicate via short-range wireless signals (e.g., Wi-Fi, Near-Field Communication (NFC), Bluetooth, etc.). FIG. 4 depicts the wireless device 1530 as a pair of wireless headphones, however at least some example embodiments are not limited thereto. Other example implementations of the wireless device 1530 include wireless computer peripherals (e.g., mouse, keyboard, printers, etc.), smart appliances (e.g., refrigerators, dishwashers, thermostats, etc.), smart televisions, speakers, etc.

According to at least some example embodiments, the aerosol-generating device 100 may collect signal traffic information regarding wireless communication signals transmitted in an area in which the aerosol-generating device 100 is located to determine a wireless “fingerprint” and/or “signature” associated with the area. For example, the aerosol-generating device 100 may collect signal traffic information corresponding to wireless communication signals transmitted by the UE 1510, the access point 1520 and/or the wireless device 1530, etc. In so doing, the aerosol-generating device 100 may detect (e.g., passively detect) networks (e.g., Wi-Fi networks), wireless devices (e.g., Bluetooth devices), etc., and associate the detected networks (e.g., communication networks), devices (e.g., communication-enabled devices), etc., with a particular location and use the collected signal traffic information associated with the particular location to determine whether the aerosol-generating device 100 has returned to the particular location at a later time by comparing the collected signal traffic information associated with the location with new signal traffic information detected by the aerosol-generating device 100.

According to at least some example embodiments, the wireless communication signals may include respective indications identifying the corresponding devices that transmitted the wireless communication signals (e.g., the UE 1510, the access point 1520 and/or the wireless device 1530). For example, the wireless communication signals may include periodically transmitted signals for establishing and/or maintaining a communication link (e.g., beacon signals, heartbeat signals, etc.). According to at least some example embodiments, the wireless communication signals may include a Service Set Identifier (SSID) (e.g., an SSID of the access point 1520), a Universally Unique Identifier (UUID) (e.g., a UUID of the wireless device 1530), a network name, a network identifier, etc., but at least some example embodiments are not limited thereto. For example, the wireless communications signals may include wireless signals output from (e.g., pinging) devices (e.g., the wireless device 1530) at a regular rate, such as from garage door openers, RF pendants, etc. Also, the wireless communication signals may include other communication signals of devices (e.g., the UE 1510, the access point 1520 and/or the wireless device 1530) that match an RF signature (e.g., a frequency domain shape, a signal strength, etc.) stored by the aerosol-generating device 100. Such RF signatures are protocol agnostic, and may be generated (e.g., by the aerosol-generating device 100) according to processes and implementations known to those having ordinary skill in the art. The signal traffic information collected by the aerosol-generating device 100 may include these indications identifying wireless devices in the area of the aerosol-generating device 100. As such, the collected signal traffic information may serve as a fingerprint associated with the area, and may be used to identify and/or differentiate the area for use as one type of behavior metric to determine whether a current operator of the aerosol-generating device 100 is an authorized operator as discussed further below.

The POS device 1540 may correspond to a device at a store (e.g., a brick-and-mortar store, vending solution, etc.). The POS device 1540 may be used (e.g., by a clerk, by the adult consumer, and/or on an automated basis) to process purchase information when the aerosol-generating device 100, and/or one or more capsules 1550, are purchased from the store, but at least some example embodiments are not limited thereto. The POS device 1540 may include processing circuitry configured to process the purchase information (e.g., by executing computer-readable instructions stored, for instance, on a memory of the POS device 1540). The POS device 1540 may also include a wireless transmitter (e.g., a short-range wireless transmitter), and/or wireless transceiver (e.g., a short-range wireless transceiver) capable of communicating with the aerosol-generating device 100, the one or more capsules 1550 and/or the UE 1510. For example, the POS device 1540 may transmit an indication of a result of an age verification process performed by a clerk of the store, and/or by the processing circuitry of the POS device 1540, and/or other information (e.g., clerk information, store information, etc.) to the aerosol-generating device 100, the one or more capsules and/or the UE 1510 using the wireless transmitter (e.g., via short-range wireless signals, Bluetooth signals, etc.).

According to at least some example embodiments, the POS device 1540 may perform the age verification process based on age verification information provided to the clerk, and/or input to the POS device 1540, by the operator of the aerosol-generating device 100. According to at least some example embodiments, the POS device 1540 may perform the age verification process without communicating with an external device. For example, a clerk of the POS device 1540 may manually perform age verification of the current operator of the aerosol-generating device by manually comparing the face of the current operator with the face on the authenticated identification document/card provided by the current operator. The clerk may determine that the age verification is successful in response to determining that the current operator's face matches the face on the authenticated identification document/card, and the authenticated identification document/card indicates that the current operator's age satisfied the threshold age. According to at least some example embodiments, the POS device 1540 (e.g., the processing circuitry of the POS device 1540) may determine a result of the age verification process by comparing the image of the current operator's face to that to the image of the face on the authenticated identification document/card, or by analyzing the image of the current operator's face to detect the age of the current operator, as discussed above in connection with the companion application. According to at least some example embodiments, the POS device 1540 may perform the age verification process in communication with the first server 1560 similar to the process discussed above in connection with the UE 1510. The POS device 1540 may communicate with the first server 1560 through a wired and/or wireless communication link. For example, the first server 1560 may determine a result of the age verification process by comparing the image of the current operator's face to that to the image of the face on the authenticated identification document/card, or by analyzing the image of the current operator's face to detect the age of the current operator, as discussed above in connection with the companion application. The first server 1560 may provide the result of the age verification process (e.g., an indication of the success or failure of the age verification, also referred to herein as an age verification indication) to the POS device 1540 through the wired and/or wireless communication link. In at least some example embodiments, the POS device 1540 (and/or clerk) is not limited to the above examples for verifying the age of the current operator, and any age verification techniques performable by the POS device 1540 (and/or clerk) may be used. As discussed above, the POS device 1540 may transmit an indication of the result of the age verification to the aerosol-generating device 100, the one or more capsules and/or the UE 1510 using the wireless transmitter. However, at least some example embodiments are not limited thereto. For example, the POS device 1540 may transmit the indication of the result of the age verification to (e.g., directly to) the aerosol-generating device 100 (e.g., through a wired and/or wireless communication link).

According to at least some example embodiments, the POS device 1540 may include a wired transmitter and/or a wired transceiver for use in communicating with the first server 1560, however at least some example embodiments are not limited thereto. For example, in at least some example embodiments, the POS device 1540 may communicate with the first server 1560 using the wireless transmitter and/or the wireless transceiver. According to at least some example embodiments, the POS device 1540 may transmit the age verification information which may be stored in the POS device 1540 or entered into the POS device 1540 (e.g., by the clerk and/or the operator of the aerosol-generating device 100) during active communication with the first server 1560 (e.g., in real-time). The first server 1560 may determine a result of the age verification process based on the same comparison(s) as, or similar comparison(s) to, those discussed above in connection with the companion application. The first server 1560 may provide the result of the age verification process to the POS device 1540 through a wired and/or wireless communication link. As discussed above, the POS device 1540 may transmit an indication of the result of the age verification to the aerosol-generating device 100, the one or more capsules and/or the UE 1510 using the wireless transmitter.

The capsule 1550 may be the same as, or similar to, the capsule 200 discussed above. The capsule 1550 may include a tag (e.g., an RF tag) capable of storing data. The tag may store such data on a register, a memory, etc. The capsule 1550 may receive data (e.g., a result of an age verification process, clerk information, store information, etc.) from the POS device 1540 (e.g., from the wireless transmitter of the POS device 1540) and store the data on the tag. The aerosol-generating device 100 may read the data stored on the tag (e.g., using the RF device 1214).

The first server 1560 may include a wired and/or wireless transmitter, receiver and/or transceiver, capable of performing wired and/or wireless communication with the POS device 1540 and/or the UE 1510. The first server 1560 may be a third-party server (e.g., a Veritad or LexisNexus age verification server), a server of an entity related to the aerosol-generating device 100 (e.g., a manufacturer's server, a distributor's server, a retailer's server, etc.), and/or a government server providing age and/or identity verification services. The first server 1560 may perform an age verification process based on age verification information received from the POS device 1540 and/or the UE 1510 as discussed above in connection with the companion application and the POS device 1540. The first server 1560 may return a result of the age verification process to the POS device 1540 and/or the UE 1510, respectively.

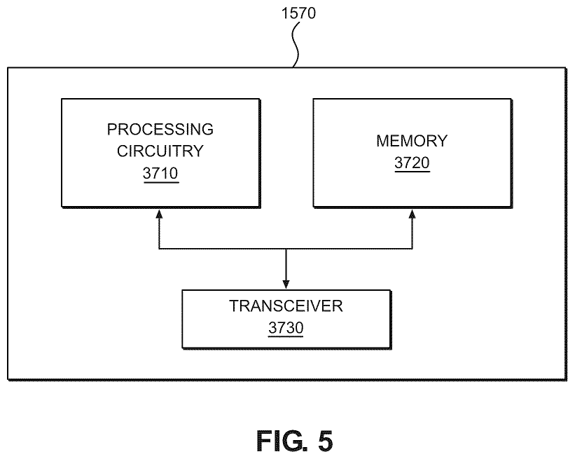

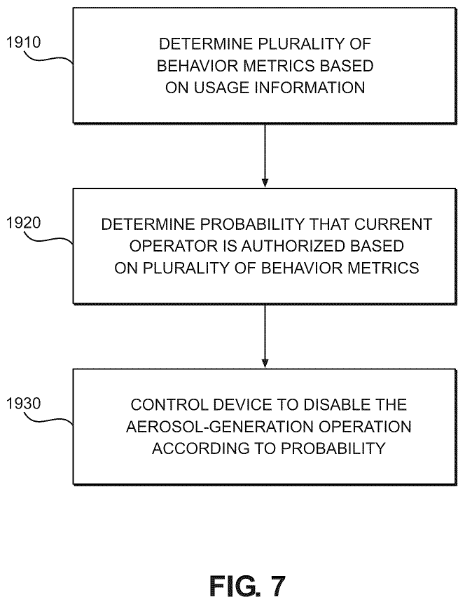

The second server 1570 may include a wired and/or wireless transmitter, receiver and/or transceiver, capable of performing wired and/or wireless communication with the UE 1510. As discussed further in connection with FIGS. 5 and 7, the second server 1570 may be an external server (e.g., a cloud-based server) that may perform one or more of the operations discussed in connection with FIGS. 7-22 (e.g., instead of the aerosol-generating device 100), and may provide the result(s) of the one or more performed operations to the aerosol-generating device 100. For example, the second server 1570 may receive information (e.g., behavior information) from the aerosol-generating device 100 via the companion application executing on the POS device 1540. The second server 1570 may perform one or more processing operations based on the received information (e.g., determining a plurality of behavior metrics based on the behavior information and/or determining a probability that a current operator of the aerosol-generating device is an authorized operator, etc.), and may transmit one or more messages to the aerosol-generating device 100 (e.g., via the companion application executing on the POS device 1540). The one or more messages may provide a notification to a current operator of the aerosol-generating device 100, control a functionality of the aerosol-generating device 100, etc.

Referring to FIG. 5, illustrated is the second server 1570 which may include processing circuitry 3710, memory 3720 and/or a transceiver 3730. As discussed above, the transceiver 3730 may perform wired and/or wireless communication with the UE 1510 (e.g., the companion application executing on the UE 1510) to receive information (e.g., behavior information) from, and transmit one or more messages to, the aerosol-generating device 100 via the UE 1510. The information received from the aerosol-generating device 100 may be stored in the memory 3720 for use in performing the one or more processing operations (e.g., one or more of the operations discussed in connection with FIGS. 7-22). The processing circuitry 3710 may control overall operations of the second server 1570 and may perform the one or more processing operations (e.g., the one or more of the operations discussed in connection with FIGS. 7-22).

Referring back to FIG. 4, according to at least some example embodiments, the aerosol-generating device 100, the user equipment (UE) 1510, the access point 1520, the wireless device 1530, the POS device 1540, the capsule 1550, the first server 1560 and/or the second server 1570 may communicate according to one or more among various multiple access schemes, such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), OFDM-FDMA, OFDM-TDMA, and/or OFDM-CDMA, etc.

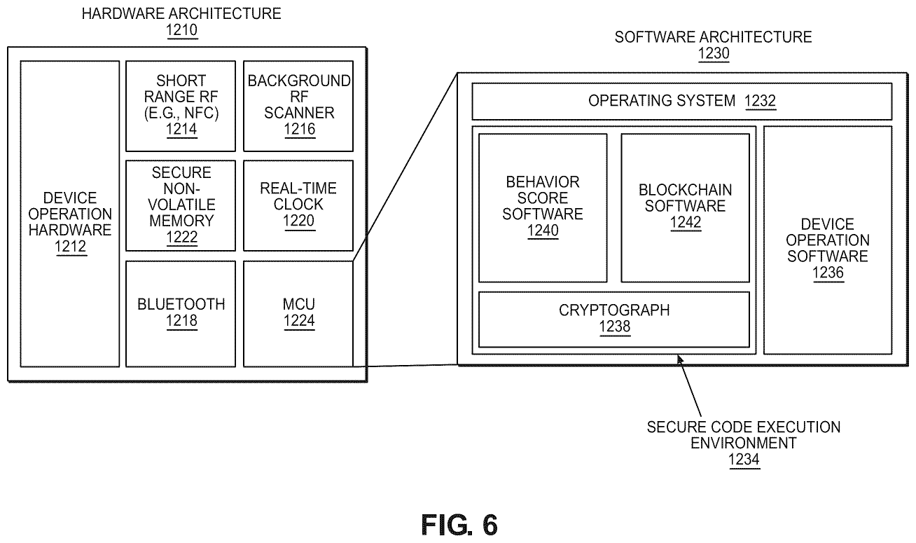

Referring to FIG. 6, a block diagram is provided illustrating a hardware and software architecture of the aerosol-generating device 100 according to at least some example embodiments. As shown in FIG. 6, the aerosol-generating device 100 may have a hardware architecture 1210 including device operation hardware 1212, a radio frequency (RF) device 1214, a background RF scanner 1216, a Bluetooth device 1218, a real-time clock 1220, a secure non-volatile memory 1222 and/or a microcontroller unit (MCU) 1224. According to at least some example embodiments, the above components of the hardware architecture 1210 may be connected to each other via, for example, a bus, etc. According to at least some example embodiments, the control subsystem 1100 of FIG. 3 may be implemented using the hardware architecture 1210.

The device operation hardware 1212 may control at least some of the overall operations of the aerosol-generating device 100 (e.g., the communication screen 140, the heater, etc.). The device operation hardware 1212 may include, for example, an application-specific integrated circuit (ASIC), a field programmable gate array (FPGA), logic circuits, a System-on-Chip (SoC), etc. The RF device 1214 may receive and/or transmit signals to at least one device external to the aerosol-generating device 100. The RF device 1214 may be a transmitter, a receiver and/or a transceiver. According to at least some example embodiments, the RF device 1214 may be configured to communicate according to a short-range RF communication protocol (e.g., Wi-Fi, Near-Field Communication (NFC), Bluetooth, etc.), but at least some example embodiments are not limited thereto. According to at least some example embodiments, the RF device 1214 is not limited to RF communications but may also, or alternatively, be configured to communication according to any wireless communication protocol. The RF device 1214 may include a modem for processing signals received and/or to be transmitted via the RF device 1214.

The background RF scanner 1216 may receive (e.g., passively receive) RF signals transmitted from at least one external device. For example, the background RF scanner 1216 may receive RF signals transmitted by a base station, access point, beacon, etc., and identify the base station, access point, beacon, etc., according to information contained in the received RF signals. According to at least some example embodiments, the background RF scanner 1216 may be implemented using the RF device 1214 rather than being included in the hardware architecture 1210 as a component separate from the RF device 1214.

The Bluetooth device 1218 may receive and/or transmit signals to at least one device external to the aerosol-generating device 100. The Bluetooth device 1218 may be a transmitter, a receiver and/or a transceiver. The Bluetooth device 1218 may be configured to communicate according to a Bluetooth communication protocol. The Bluetooth device 1218 may include a modem for processing signals received and/or to be transmitted via the Bluetooth device 1218. According to at least some example embodiments, the Bluetooth device 1218 may be implemented using the RF device 1214 rather than being included in the hardware architecture 1210 as a component separate from the RF device 1214.

The real-time clock 1220 may be based on a signal from a crystal oscillator included in the aerosol-generating device 100, or based on a clock signal received from a source external to the aerosol-generating device 100 (e.g., received using the RF device 1214, the background RF scanner 1216 and/or the Bluetooth device 1218). The real-time clock 1220 may be implemented by the device operation hardware 1212 and/or the MCU 1224 based on the signal from the crystal oscillator or the external clock signal to provide a real-time internal clock signal that may be used by the aerosol-generating device to accurately track the passage of time.

The secure non-volatile memory 1222 may store data generated during operation of the aerosol-generating device 100, data received from at least one source external to the aerosol-generating device 100 (e.g., identification information regarding nearby base stations, access points, etc.), computer-readable instructions executable by the MCU 1224, etc. The secure non-volatile memory 1222 may be implemented using, for example, flash memory, Read Only Memory (ROM), Electrically Programmable ROM (EPROM), Electrically Erasable Programmable ROM (EEPROM), registers, hard disk, a removable disk, a CD ROM, or any other form of non-volatile storage medium known in the art.

The MCU 1224 may control at least some of the overall operations of the aerosol-generating device 100. The MCU 1224 may include, for example, at least one processor, a central processing unit (CPU), an arithmetic logic unit (ALU), a digital signal processor, a microcomputer, a programmable logic unit, a microprocessor, etc. The MCU 1224 may be configured to execute a software architecture 1230 based on, for example, the computer-readable instructions stored in the secure non-volatile memory 1222. According to at least some example embodiments, the software architecture 1230 may include an operating system 1232, a secure code execution environment 1234 and/or device operation software 1236.

The operating system 1232 may manage computing resources of the aerosol-generating device, and may provide an overall environment in which the secure code execution environment 1234 and/or device operation software 1236 may be executed. The secure code execution environment 1234 may provide a secure environment for execution of various software. For example, the secure code execution environment 1234 may include a cryptograph 1238, behavior score software 1240 and/or blockchain software 1242, etc. The cryptograph 1238 may encrypt data output from various software (e.g., the behavior score software 1240 and/or the blockchain software 1242, etc.) executed in the secure code execution environment 1234 to a device and/or component external to the secure code execution environment 1234 and/or the aerosol-generating device 100. The cryptograph 1238 may decrypt data received from a device and/or component, external to the secure code execution environment 1234 and/or the aerosol-generating device 100 before providing the decrypted data to various software (e.g., the behavior score software 1240 and/or the blockchain software 1242) executed in the secure code execution environment 1234.

As indicated above, the various software executed in the secure code execution environment 1234 may include behavior score software 1240 and/or blockchain software 1242 configured to perform functions related to a behavior score and/or a blockchain, respectively, when executed by the MCU 1224. The behavior score and blockchain will be discussed further below. According to at least some example embodiments, the secure code execution environment 1234, using at least the cryptograph 1238, secures data generated by the various software (e.g., the behavior score software 1240 and/or the blockchain software 1242, etc.) thereby preventing or reducing unauthorized access to the data.

According to at least some example embodiments, device operation software 1236 may be executed by the MCU 1224 to control at least some of the overall operations of the aerosol-generating device 100 (e.g., the communication screen 140, the heater, etc.). According to at least some example embodiments, operations controlled by using the software architecture 1230 (e.g., the device operation software 1236) executed by the MCU 1224 may be different from, the same as or similar to those controlled using the device operation hardware 1212. According to at least some example embodiments, the software architecture 1230 (e.g., the device operation software 1236) executed by the MCU 1224 and/or the device operation hardware 1212 may operate collaboratively and/or contemporaneously to execute some or all of the overall operations of the aerosol-generating device 100. According to at least some example embodiments, data input and/or output to/from the device operation software 1236 may not be encrypted.

According to at least one example embodiment, data (e.g., behavior information) used to determine whether a current operator of the aerosol-generating device 100 is an authorized operator may be received into the software architecture 1230 through external interfaces. The data may be received from one or more components of the aerosol-generating device 100 and/or from one or more external devices, as discussed further below. The data received through the external interfaces may be decrypted using a cryptographic module (e.g., the cryptograph 1238), and may be provided to a metric calculation block. According to at least some example embodiments, the cryptographic module may also encrypt data output from the software architecture 1230 to a device and/or component external to the software architecture 1230 and/or the aerosol-generating device 100.

The metric calculation block may convert the data (e.g., behavior information) into behavior metrics by, for example, quantizing the data. The behavior metrics may be provided to a behavior calculation algorithm (e.g., the behavior score software 1240) and/or a secure data storage (e.g., the secure non-volatile memory 1222). The behavior calculation algorithm may calculate a probability that a current operator of the aerosol-generating device 100 is an authorized operator (e.g., a behavior score) based on the behavior metrics. The behavior score may be provided to the secure data storage and/or a blockchain module (e.g., blockchain software 1242). The blockchain module may generate a block based on the behavior score, and may add the generated block to a blockchain stored in the secure data storage. According to at least some example embodiments, the blockchain module may be omitted from the software architecture 1230 and the storing of the behavior score on a blockchain may be omitted. The behavior metrics and behavior calculation algorithm will be discussed in further detail in connection with FIG. 7.

The secure data storage may be configured to enable one or more other software functions of the software architecture 1230 to access the stored behavior score via one or more interfaces (e.g., one or more secure interfaces, such as a secured Application Programming Interface (API), etc.). According to at least one example embodiment, the software architecture 1230 may be hardware-agnostic such that the above-described data flow thereof may be executed on a range of different types of devices and/or platforms.

According to at least one example embodiment, an operating system may be executed by the MCU 1224. The operating system may include a non-secure operating system and a secure operating system, but the example embodiments are not limited thereto, and for example, the non-secure operation system or the secure operating system may be omitted. The non-secure operating system and the secure operating system may be executable side-by-side, or contemporaneously on a single core (e.g., a single core of the MCU 1224). Secure software executed on the secure operating system may be secure from access by non-secure software executed on the non-secure operating system. The non-secure operating system and the secure operating system may communicate with each other, however, using a monitor kernel. According to at least some example embodiments, the secure operating system may push data corresponding to (e.g., operated on, output from, processed by, generated by, etc.) the secure software to the non-secure operating system for access by the non-secure software. According to at least some example embodiments, the operating system may perform a secure boot sequence to verify the integrity of a secure software image of the secure operating system. According to at least some example embodiments, the operating system may be an Arm® TrustZone® system, but is not limited thereto, and other operating systems may be used.

The non-secure operating system may provide an execution environment for the non-secure software, for example, operator interface software, device control software and/or non-secure hardware interfaces. According to at least some example embodiments, the operator interface software, the device control software and/or the non-secure hardware interfaces may be implementations of the device operation software 1236. According to at least some example embodiments, the operator interface software may be used to control the communication screen 140 and/or the operator interface of a companion application executed by an external device, etc. to, for example, display one or more notifications based on an authorized operator probability as discussed further below. According to at least some example embodiments, the non-secure hardware interfaces may be used to input and/or output data between the non-secure software and one or more hardware devices (e.g., one or more components of the hardware architecture 1210 and/or one or more external devices, such as a user equipment 1510, a wireless device 1530, etc.).

The secure operating system may provide an execution environment for the secure software, for example, a behavior-score software module and/or behavior-score hardware interfaces, but is not limited thereto. According to at least some example embodiments, the behavior-score software module may correspond to (e.g., may be) the behavior score software 1240. According to at least some example embodiments, the behavior-score hardware interfaces may correspond to (e.g., may be) the external interfaces discussed above.

Referring to FIG. 7, a flowchart is provided illustrating a method for controlling an aerosol-generating device according to a probability that a current operator of the aerosol-generating device is an authorized operator, according to at least some example embodiments. The operations described herein as being performed by the aerosol-generating device 100, such as the operations described in connection with FIGS. 7-22, may be performed by processing circuitry of the aerosol-generating device 100, however some example embodiments are not limited thereto. For example, according to some example embodiments, one or more (or all) of the operations described in connection with FIGS. 7-22 may be performed by the processing circuitry 3710 of the second server 1570 instead of the processing circuitry of the aerosol-generating device 100. In such scenarios, operations described in connection with FIGS. 7-22 as being performed by the aerosol-generating device 100 may further include transmitting, by the aerosol-generating device 100, information (e.g., corresponding information and/or relevant information) to the second server 1570 and the corresponding operations being performed by the second server 1570 with a result of the corresponding operations being transmitted, by the second server 1570 (e.g., by the transceiver 3730), to the aerosol-generating device 100 (e.g., via the companion application). For simplicity of description, however, the operations described in connection with FIGS. 7-22 will be described in as being performed by the processing circuitry of the aerosol-generating device 100. The term ‘processing circuitry,’ as used herein may refer to, for example, a hardware/software combination such as a processor executing software (e.g., the MCU 1224 executing the software architecture 1230), but at least some example embodiments are not limited thereto. According to at least some example embodiments, the processing circuitry may refer to hardware including logic circuits. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. Also, the POS device and/or capsule discussed in connection with FIGS. 6-21 may be the same as, or similar to, the POS device 1540 and/or the capsule 1550, respectively.

In operation 1910, the aerosol-generating device 100 may determine a plurality of behavior metrics based on operation information (e.g., behavior information). According to at least some example embodiments, discussion herein relating to determination of a behavior metric may refer to determination of a value of the behavior metric. The plurality of behavior metrics may include one or more among a time metric, an age verification metric, a capsule operation metric, a trusted retailer metric, an operation pattern metric, a location metric, a companion application connection metric, etc. However, at least some example embodiments are not limited thereto. According to at least some example embodiments, the plurality of metrics may include more metrics, fewer metrics and/or different metrics. As such, operation 1910 may be performed without determining one or more of the behavior metrics described herein, and the authorized operator probability described below in connection with operation 1920 may be determined without one or more of the behavior metrics described herein having been determined. Also, one or more of the above metrics may be combined, or divided, to form different metrics.

Values of the plurality of behavior metrics may be determined based on behavior information obtained by the aerosol-generating device 100. For example, the behavior information may be collected from sources internal and/or external to the aerosol-generating device. Internal sources of behavior information may include the real-time clock 1220, an operating pattern model and/or puff profile model (e.g., generated by the aerosol-generating device 100 and stored in, for example, the secure non-volatile memory 1222), signal traffic information (e.g., stored in the secure non-volatile memory 1222) indicative of a location of the aerosol-generating device 100, internal verification of the capsule information, aerosol-generating device 100 operation tracking (e.g., using the power button 142, a power source, the consumer interface panel 143, one or more air flow sensors, the device sensors 1125, the power controller 1110a, the actuator controls 1115, etc.), etc. External sources of behavior information may include the RF device 1214, the background RF scanner 1216, the Bluetooth device 1218, the companion application (e.g., installed and executed on the UE 1510), etc. According to some example embodiments, in scenarios in which the operations described in connection with FIGS. 6-21 are performed by the second server 1570 instead of the aerosol-generating device 100, the behavior information (as well as any other information used to perform the operations described in connection with FIGS. 6-21) may be collected by the second server 1570 from the aerosol-generating device 100 (e.g., via the companion application), but some example embodiments are not limited thereto. For example, at least some of the behavior information (e.g., other information used to perform the operations described in connection with FIGS. 6-21) may be obtained from another source, may be previously stored (and/or programmed) in the second server 1570 (e.g., stored in the memory 3720), etc. According to some example embodiments, in scenarios in which the operations described in connection with FIGS. 6-21 are performed by the second server 3720 instead of the aerosol-generating device 100, the behavior information (as well as any other information used to perform the operations described in connection with FIGS. 6-21) may be stored in the memory 3720 of the second server 1570 for use in performing the operations described in connection with FIGS. 6-21).

Each determined behavior metric among the plurality of behavior metrics may have a respective value representing an increase or decrease in the probability that a current operator of the aerosol-generating device 100 is an authorized operator (also referred to herein as the authorized operator probability). As discussed herein, as the authorized operator probability increases, an unauthorized operator probability level reflecting that the current operator is not the authorized operator decreases. Similarly, as the authorized operator probability decreases, the unauthorized operator probability level reflecting that the current operator is not the authorized operator increases. According to at least some example embodiments, an authorized operator as discussed herein may refer to an operator of the aerosol-generating device 100 having an age above or equal to an age threshold. According to at least some example embodiments, the age threshold may be based on statutory restrictions provided by a governmental authority in a given area and/or jurisdiction (e.g., a country, a state, a province, a county, a city, etc.). According to at least some example embodiments, the age threshold may be based on medical guidelines, prescription information, etc. (e.g., in cases in which the capsule contains a medicine and/or controlled substance, etc.).

The time metric may correspond to the passage of time. For example, the time metric may reflect that the authorized operator probability generally decreases over time. As such, the aerosol-generating device may determine the time metric as a value (also referred to herein as a time metric value) reflecting a decrease in the authorized operator probability based on the passage of a time period. For example, the time period may be measured (e.g., continuously) from a most recent successful age verification, may represent a fixed or alternatively, given time period (e.g., a day as measured from an initial time point, such as midnight), etc. According to at least some example embodiments, the time metric value may reflect a decrease in the authorized operator probability by a fixed or alternatively, given amount (e.g., linearly) each time the time period passes. According to at least some example embodiments, the time metric value may reflect a non-linear decrease in the authorized operator probability each time the time period passes (e.g., decreasing by a greater amount each time the time period passes), but is not limited thereto. According to at least some example embodiments, the aerosol-generating device 100 may determine the time metric using the real-time clock 1220, but is not limited thereto, and for example, the time metric may be calculated using an external device, e.g., a clock of the UE device 1510, etc.

According to at least some example embodiments, the aerosol-generating device 100 may adjust the time period, after which the authorized operator probability may be decreased, based on the current authorized operator probability (e.g., the behavior score). For example, the aerosol-generating device 100 may decrease the time period when the current authorized operator probability is lower. In this way, the aerosol-generating device 100 may increase an amount of influence represented by the time metric on the authorized operator probability (e.g., behavior score) in situations indicating the current operator of the aerosol-generating device 100 is less likely to be the authorized operator. According to at least some example embodiments, the time metric value may additionally, or alternatively, reflect a decrease in the authorized operator probability each time the aerosol-generating device 100 is operated (e.g., to perform an aerosol-generation operation) and/or each time a new capsule is inserted into the aerosol-generating device 100, etc.

The age verification metric may be based on an indication of an age verification result of an age verification process. For example, a value of the age verification metric (e.g., an age verification metric value) may reflect that the authorized operator probability increases based on an indication that an age of the current operator of the aerosol-generating device 100 has been successfully verified According to at least some example embodiments, the age of the current operator of the aerosol-generating device 100 may be verified, and an indication of a successful or failed age verification provided to the aerosol-generating device 100, according to any of the age verification processes discussed in connection with FIG. 4. According to at least some example embodiments, the indication that the age of the current operator of the aerosol-generating device 100 has been successfully verified by the first server 1560 may be sufficient, even without consideration of any other behavior metrics, to increase the authorized operator probability to a highest level (e.g., decrease the unauthorized operator probability level to a lowest level). Also, the indication that the age of the current operator of the aerosol-generating device 100 has been successfully verified by the first server 1560 may be sufficient, even without consideration of any other behavior metrics, to restore the aerosol-generating device 100 to operability in circumstances in which the aerosol-generating device 100 has been disabled (e.g., as discussed in connection with operations 1850, 1855 and 1860). According to at least some example embodiments, the term current operator as used herein may refer to an operator currently using the aerosol-generating device 100, or may refer to an operator that performs age verification in connection with the aerosol-generating device 100 (e.g., when purchasing a capsule that is later inserted into the aerosol-generating device 100, via, e.g., the companion application corresponding to the aerosol-generating device 100, etc.) regardless of whether that operator is currently using the aerosol-generating device 100.

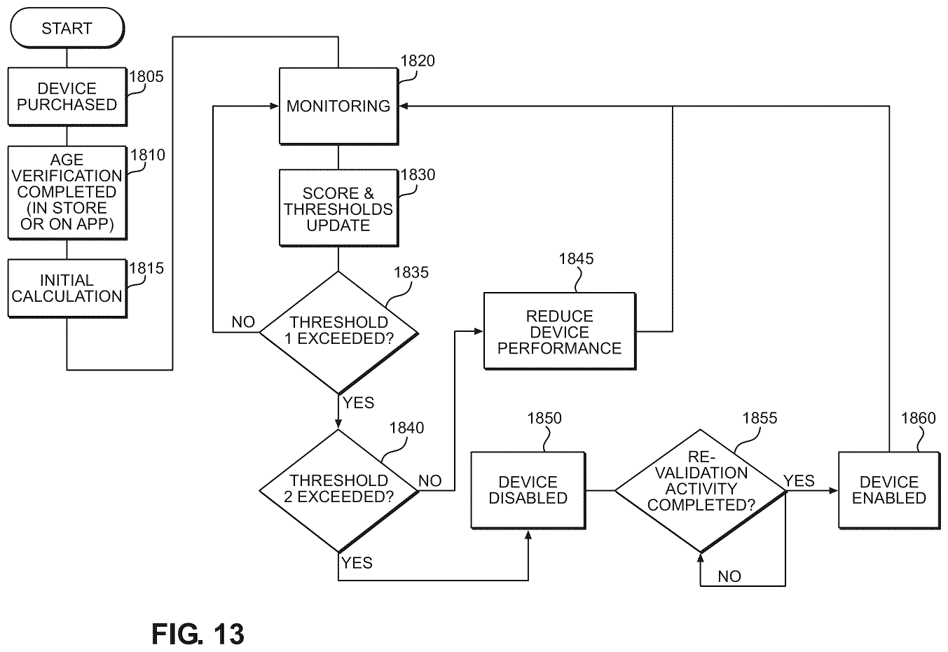

The age verification process may be performed external to the aerosol-generating device. For example, the age verification process may be performed at a store (e.g., a brick-and-mortar store, vending solution, etc.), online (e.g., from a webpage, a web-based application, etc.), using the companion application corresponding to the aerosol-generating device 100 (e.g., installed and executed on the UE 1510), etc., as discussed in association with FIG. 4 above and will be further discussed in FIG. 13 below. According to at least some example embodiments, the indication of the age verification result of the age verification process may be received in encrypted form via the RF device 1214 and/or the Bluetooth device 1218, and subsequently decrypted by the aerosol-generating device 100 (e.g., using the cryptographic module). For example, when the age verification process is performed using the companion app, the companion app may generate a token corresponding to the age verification result and transmit the token to the aerosol-generating device 100 (e.g., via a Bluetooth signal received by the Bluetooth device 1218). The aerosol-generating device 100 may receive the token and collect the age verification result based on the token. Also, as will be discussed in further detail in connection with FIG. 13 below, when the age verification process is performed at the store, the age verification result may be recorded on a capsule tag, and transmitted to (and/or read by) the aerosol-generating device 100 (e.g., via a wireless signal received by the RF device 1214). The aerosol-generating device 100 may receive the age verification result from the capsule (e.g., when the capsule is inserted into the aerosol-generating device 100 for use therein).

According to at least some example embodiments, the aerosol-generating device may determine the age verification metric value based on the age verification result weighted according to how the age verification process is performed and/or a trust level associated with the method of performing the age verification process. For example, an age verification result corresponding to an age verification process performed in the store may be weighted higher than an age verification result corresponding to an age verification process performed online or using the companion application, or an age verification result corresponding to an age verification process performed based on a current image of the operator may be weighted higher than an age verification result solely corresponding to the input of personal identifying information of the operator, but the example embodiments are not limited thereto. According to at least some example embodiments, the age verification metric value may be determined based on a combination of age verification results, and the age verification results may correspond to age verification processes performed according to different methods (e.g., store, online and/or companion application).

The capsule operation metric may be based on whether a capsule (e.g., a capsule inserted into the aerosol-generating device 100) is determined by the aerosol-generating device 100 to be a genuine capsule. When the capsule is determined to be genuine, a value of the capsule operation metric (e.g., a capsule operation metric value) may be determined to reflect an increase in the authorized operator probability. In contrast, when the capsule is determined to be non-genuine, the capsule operation metric value may be determined to reflect a decrease in the authorized operator probability. As will be discussed in further detail in connection with FIG. 13, the capsule tag may store various information that may be collected by the aerosol-generating device 100 (e.g., via the RF device 1214) and the aerosol-generating device 100 may determine whether the capsule is genuine based on the information stored on the capsule tag. For example, the information stored on the capsule tag may include, but is not limited to, an indication that the capsule is a genuine capsule, an indication of an age verification result, an indication of an age verification process used, an identifier of a retailer from which the capsule was purchased, an indication of a retailer trust score of the retailer, an indication of a clerk trust score of a clerk from whom the capsule was purchased, an indication of a chain of custody of the capsule, an indication of a capsule type of the capsule (e.g., the type or amount of compounds or active ingredients), an indication of a flavor of the capsule, a number of capsules in a pack that was purchased, etc.

In determining one or more among the plurality of behavior metrics (e.g., the capsule operation metric, the trusted retailer metric and/or the operation pattern metric) respective values corresponding to teach of the types of information stored on the capsule tag may be weighted according to the corresponding type of information (e.g., each type of information may be weighted differently) when determining each of the one or more behavior metrics. According to at least some example embodiments, each time a new capsule is inserted into the aerosol-generating device 100, the aerosol-generating device 100 may read the information stored on the capsule tag, verify the chain of custody of the capsule, reset the authorized operator probability to the highest level, determine the values of the one or more behavior metrics based on the information stored on the capsule tag, and re-determine the authorized operator probability based on the values of the one or more behavior metrics (discussed in more detail below).

According to at least some example embodiments, the aerosol-generating device 100 may receive and/or read the information from the capsule tag in encrypted form (e.g., each time a new capsule is inserted into the aerosol-generating device 100), and may subsequently decrypt the information (e.g., using the cryptographic module (e.g., the cryptograph 1238). The aerosol-generating device 100 may determine the capsule operation metric (e.g., the capsule operation metric value) based on the decrypted information. According to at least some example embodiments, the aerosol-generating device 100 may determine whether the capsule is a genuine capsule based on whether or not a corresponding indication is stored on the capsule tag (e.g., indication that the capsule is a genuine, the chain of custody of the capsule, the indication of a capsule type of the capsule, etc.). In such examples, the aerosol-generating device 100 may determine the capsule to be genuine when the capsule tag stores an indication that the capsule is a genuine capsule, a verifiable chain of custody and/or an indication that the capsule is of a genuine type, and may determine that the capsule is not genuine when the capsule tag does not store an indication that the capsule is a genuine capsule, a verifiable chain of custody and/or an indication that the capsule is of a genuine type. According to at least some example embodiments, the aerosol-generating device 100 may determine whether the capsule is a genuine capsule based on whether or not the capsule includes a tag properly formatted, and/or encrypted, to include one or more of the types of information described above. In such examples, the aerosol-generating device 100 may determine the capsule to be genuine when the capsule includes a tag that is properly formatted and/or encrypted, and may determine that the capsule is not genuine when the capsule tag does not include a tag that is properly formatted and/or encrypted. According to at least some example embodiments, a genuine capsule may be a capsule that is manufactured, distributed and/or sold by a legally authorized entity.

According to at least some example embodiments, the capsule tag may store at least one key (e.g., a cryptographic key, etc.) and/or identifier associated with the capsule and/or the chain of custody. The aerosol-generating device 100 may determine that the capsule tag corresponds to a genuine capsule in response to determining that a first key/identifier associated with the capsule is valid (e.g., by comparing the first key/identifier with keys/identifiers stored on the aerosol-generating device 100 or another device, by processing the first key/identifier with an algorithm (e.g., a cryptographic algorithm) that would be known to those having ordinary skill in the art, etc.). The aerosol-generating device 100 may determine that the capsule tag corresponds to a genuine capsule in response to determining that a second key/identifier associated with the chain of custody represents a valid chain of custody (e.g., by comparing the second key/identifier with keys/identifiers stored on the aerosol-generating device 100 or another device, etc.). According to at least some example embodiments, the aerosol-generating device 100 may determine the capsule to be genuine when both the first and second key/identifiers are determined to be valid, or when at least one among the first key/identifier and the second key/identifier is determined to be valid. According to at least some example embodiments, the capsule operation metric value may vary according to how many among the first key/identifier and second key/identifier are determined to be valid, and/or whether the first key/identifier and/or the second key identifier are determined to be non-genuine a threshold number of times or more.

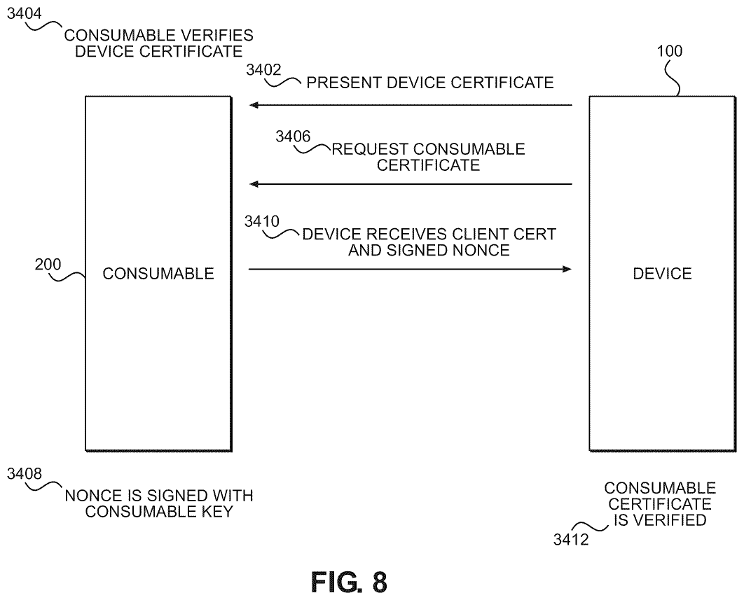

For example, referring to FIG. 8, illustrated is a process performed between a capsule 200 and the aerosol-generating device 100 for determining whether the capsule 200 is genuine using a key/identifier. In operation 3402, the aerosol-generating device 100 may transmit a device key/identifier of the aerosol-generating device 100 to the capsule 200 (e.g., via the RF device 1214). The device key/identifier may be a security certificate (e.g., a Public Key Infrastructure (PKI) certificate corresponding to the aerosol-generating device 100, etc.). In operation 3404, the capsule 200 may verify the device key/identifier. For example, the capsule 200 may perform data processing operations using processing circuitry (e.g., included in the tag of the capsule 200) powered by energy (e.g., RF energy) transmitted by the aerosol-generating device 100 according to RFID principles, to verify the device key/identifier as genuine and/or authentic using known cryptographic processes known to those of ordinary skill in the art.

In operation 3406, the aerosol-generating device 100 may transmit a request to the capsule 200 for a capsule key/identifier of the capsule (e.g., via the RF device 1214). The capsule key/identifier may be a security certificate (e.g., a PKI certificate corresponding to the capsule 200, etc.). In operation 3408, the capsule 200 may sign a nonce (e.g., a cryptographic number used only once) with the capsule key/identifier (e.g., the capsule 200 may sign the nonce with the private key stored in the memory of the capsule 200, etc.). According to some example embodiments, the capsule 200 may only perform operation 3408 in response to successfully verifying the device key/identifier, but some example embodiments are not limited thereto. In operation 3410, the capsule 200 may transmit the signed nonce to the aerosol-generating device 100. For example, the capsule 200 may transmit the signed nonce using the energy (e.g., RF energy) transmitted by the aerosol-generating device 100 according to RFID principles. In operation 3412, the aerosol-generating device 100 may verify the capsule key/identifier by decrypting the signed nonce with, for example, a security key associated with a manufacturer of the capsule 200 stored in the memory of the aerosol-generating device 100, etc., to determine whether the decrypted signed nonce corresponds to the original nonce transmitted to the capsule 200. The aerosol-generating device 100 may determine that the capsule 200 is a genuine capsule in response to successfully validating the signed nonce (e.g., the decrypted nonce matches the originally transmitted nonce). The aerosol-generating device 100 may determine that the capsule 200 is not a genuine capsule in response to a failure to validate the signed nonce, or in response to a failure to receive a signed nonce from the capsule 200.

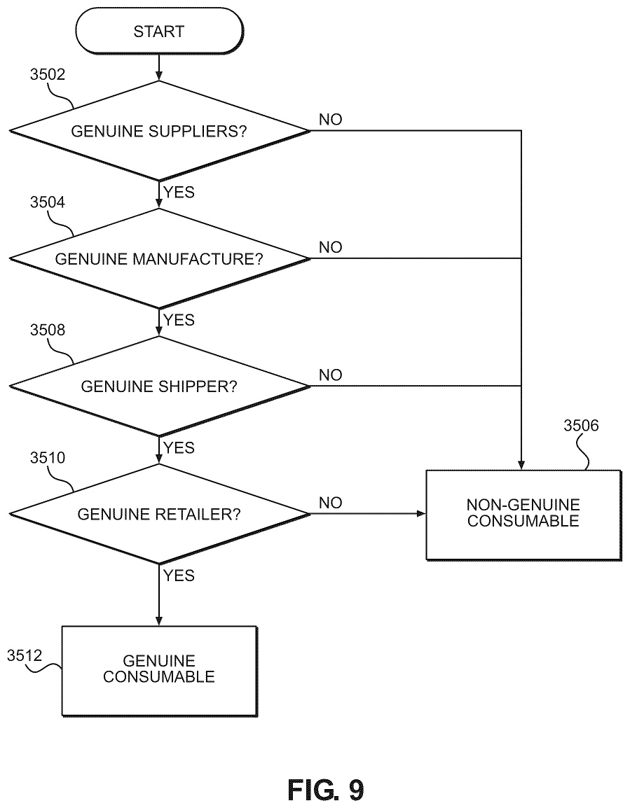

Also, referring to FIG. 9, illustrated is a process for determining whether a capsule 200 is genuine based on a chain of custody of the capsule 200. As discussed above, the tag of the capsule 200 may store an indication of a chain of custody of the capsule 200. According to some example embodiments, the tag may include at least one respective field for each of at least one supplier, at least one manufacturer, at least one shipper, at least one retailer, etc., but the example embodiments are not limited thereto, and for example, one or more fields (e.g., chain of custody entities) may be omitted and/or one or more additional fields may be included. The at least one supplier may refer to a supplier of the contents of the capsule 200 and/or of the capsule 200 itself. The at least one manufacturer may refer to a manufacturer of the capsule 200. The at least one shipper may refer to each entity that ships the capsule 200 (e.g., between the manufacturer and the retailer). The at least one retailer may refer to the retailer at which the authorized operator purchases the capsule 200, and/or any other retailer that possessed the capsule 200. According to some example embodiments, each time the capsule 200 is possessed by an entity (e.g., a supplier, a manufacturer, a shipper, a retailer, etc.), the entity transmits (e.g., using an RF transmitter, such as a tunnel scanner) a corresponding entity key/identifier (e.g., a PKI certificate) for storage on the tag of the capsule 200. According to some example embodiments, the manufacturer may transmit its PKI certificate for storage on the tag as well as that of the at least one supplier, etc. According to other example embodiments, the chain of custody information may be stored and tracked in a database of an external server, such as the second server 1570. The entities are discussed as including a supplier, a manufacturer, a shipper and a retailer, however some example embodiments are not limited thereto and other handling points of the capsule 200 may function as entities for tracking the chain of custody. According to some example embodiments, in addition to storing the entity key/identifier on the tag, a timestamp indicating a time at which the entity key/identifier was received from the corresponding entity may be stored in association with the entity key/identifier. Each timestamp may include a time at which the capsule 200 was received, and a time at which the capsule 200 was delivered, by a given entity.

In operation 3502, the aerosol-generating device 100 may read an inserted capsule 200 to detect whether a supplier field of the tag includes a supplier key/identifier. In response to detecting that the supplier field includes the supplier key/identifier, the aerosol-generating device 100 may attempt to verify the supplier key/identifier. In response to successful verification of the supplier key/identifier, the aerosol-generating device 100 may advance to operation 3504. In response to a failure to verify the supplier key/identifier, and/or in response to detecting that the supplier field does not include a supplier key/identifier, the aerosol-generating device may determine that the capsule 200 is not genuine in operation 3506. In operation 3504, the aerosol-generating device 100 may read the inserted capsule 200 to detect whether a manufacturer field of the tag includes a manufacturer key/identifier. In response to detecting that the manufacturer field includes the manufacturer key/identifier, the aerosol-generating device 100 may attempt to verify the manufacturer key/identifier. In response to successful verification of the manufacturer key/identifier, the aerosol-generating device 100 may advance to operation 3508. In response to a failure to verify the manufacturer key/identifier, and/or in response to detecting that the manufacturer field does not include a manufacturer key/identifier, the aerosol-generating device may determine that the capsule 200 is not genuine in operation 3506.

In operation 3508, the aerosol-generating device 100 may read the inserted capsule 200 to detect whether a shipper field of the tag includes a shipper key/identifier. In response to detecting that the shipper field includes the shipper key/identifier, the aerosol-generating device 100 may attempt to verify the shipper key/identifier. In response to successful verification of the shipper key/identifier, the aerosol-generating device 100 may advance to operation 3510. In response to a failure to verify the shipper key/identifier, and/or in response to detecting that the shipper field does not include a shipper key/identifier, the aerosol-generating device may determine that the capsule 200 is not genuine in operation 3506. In operation 3510, the aerosol-generating device 100 may read the inserted capsule 200 to detect whether a retailer field of the tag includes a retailer key/identifier. In response to detecting that the retailer field includes the retailer key/identifier, the aerosol-generating device 100 may attempt to verify the retailer key/identifier. In response to successful verification of the retailer key/identifier, the aerosol-generating device 100 may determine that the capsule 200 is genuine in operation 3512. In response to a failure to verify the retailer key/identifier, and/or in response to detecting that the retailer field does not include a retailer key/identifier, the aerosol-generating device may determine that the capsule 200 is not genuine in operation 3506.

According to some example embodiments, rather than determining that the capsule 200 is not genuine in operation 3506, or genuine in operation 3512, the aerosol-generating device 100 may determine that the likelihood of the capsule 200 being genuine decreases in operation 3506 and increases in operation 3512, such that the capsule operation metric value decreases or increases, respectively. Also, the likelihood of the capsule 200 being genuine determined in operations 3506 and 3512 may be combined with other information to determine the capsule operation metric value. For example, the aerosol-generating device 100 may read timestamps stored on the tag of the capsule 200 to detect whether any gaps are present between the time at which the capsule 200 was delivered by one entity and the time at which the capsule 200 was received by another entity. According to some example embodiments, the aerosol-generating device 100 may determine the likelihood of the capsule 200 being genuine as being decreased in response to detecting the existence of such a gap, and may decrease the capsule operation metric value. According to some example embodiments, the aerosol-generating device 100 may decrease the capsule operation metric value by an amount proportional to the size of the time gap. In response to determining that no time gaps are reflected by the tag of the capsule 200, the aerosol-generating device 100 may determine the likelihood of the capsule 200 being genuine as being increased, and may increase the capsule operation metric value. According to some example embodiments, the aerosol-generating device 100 may determine the capsule operation metric value based on the timestamps on the tag of the capsule 200 without verifying the entity key/identifiers, but some example embodiments are not limited thereto.

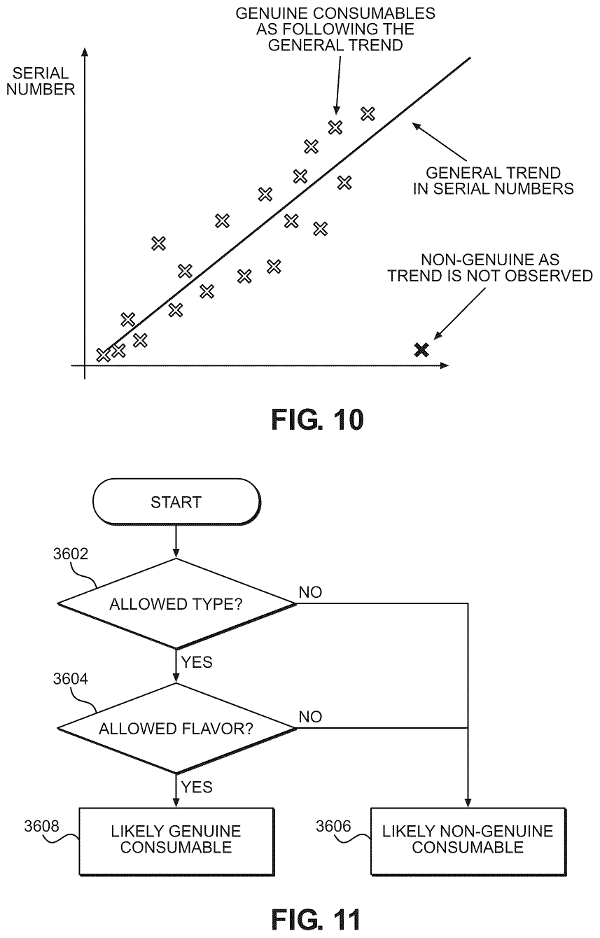

Additionally, referring to FIG. 10, illustrated is a graph for use in illustrating how a capsule 200 is determined to be genuine based on serial identifier and/or batch identifier information. The tag of the capsule 200 may store a serial identifier (also referred to herein as a serial number) and/or a batch identifier (also referred to herein as a batch number). The aerosol-generating device 100 may read an inserted capsule 200 to detect whether a serial number and/or batch number is indicative of a genuine capsule. For example, the aerosol-generating device 100 may store serial numbers and/or batch numbers of previously inserted capsules 200, and/or may store ruleset and/or an algorithm (e.g., manufacturer's ruleset, manufacturer's algorithm, etc.) for determining whether a serial number and/or batch number is a valid serial number and/or batch number. In at least one example embodiment, the aerosol-generating device 100 may compare the serial number and/or batch number of the currently inserted capsule 200 to determine whether it matches a serial number and/or batch number, respectively, of a previously inserted capsule 200. If so, the currently inserted capsule 200 may be determined to be not genuine.

Also, values of serial numbers and/or batch numbers of capsules 200 may generally increase and/or otherwise change over time as new capsules 200 are manufactured. The aerosol-generating device 100 may compare a value of the serial number and/or batch number of the currently inserted capsule 200 with values of the serial numbers and/or batch numbers of the previously inserted capsules 200 to determine whether the value of the serial number and/or batch number of the currently inserted capsule 200 reflects a trend of generally increasing serial numbers and/or batch numbers. In response to determining that the value of the serial number and/or batch number of the currently inserted capsule 200 reflects a trend of generally increasing serial numbers and/or batch numbers, the aerosol-generating device 100 may determine that the currently inserted capsule 200 is a genuine capsule. Otherwise, the aerosol-generating device 100 may determine that the currently inserted capsule 200 is not a genuine capsule. For example, the aerosol-generating device 100 may determine that the currently inserted capsule 200 is not a genuine capsule in response to determining that the value the value of the serial number and/or batch number of the currently inserted capsule 200 deviates from a line reflecting the average value of the values of the serial numbers and/or batch numbers of the previously inserted capsules 200 by a threshold amount or more. In some example embodiments, the aerosol-generating device 100 may compare the value of serial number and/or batch number of the currently inserted capsule 200 with expected values of serial numbers and/or batch numbers of future capsules (e.g., the general trend for future capsules 200) based on the stored serial number and/or batch number ruleset to determine whether the value of the currently inserted capsule 200 is within a desired and/or expected serial number range and/or batch number.

Also, referring to FIG. 11, illustrated is a process for determining whether a capsule 200 is genuine based on a type and/or flavor of the capsule 200. The tag of the capsule 200 may store an indication of a type of the capsule 200 and/or a flavor of the capsule 200. The type of the capsule 200 may refer to one or more of a composition (e.g., whether the contents of the capsule include nicotine or not), a strength (e.g., an amount of nicotine or other substance contained in the capsule), etc. The flavor of the capsule 200 may refer to a flavor of the contents of the capsule 200. In operation 3602, the aerosol-generating device 100 may read a type of an inserted capsule 200 from the tag of the inserted capsule 200, and compare the type of the inserted capsule 200 to a list of approved capsule types stored on the aerosol-generating device 100. According to some example embodiments, the list of approved capsule types may be set or updated at the POS device 1540 (e.g., during purchase of the aerosol-generating device 100 and/or purchase of the capsule 200), however some example embodiments are not limited thereto, and for example, the list of approved capsule types may be set or updated using the companion application, etc. In response to determining that the type of the inserted capsule 200 is included in the list of approved capsule types, the aerosol-generating device 100 may proceed to operation 3604. Otherwise, the aerosol-generating device 100 may determine that the inserted capsule 200 is not genuine in operation 3606. In operation 3604, the aerosol-generating device 100 may read a flavor of the inserted capsule 200 from the tag of the inserted capsule 200, and compare the flavor of the inserted capsule 200 to a list of approved flavor types stored on the aerosol-generating device 100. According to some example embodiments, the list of approved flavor types may be set or updated at the POS device 1540 (e.g., during purchase of the aerosol-generating device 100 and/or purchase of the capsule 200), however some example embodiments are not limited thereto, and for example, the list of approved flavor types may be set or updated using the companion application, etc. In response to determining that the flavor of the inserted capsule 200 is included in the list of approved flavor types, the aerosol-generating device 100 may determine that the inserted capsule 200 is a genuine capsule in operation 3608. Otherwise, the aerosol-generating device 100 may determine that the inserted capsule 200 is not a genuine capsule in operation 3606.

While the examples discussed in FIGS. 7-10 refer to determinations of whether or not a capsule 200 is genuine, however some example embodiments are not limited thereto. For example, instead of determining that a capsule 200 is genuine, the aerosol-generating device 100 may determine that the likelihood of the capsule 200 being genuine increases, and may increase the capsule operation metric value. Similarly, instead of determining that a capsule 200 is not genuine, the aerosol-generating device 100 may determine that the likelihood of the capsule 200 being genuine decreases, and may decrease the capsule operation metric value. Also, the two or more of the examples discussed in connection with FIGS. 7-10 may be performed in combination to determine the likelihood of the capsule 200 being genuine decreases as well as the capsule operation metric value. For example, the determinations of the likelihoods of the capsule 200 being genuine (or capsule operation metric values) performed according to two or more of the examples discussed in FIGS. 7-10 may be combined to determine a combined likelihood of the capsule 200 being genuine (or capsule operation metric value), with or without respective weighting to the corresponding likelihoods being combined.

Referring back to FIG. 7, the trusted retailer metric may be based on whether a capsule (e.g., a capsule inserted into the aerosol-generating device 100) is determined by the aerosol-generating device 100 to have been purchased from a trusted retailer. According to at least some example embodiments, the determination of whether the capsule was purchased from a trusted retailer as discussed herein may additionally, or alternatively, include determining whether the capsule was purchased from a trusted clerk (e.g., a trusted retail employee) of the retailer. When the capsule is determined to have been purchased from a trusted retailer, a value of the trusted retailer metric (e.g., a trusted retailer metric value) may be determined to reflect an increase in the authorized operator probability. In contrast, when the capsule is determined to not have been purchased from a trusted retailer, the trusted retailer metric may be determined to reflect a decrease in the authorized operator probability. As discussed above, the capsule tag may store various information that may be collected by the aerosol-generating device 100 (e.g., via the short-range RF device 1214).

According to at least some example embodiments, the aerosol-generating device 100 may receive and/or read the information from the capsule tag in encrypted form (e.g., each time a new capsule is inserted into the aerosol-generating device 100), and may subsequently decrypt the information (e.g., using the cryptographic module). The aerosol-generating device 100 may determine the trusted retailer metric (e.g., the trusted retailer metric value) based on the decrypted information. For example, the aerosol-generating device 100 may determine whether the capsule corresponding to the capsule tag was purchased from a trusted retailer and/or a trusted clerk based on information stored on the capsule tag (e.g., the indication of the age verification process used, the identifier of the retailer from which the capsule was purchased, the indication of the retailer trust score of the retailer and/or the indication of the clerk trust score of the clerk from whom the capsule was purchased). According to at least some example embodiments, retailers and/or clerks may be assigned respective trust scores based on their abilities to correctly verify an operator's age. As such, the determination of whether the capsule was purchased from a trusted retailer (and/or a trusted clerk) may be made based on the indication of the age verification process used and/or the identifier of the retailer from which the capsule was purchased, as well as (or alternatively) the indication of the retailer trust score of the retailer and/or the indication of the clerk trust score of the clerk from whom the capsule was purchased. According to at least some example embodiments, the aerosol-generating device 100 may determine whether the capsule corresponding to the capsule tag was purchased from a trusted retailer and/or a trusted clerk based on information a corresponding indication(s) received (e.g., via the Bluetooth device 1218) from the retailer or the companion application when a capsule is purchased. However, at least some example embodiments for determining whether the capsule was purchased from a trusted retailer and/or trusted clerk are not limited to the above examples, and the aerosol-generating device 100 may determine whether the capsule was purchased from a trusted retailer and/or trusted clerk according to any process that may be performed by the aerosol-generating device 100.

Also, according to at least some example embodiments, the aerosol-generating device 100 may determine a level of trust in the retailer and/or the clerk. For example, the retailer and/or the clerk may each be untrusted, or trusted according to one or more different trust levels. For example, each different trust level may correspond to a different trust score threshold, and the aerosol-generating device 100 may determine a trust level of the retailer and/or the clerk by comparing the retailer trust score and/or the clerk trust score to the different trust score thresholds. According to at least some example embodiments, the trust score thresholds compared to the retailer trust score are the same as, or similar to, those compared to clerk trust score. However, at least some example embodiments are not limited to, and the retailer trust score and clerk trust score may be compared to different sets of trust score thresholds.

When the aerosol-generating device 100 determines that the capsule was purchased from a trusted retailer and/or a trusted clerk, the aerosol-generating device 100 may determine the trusted retailer metric to reflect an increase in the authorized operator probability. For example, the trusted retailer metric value may be determined to reflect an increase in the authorized operator probability (e.g., an increase of ‘+25’) corresponding a determination that the retailer is a trusted retailer, the clerk is a trusted clerk, or a combination based on whether the retailer is determined to be a trusted retailer and the clerk is determined to be a trusted clerk. Also, the trusted retailer metric value may be determined to reflect a decrease in the authorized operator probability (e.g., a decrease of ‘-5’) corresponding a determination that the retailer is not a trusted retailer, the clerk is not a trusted clerk, or a combination based on whether the retailer is determined not to be a trusted retailer and the clerk is determined not to be a trusted clerk. Such a combination may be a weighted combination with different weights applied to the determination of whether the retailer is a trusted retailer, and the determination of whether the clerk is a trusted clerk, in determining the trusted retailer metric value. Also, the trusted retailer metric value may be determined to reflect an increase in the authorized operator probability based on the trust level of the retailer and/or the trust level of the clerk, such that higher trust levels are reflected as higher increases in the authorized operator probability.

The operation pattern metric may be based on whether a recent operating pattern matches an operating pattern model generated by the aerosol-generating device 100 (e.g., by the processing circuitry of the aerosol-generating device 100). For example, upon purchase of the aerosol-generating device 100 (e.g., starting with the first aerosol-generating operation of the aerosol-generating device 100), the aerosol-generating device 100 may generate an operating pattern model associated with the current operator based on various operating information (and/or behavior pattern information) collected by and/or sensed by the aerosol-generating device 100. Such operating information may include, for example, session length, operation time of day, capsule operation rate, number of capsules used, last capsule pack verification, typical capsule type, typical capsule flavor, typical capsule purchase location, etc.

The session length may refer to a duration of time during which the aerosol-generating device 100 is being operated to perform an aerosol-generation operation. For example, the session length may refer to a duration of time of a single puff performed by the current operator, a duration of time from the start of a first puff to a time point at which a time period following a puff end exceeds a threshold time, etc. The aerosol-generating device 100 may determine the session length and/or the operation time of day using, for example, one or more flow sensors, the real-time clock 1220, etc.

The aerosol-generating device 100 may determine the capsule operation rate, number of capsules used, last capsule pack verification, typical capsule type, typical capsule flavor and/or typical capsule purchase location using, for example, information stored on capsule tags, the real-time clock 1220, etc. As discussed above, the aerosol-generating device 100 may read the information stored on a capsule tag each time a new capsule is inserted into the aerosol-generating device 100 (e.g., using the RF device 1214), and may use this information to track the above operating information. The capsule type may refer to a type of product contained in the capsule, a configuration of the capsule, etc. The typical capsule purchase location may be based on the identifier of a retailer from which the capsule was purchased obtained from the capsule tag.

According to at least some example embodiments, the aerosol-generating device 100 may generate the operating pattern model based on information corresponding to the authorized operator collected for the determination of other behavior metrics among the plurality of behavior metrics (e.g., the indication of whether the retailer is a trusted retailer/retailer trust level, companion application communication information, indications of age verification results, etc.) in addition to, or alternatively to, the various operating information described above.

According to at least some example embodiments, the aerosol-generating device 100 may generate the operating pattern model through a machine learning process. For example, after the purchase of the aerosol-generating device 100 and successful age verification of the authorized operator, the aerosol-generating device 100 may continuously track the operating information corresponding to the authorized operator and/or information associated with the authorized operator collected for the determination of other behavior metrics, and use this tracked information (e.g., historical operating pattern) to train the machine learning process to generate the authorized operating pattern model. The authorized operating pattern model may represent the operating pattern of the authorized operator. After the aerosol-generating device 100 completes the generation of the authorized operating pattern model, the aerosol-generating device 100 may collect an updated recent operating pattern (e.g., the operating information, and/or information collected for the determination of other behavior metrics, that may be the same as or similar to that used to generate the authorized operating pattern model) of a current operator of the aerosol-generating device 100, and may input the updated recent operating pattern into the trained machine learning process to generate a recent operating pattern model. The aerosol-generating device 100 may then determine whether the recent operating pattern model sufficiently matches the authorized operating pattern model. The aerosol-generating device 100 may determine that the recent operating pattern model matches the authorized operating pattern model in response to determining that the recent operating pattern model positively correlates with the authorized operating pattern model beyond a threshold level. When the recent operating pattern model associated with the current operator of the aerosol-generating device 100 is determined to match the authorized operating pattern model of the authorized operator of the aerosol-generating device 100, the aerosol-generating device 100 may determine a value of the operation pattern metric (e.g., an operation pattern metric value) to reflect an increase in the authorized operator probability of the current operator. In contrast, when the recent operating pattern model of the current operator is determined not to match the authorized operating pattern model of the authorized operator of the aerosol-generating device 100, the aerosol-generating device 100 may determine the operation pattern metric value to reflect a decrease in the authorized operator probability of the current operator. For example, the aerosol-generating device 100 may determine the operation pattern metric value of the current operator to reflect an increase in the authorized operator probability when the authorized operating pattern model matches the recent operating pattern model Also, the aerosol-generating device 100 may determine the operation pattern metric value to reflect a decrease in the authorized operator probability when the authorized operating pattern model does not match the recent operating pattern model. According to at least some example embodiments, the operation pattern metric may enable the aerosol-generating device 100 to determine an increased authorized operator probability of a current operator in response to regular operation of the aerosol-generating device 100 (e.g., once per day, etc.).

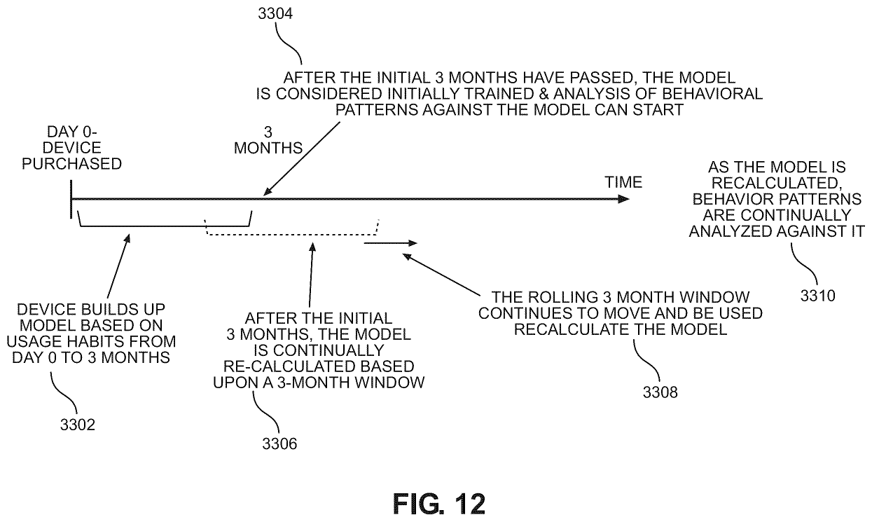

Referring to FIG. 12, depicted are time windows for use in illustrating the generating and updating of the authorized operating pattern model. In operation 3302, the aerosol-generating device 100 may train the machine learning process to generate the authorized operating pattern model using the historical operating pattern. For example, it may be more likely that the operator that operates the aerosol-generating device 100 more recently after purchase of the aerosol-generating device 100 is the authorized operator. Accordingly, the aerosol-generating device 100 may treat the historical operating pattern of the aerosol-generating device 100 within an initial training period of time from purchase of the aerosol-generating device 100 as a base truth with respect to the operating pattern of the authorized operator. As such, the training of the machine learning process may include generating a developmental operating pattern model based on the historical operating pattern, generating a recent operating pattern model based on a recent operating pattern, comparing the developmental operating pattern model with the recent operating pattern model to detect an amount of error (e.g., an extent to which the developmental operating pattern model does not match the recent operating pattern model), and adjusting the machine learning process based on the amount of error. The aerosol-generating device 100 continues to train the machine learning process to reduce the amount of error between a current developmental operating pattern model and recent operating pattern models until the end of the initial training period of time. According to at least some example embodiments, the initial training period of time may be a specific time period (e.g., three months), however at least some example embodiments are not limited thereto. For example, the initial training period of time may continue until the amount of error between a current developmental operating pattern model and recent operating pattern models falls to a desired threshold level. For example, the aerosol-generating device 100 may train the machine learning process until a threshold number of consecutive recent operating pattern models are determined to sufficiently match the current developmental operating pattern model. According to at least some example embodiments, in operation 3304, the current developmental operating pattern model at the end of the initial training period of time is determined to represent the authorized operating pattern model.

According to at least some example embodiments, the aerosol-generating device 100 may continually update the authorized operating pattern model over time. For example, the aerosol-generating device 100 may update the authorized operating pattern model by retraining the machine learning process accordingly to recent operating patterns using a process that is the same as, or similar to, that discussed above as being used to generate the authorized operating pattern model, but at least some example embodiments are not limited thereto. For example, the aerosol-generating device 100 may alternatively or additionally update the authorized operating pattern model by directly adjusting parameters (or values thereof) based on recent operating patterns at desired time intervals, for example, at monthly time intervals, but the example embodiments are not limited thereto, and for example, the updates may occur on a daily basis, a weekly basis, a three-month basis, a yearly basis, etc. In operation 3306, the aerosol-generating device 100 may update the authorized operating pattern model based on recent operating patterns obtained within a specific time window (e.g., a three-month time window from the date that the update is performed, etc.). According to this example, as newer recent operating patterns are added to a data set on which the authorized operating pattern model is based, older recent operating patterns may be removed from the data set in operation 3308, however at least some example embodiments are not limited thereto. For example, according to at least some example embodiments, the newer recent operating patterns may be added to the data set without removing the older recent operating patterns such that each individual recent operating pattern has a reduced impact on the authorized operating pattern model over time. For example, temporary changes in the adult vaper's operating pattern, e.g., due to the adult vaper going on vacation in a new city, changes in work schedule, etc., may have a reduced impact on the authorized operating pattern model over time, whereas permanent change in the adult vaper's operating pattern, e.g., a permanent move to a new city, a permanent change in work schedule, etc., may result in a permanent change in the updated authorized operating pattern model. In operation 3310, the operation pattern metric value may be determined by the aerosol-generating device 100 using the continuously updated authorized operating pattern model.

Referring back to FIG. 7, according to at least some example embodiments, the aerosol-generating device 100 may generate a puff profile model associated with the authorized operator separate from the operating pattern model and use the generated puff profile model to determine whether the puff profile of a current operator is the same and/or substantially similar to the puff profile model of the authorized operator. The aerosol-generating device 100 may generate the puff profile model of the authorized operator based on various puff information and/or historical behavior information corresponding to the authorized operator such as, for example, puff duration, session length, peak airflow per puff, number of puffs per session, time to first puff (e.g., from powering on of the aerosol-generating device 100), etc., that is typical and/or routine behavior of the authorized operator. The aerosol-generating device 100 may determine the puff information corresponding to the authorized operator from data collected from, for example, the one or more flow sensors, the real-time clock 1220, etc.

According to at least some example embodiments, the aerosol-generating device 100 may generate the puff profile model associated with the authorized operator (also referred to herein as an authorized puff profile model) through a machine learning process, similar to the machine learning process for the operating pattern model. For example, after the purchase of the aerosol-generating device 100 and successful verification of the age of the authorized operator, the aerosol-generating device 100 may continuously track the puff information of the authorized operator and use this tracked puff information (e.g., historical puff information) to train the machine learning process to generate the puff profile model. The authorized puff profile model may represent the puff profile of the authorized operator. After the aerosol-generating device 100 completes the generation of the authorized puff profile model, the aerosol-generating device 100 may collect updated recent puff profile (e.g., the puff information) corresponding to a current operator, and may input the updated recent puff profile into the trained machine learning process to generate a recent operating pattern model. The aerosol-generating device 100 may then determine whether the recent operating pattern model sufficiently matches the authorized puff profile model. The aerosol-generating device 100 may determine that the recent puff profile model matches the authorized puff profile model in response to determining that the recent puff profile model positively correlates with the authorized puff profile model beyond a threshold level. When the recent puff profile model associated with the current operator of the aerosol-generating device 100 is determined to match the authorized puff profile model of the authorized operator of the aerosol-generating device 100, the aerosol-generating device 100 may determine a value of the operation pattern metric (e.g., an operation pattern metric value) to reflect an increase in the authorized operator probability of the current operator. In contrast, when the recent puff profile model of the current operator is determined not to match the authorized puff profile model of the authorized operator of the aerosol-generating device 100, the aerosol-generating device 100 may determine the operation pattern metric value to reflect a decrease in the authorized operator probability of the current operator. For example, the aerosol-generating device 100 may determine the operation pattern metric value of the current operator to reflect an increase in the authorized operator probability when the authorized puff profile model matches the recent puff profile model Also, the aerosol-generating device 100 may determine the operation pattern metric value to reflect a decrease in the authorized operator probability when the authorized puff profile model does not match recent puff profile model.

According to at least some example embodiments, the aerosol-generating device 100 may train the machine learning process to generate the authorized puff profile model according to a process at least similar to that discussed above in connection with FIG. 12. For example, the aerosol-generating device 100 may train the machine learning process to generate the authorized puff profile model using the updated recent puff profile (e.g., the puff information) corresponding to a current operator. According to at least some example embodiments, the machine learning process used to generate the authorized puff profile model may be different from that used to generate the authorized operating pattern model, however at least some example embodiments are not limited thereto. As with the authorized operating pattern model, the aerosol-generating device 100 may treat the updated recent puff profile of the aerosol-generating device 100 within an initial training period of time from purchase of the aerosol-generating device 100 as a base truth with respect to the puff profile of the authorized operator. As such, the training of the machine learning process may include generating a developmental puff profile model based on previous puff information, generating a recent puff profile model based on an updated recent puff profile, comparing the developmental puff profile model with the recent puff profile model to detect an amount of error (e.g., an extent to which the developmental puff profile model does not match the recent puff profile model), and adjusting the machine learning process based on the amount of error (e.g., to reduce the amount of error). The aerosol-generating device 100 continues to train the machine learning process to reduce the amount of error between a current developmental puff profile model and recent puff profile models until the end of the initial training period of time. According to at least some example embodiments, the initial training period of time may be a specific time period (e.g., three months), however at least some example embodiments are not limited thereto. For example, the initial training period of time may continue until the amount of error between a current developmental puff profile model and recent puff profile models falls to a desired threshold level. For example, the aerosol-generating device 100 may train the machine learning process until a threshold number of consecutive recent puff profile models are determined to sufficiently match the current developmental puff profile model. According to at least some example embodiments, the current developmental puff profile model at the end of the initial training period of time is determined to represent the authorized puff profile model.

According to at least some example embodiments, the aerosol-generating device 100 may continually update the authorized puff profile model over time. For example, the aerosol-generating device 100 may update the authorized puff profile model by retraining the machine learning process accordingly to updated recent puff profiles using a process that is the same as, or similar to, that discussed above as being used to generate the authorized puff profile model, but at least some example embodiments are not limited thereto. For example, the aerosol-generating device 100 may alternatively or additionally update the authorized puff profile model by directly adjusting parameters (or values thereof) based on updated recent puff profiles. The aerosol-generating device 100 may update the authorized puff profile model based on updated recent puff profiles obtained within a specific time window (e.g., three months). According to this example, as newer updated recent puff profiles are added to a data set on which the authorized puff profile model is based, older updated recent puff profiles may be removed from the data set, however at least some example embodiments are not limited thereto. For example, according to at least some example embodiments, the newer updated recent puff profiles may be added to the data set without removing the older updated recent puff profiles such that each individual updated recent puff profile has a reduced impact on the authorized puff profile model over time. The operation pattern metric value may be determined by the aerosol-generating device 100 using the continuously updated authorized puff profile model.

According to at least some example embodiments, the aerosol-generating device 100 may determine the operation pattern metric based on whether the recent puff profile model of the current operator matches the authorized puff profile model instead of determining the operation pattern metric using the authorized operating pattern model. According to at least some example embodiments, the aerosol-generating device 100 may determine the operation pattern metric value based on a combination of whether the recent operating pattern model matches the authorized operating pattern model and whether the recent puff profile model matches the authorized puff profile model. Such a combination may be a weighted combination with different weights applied to the determination of whether the recent operating pattern model matches the authorized operating pattern model, and the determination of whether the recent puff profile model matches the authorized puff profile model.

According to at least some example embodiments, the processing circuitry of the aerosol-generating device 100 may perform some operations (e.g., the operations described herein as being performed by the machine learning process for generating the authorized operating pattern model and/or the machine learning process for generating the authorized puff profile model) by artificial intelligence and/or machine learning. As an example, the processing circuitry of the aerosol-generating device 100 may implement an artificial neural network that is trained on a set of training data associated with the authorized operator by, for example, a supervised, unsupervised, and/or reinforcement learning model, and wherein the processing circuitry may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

A value of the location metric (e.g., a location metric value) may reflect that the authorized operator probability increases based on a determination that the aerosol-generating device 100 is used in a known location, and decreases based on a determination that the aerosol-generating device 100 is used in an unknown location or restricted location. As discussed in connection with FIG. 4, the aerosol-generating device 100 may be operated in a communication system 1500 including, for example, an access point 1520 and/or a wireless device 1530. According to at least some example embodiments, the aerosol-generating device 100 may scan (e.g., passively or actively) for communications signals detectable by the aerosol-generating device 100 (e.g., using the RF device 1214, the background RF scanner and/or the Bluetooth device 1218). For example, the aerosol-generating device 100 may collect signal traffic information corresponding to wireless communication signals transmitted by the access point 1520 and/or the wireless device 1530. In so doing, the aerosol-generating device 100 may detect (e.g., passively detect) networks (e.g., Wi-Fi networks), Bluetooth devices, etc. According to at least some example embodiments, the wireless communication signals may include respective indications identifying the corresponding devices that transmitted the wireless communication signals (e.g., the access point 1520 and/or the wireless device 1530). For example, the wireless communication signals may include periodically transmitted signals for establishing and/or maintaining a communication link (e.g., beacon signals, heartbeat signals, etc.). The signal traffic information collected by the aerosol-generating device 100 may include these indications identifying wireless devices in the area of the aerosol-generating device 100. As such, the collected signal traffic information (e.g., a plurality of identifiers identifying networks and other wireless devices historically within range of the aerosol-generating device 100) may serve as a fingerprint associated with the area (e.g., location information), and may be used to identify and/or differentiate the area. Such collected location information may be stored in the aerosol-generating device 100 (e.g., in the secure non-volatile memory 1222).

The aerosol-generating device 100 may determine, e.g., during an aerosol-generation operation of the aerosol-generating device 100, the location metric based on whether a fingerprint corresponding to a current location of the aerosol-generating device 100 matches the fingerprint corresponding to location information stored in the aerosol-generating device 100. For example, the aerosol-generating device 100 may collect updated signal traffic information (e.g., a plurality of identifiers identifying networks and other wireless devices recently within range of the aerosol-generating device 100 and/or a fingerprint associated with the updated signal traffic information), and determine whether the updated signal traffic information corresponds to (e.g., matches) the stored location information (e.g., stored signal traffic information, a stored fingerprint, etc.). The aerosol-generating device 100 may determine that the updated signal traffic information corresponds to the stored location information when a desired threshold number (or percentage) of identifiers (identifying networks and other wireless devices) of the stored location information (e.g., the plurality of identifiers identifying networks and other wireless devices historically within range of the aerosol-generating device 100) is included in the updated signal traffic information. The aerosol-generating device 100 may determine the location metric value as reflecting a higher authorized operator probability in response to determining that the updated signal traffic information corresponds to the stored location information. The aerosol-generating device 100 may determine the location metric value as reflecting a lower authorized operator probability in response to determining that the updated signal traffic information does not correspond to the stored location information. For example, the aerosol-generating device 100 may determine the location metric value as reflecting a lower authorized operator probability in response to determining that none of the identifiers of the stored location information are included in the updated signal traffic information, or in other words, the aerosol-generating device 100 is located in a location where the aerosol-generating device 100 has not been previously operated.

According to at least some example embodiments, the updated signal traffic information may include an identifier of and/or message from a wireless beacon (e.g., an RF beacon) indicating that operation of the aerosol-generating device 100 may be restricted at a current location of the aerosol-generating device 100 (e.g., within range of the wireless beacon). Such a wireless beacon may be positioned at, for example, a school, a hospital, a government building, bus, train, airplane, etc. The aerosol-generating device 100 may determine the location metric as reflecting a lower authorized operator probability in response to determining that the updated signal traffic information includes the identifier of the wireless beacon. According to at least some example embodiments, the aerosol-generating device 100 may adjust the authorized operator probability to a lowest value, and/or may disable the aerosol-generation functionality of the aerosol-generating device 100, in response to such a determination that the updated signal traffic information includes the identifier of and/or message from the wireless beacon.

The companion application connection metric may be based on interaction with a companion application installed and executed, for example, on the UE 1510. According to at least some example embodiments, the aerosol-generating device 100 may be registered to, or paired with, the UE 1510 via the companion application. The aerosol-generating device 100 may attempt to connect to the companion application, e.g., periodically, when a new capsule is inserted therein, when an aerosol-generation operation is performed, etc. The aerosol-generating device 100 may determine a value of the companion application connection metric (e.g., a companion application connection metric value) reflecting a higher authorized operator probability in response to successfully connecting to the companion application (e.g., regularly connecting to the companion application over a period of time, for example, connecting once per week). For example, successful connection to the companion application may provide an indication that the UE 1510 is within communication range of the aerosol-generating device 100. The aerosol-generating device 100 may determine the companion application connection metric value reflecting a lower authorized operator probability in response to failed attempts at connecting to the companion application.

Additionally, or alternatively, the aerosol-generating device 100 may connect to the companion application to determine a companion application status. For example, the companion application status may include one or more status indicators indicating whether, for example, the companion application is also installed on another device (e.g., in addition to the UE 1510), the companion application is installed on a device (e.g., the UE 1510) that is jailbroken, the companion application has been uninstalled and reinstalled, the companion application has been modified or corrupted, the companion application is out-of-date, etc. The aerosol-generating device 100 may determine the companion application status as unreliable in response to determining that any of the one or more status indicators is satisfied, in response to determining that a threshold number of the one or more status indicators is satisfied, or in response to determining that a weighted combination of the one or more status indicators (satisfied or unsatisfied) exceeds a desired status threshold (in such an example, a satisfied indicator may be quantified as a low number, such as ‘0’ or ‘−1,’ and an unsatisfied indicator may be quantified as ‘1’, but is not limited thereto). Otherwise, the aerosol-generating device 100 may determine the companion application status as reliable. The aerosol-generating device 100 may determine the companion application connection metric value reflecting a lower authorized operator probability in response to determining the companion application status as unreliable. The aerosol-generating device 100 may determine the companion application connection metric value reflecting a higher authorized operator probability in response to determining the companion application status as reliable.

Additionally, or alternatively, the aerosol-generating device 100 may determine whether the authorized operator has been age verified using the companion application. Such an age verification performed through the companion application may provide an indication of normal operation of the companion application, in addition to the indication of the authorized operator being age verified. The aerosol-generating device 100 may determine the companion application connection metric value reflecting a higher authorized operator probability in response to determining that the authorized operator has been age verified using the companion application. The aerosol-generating device 100 may determine the companion application connection metric reflecting a lower authorized operator probability in response to determining that the authorized operator has not been age verified using the companion application.

According to at least some example embodiments, the aerosol-generating device 100 may determine the companion application connection metric value based on a combination (e.g., a weighted combination) of values respectively corresponding to connecting to the companion application, the companion applications status and/or age verification using the companion application.

As discussed above with respect to various behavior metrics, one or more among the plurality of behavior metrics may be determined based on a combination of different data. According to at least some example embodiments, such a combination may be a weighted combination in which a different weight is applied to one or more of the different data, however at least some example embodiments are not limited thereto. Also, according to at least some example embodiments, the combination of different data may be, for example, a sum, an average, etc.

As discussed above, the one or more determined behavior metrics may not include all of the behavior metrics among the plurality of behavior metrics discussed above. In a first example, according to at least some example embodiments, only the time metric, the age verification metric, the capsule operation metric, the trusted retailer metric, the operation pattern metric and/or the location metric may be determined, without determining the companion application connection metric. Also, in this example, the age verification metric may be determined based on an indication of a result of an age verification operation obtained from a capsule. Accordingly, in this first example, the aerosol-generating device 100 is able to determine the one or more behavior metrics without communicating (e.g., transmitting data to) another device. For instance, the behavior information obtained to determine the one or more behavior metrics of this first example may be obtained using internal components of the aerosol-generating device 100 along with behavior information read from the tag of one or more capsules.

In a second example, the time metric, the age verification metric, the capsule metric, the trusted retailer metric, the operation pattern metric, the location metric and/or the companion application metric may be determined, where the age verification metric is determined without communicating with an external server (e.g., the first server 1560). For instance, the age verification process may be performed by the companion application or the POS device 1540 without communicating (e.g., transmitting data to) another external device. As such, the behavior information obtained to determine the one or more behavior metrics of this first example may be obtained using internal components of the aerosol-generating device 100 along with behavior information read from the tag of one or more capsules and/or obtained from the companion application.

As discussed above, existing aerosol-generating devices, and methods for controlling such devices, rely on communication with (e.g., transmitting data to) external devices (e.g., external servers) to determine operability of the existing devices based on an age validation process performed with the external server. As a result, an operator of the existing devices is compelled to frequently interact with the external device to restore and/or maintain aerosol-generation functionality. This interaction is excessively burdensome on the operator of the existing devices, resulting in an unsatisfactory experience in using the existing devices, cause data privacy concerns for the operator of the existing devices (e.g., such as an increased probability of exposure of personal identifying information of the operator, location information, etc.), and/or may not comply with data security regulations in some jurisdictions, such as the General Data Protection Regulation (GDPR) of the European Union.

However, according to at least some example embodiments, improved aerosol-generating devices, and methods for controlling the same, are provided. For example, the improved devices may determine an authorized operator probability, representing a likelihood that a current operator of the improved devices is an authorized operator, based on behavior metrics and disable aerosol-generating functionality when this probability falls below a behavior threshold. As discussed in connection with the first and second examples above, the improved devices may determine the behavior metrics based on behavior information without communicating with (e.g., transmitting data to) an external server, or any other external device (e.g., the first example). Accordingly, the improved devices may maintain normal functionality without any (or with fewer and/or less frequent) inputs from the operator (for example, without the operator being compelled to perform age verification and/or authentication with an external server). Therefore, the improved devices and methods overcome the deficiencies of the existing devices and methods to at least reduce the interaction burden on the operator, increasing the data security of information associated with the operator, etc., thereby improving the experience of operating the improved devices.

In operation 1920, the aerosol-generating device 100 may determine the authorized operator probability. According to at least some example embodiments, the aerosol-generating device 100 may determine the authorized operator probability by combining the values of the plurality of behavior metrics determined in operation 1910. According to at least some example embodiments, the aerosol-generating device 100 may determine the authorized operator probability according to a summation method and/or a weighted average method.

The aerosol-generating device 100 may determine the authorized operator probability according to the summation method by summing the values of the plurality of behavior metrics. As discussed above, each of the plurality of behavior metrics may be represented by a corresponding value. According to at least some example embodiments, this value may be, for example, an integer, and may be negative or positive according to whether the behavior metric value increases the authorized operator probability. For example, a given behavior metric value may be positive to reflect that the various data forming the basis for the given behavior metric value corresponds to a higher authorized operator probability. Also, a given behavior metric value may be positive to reflect that the various data forming the basis for the given behavior metric value corresponds to a higher authorized operator probability. According to the summation method, the authorized operator probability may be determined by summing the positive and negative values of the plurality of behavior metrics to obtain a total value representing the authorized operator probability. For example, a higher total value may represent a higher authorized operator probability, and a lower total value may represent a lower authorized operator probability.

As an example of the summation method, the determined behavior metrics may include the trusted retailer metric, the operation pattern metric and the age verification metric. The trusted retailer metric may have a trusted retailer metric value of, for example, ‘−10’ reflecting that a capsule was purchased from a non-trusted retailer, thereby decreasing the authorized operator probability by ‘10’ from its previous value, but the example embodiments are not limited thereto. The operation pattern metric may have an operation pattern metric value of, e.g., ‘−20’ reflecting a recent operating pattern that that is classified as a non-matching operating pattern, thereby decreasing the authorized operator probability by ‘20’ from its previous value. The age verification metric may have an age verification metric value of, e.g., ‘+60’ reflecting that a successful age verification process was completed at a trusted retailer, thereby increasing the authorized operator probability by ‘60’ from its previous value. The summed value of the determined behavior metrics in this example may be an increase of ‘30’ from an initial value of the authorized operator probability (e.g., the value of the authorized operator probability prior to be initiation of the summation method). According to at least some example embodiments, in an example in which the initial value of the authorized operator probability is zero, or ‘30’ or less, the summed value of the determined behavior metrics may result in an authorized operator probability of ‘60’.

The aerosol-generating device 100 may determine the authorized operator probability according to the weighted average methods by applying a respective weight to each of the plurality of behavior metrics (e.g., values of the plurality of behavior metrics), and calculating an average value of the weighted values of the plurality of behavior metrics. The average value may represent the authorized operator probability. For example, a higher average value may represent a higher authorized operator probability, and a lower average value may represent a lower authorized operator probability.

According to at least some example embodiments, operations 1910 and/or 1920 may be performed periodically (e.g., according to a fixed or alternatively, given time period), and/or in response to one or more triggers. The one or more triggers may include, for example, a time period since operation 1920 was last performed exceeding a desired threshold time period (e.g., an hour, etc.), occurrence of an operation event (e.g., an aerosol-generation operation), a new capsule being inserted into the aerosol-generating device 100, use of the aerosol-generating device in a restricted location, a new connection with the companion application, etc. According to at least some example embodiments, a number and type of the one or more triggers may be dynamically modified according to changes in the determined authorized operator probability and/or behavior thresholds.

In operation 1930, the aerosol-generating device 100 may control the operation thereof according to the determined authorized operator probability. For example, the aerosol-generating device 100 may compare the determined authorized operator probability to one or more behavior thresholds (may also be referred to herein as behavior threshold values and/or desired behavior threshold values). For example, the one or more behavior thresholds may include only a single behavior threshold, but is not limited thereto. In such an example, a determined authorized operator probability lower than or equal to the single behavior threshold may represent a lowest probability range, and a determined authorized operator probability exceeding the single behavior threshold may represent a highest probability range. In response to determining that the determined authorized operator probability represents the lowest probability range, the aerosol-generating device 100 may disable (e.g., prevent, block, lock, impede, suspend, etc.) the aerosol-generation functionality of the aerosol-generating device 100. For example, the aerosol-generating device 100 may disable (e.g., prevent, block, lock, impede, suspend, etc.) powering of the heater of the aerosol-generating device 100 while the aerosol-generation functionality remains in the disabled state. According to at least some example embodiments, the aerosol-generating device 100 may remain in the disabled state until the aerosol-generating device 100 receives (e.g., via the RF device 1214 and/or the Bluetooth device 1218) an indication that the authorized operator has successfully performed an age verification process (e.g., at a store, online, via the companion application, etc.). In response to determining that the determined authorized operator probability represents the highest probability range, the aerosol-generating device 100 may continue normal operations, including permitting the aerosol-generation functionality of the aerosol-generating device 100.

According to at least some example embodiments, the one or more behavior thresholds may include a plurality of behavior thresholds. In this example, a determined authorized operator probability lower than or equal to the lowest behavior threshold among the plurality of behavior thresholds may represent the lowest probability range discussed above and result in the same, or similar, control of the aerosol-generating device 100 as discussed above (e.g., disabling the aerosol-generation functionality). Also, a determined authorized operator probability exceeding the highest behavior threshold among the plurality of behavior thresholds may represent the highest probability range discussed above and result in the same, or similar, control of the aerosol-generating device 100 as discussed above (e.g., permitting the aerosol-generation functionality). A determined authorized operator probability that is lower or equal to the highest behavior threshold, and exceeds the lowest behavior threshold, may represent an intervening probability range. In response to determining that the determined authorized operator probability represents the intervening probability range, the aerosol-generating device 100 may control the aerosol-generating device 100 perform one or more actions such as, for example, output a notification (e.g., notify the operator that an updated age verification process should be performed to avoid reduced performance of the aerosol-generating device 100 or avoid a possible lockout/disablement of the aerosol-generating device 100), reduce performance of the aerosol-generating device 100 (e.g., reduce session length, puff length, etc.) etc.

In circumstances in which the plurality of behavior thresholds includes more than two behavior thresholds, a plurality of intervening probability ranges may be represented. Each of the plurality of intervening probability ranges, from a lowest intervening probability range to a highest intervening probability range, may correspond to ranges of increasing authorized operator probability. As such, actions performed by the aerosol-generating device 100 based on a determined authorized operator probability in a lower intervening probability range may be more severe than actions performed by the aerosol-generating device 100 based on a determined authorized operator probability in a higher intervening probability range. The plurality of behavior thresholds, as well as the corresponding intervening probability ranges, may be spaced apart such that an operator of the aerosol-generating device 100 receiving a notification corresponding to a higher probability range has sufficient time to take actions to increase the authorized operator probability before the determined authorized operator probability falls to a lower intervening probability range.

According to at least some example embodiments, the various intervening probability ranges correspond to different actions to be performed by the aerosol-generating device 100 in response to determining that the determined authorized operator probability falls therein. For example, in a highest intervening probability range, the aerosol-generating device 100 may continue normal operations, and may notify/prompt the operator of the aerosol-generating device 100 at a lower frequency (e.g., 2-3 times per year) to perform operations to increase the authorized operator probability (e.g., performing an updated age verification process, purchasing a genuine capsule, purchasing a capsule from a trusted retailer/clerk, using the companion application, operating the aerosol-generating device 100 at a known location (such as the authorized operator's residence), etc.) to avoid (or reduce) interruption in use. At a lower intervening probability range than the highest intervening probability range, the aerosol-generating device 100 may continue normal operations, and may notify/prompt the operator of the aerosol-generating device 100 at a higher frequency (e.g., weekly) to perform operations to increase the authorized operator probability (e.g., performing an updated age verification process, purchasing a genuine capsule, purchasing a capsule from a trusted retailer/clerk, using the companion application, operating the aerosol-generating device 100 at a known location (such as the authorized operator's residence), etc.) to avoid (or reduce) interruption in use. At a lowest intervening probability range, the aerosol-generating device 100 may reduce performance of the aerosol-generating device 100 (e.g., reduce session length, puff length, etc.) and continue notifying/prompting the operator of the aerosol-generating device 100 at a higher frequency (e.g., daily) to perform operations to increase the authorized operator probability (e.g., performing an updated age verification process, purchasing a genuine capsule, purchasing a capsule from a trusted retailer/clerk, using the companion application, operating the aerosol-generating device 100 at a known location (such as the authorized operator's residence), etc.) to avoid (or reduce) disablement of the aerosol-generation functionality of the aerosol-generating device 100.

According to at least some example embodiments, the aerosol-generating device 100 may adjust/update the one or more behavior thresholds. For example, in response to negative operation factors such as, the authorized operator probability remaining at a lower value for an extended time period, operation of the aerosol-generating device 100 in a restricted area, repeated operation of the aerosol-generating device 100 while the authorized operator probability is lower, etc., the aerosol-generating device 100 may increase at least one among the one or more behavior thresholds. As such, the severity of actions performed in correspondence with the various probability ranges may increase at a faster rate as the authorized operator probability decreases. Alternatively, in response to positive operation factors, such as operation of the aerosol-generating device 100, while the authorized operator probability is higher, for an extended period of time, etc., the aerosol-generating device 100 may decrease at least one among the one or more behavior thresholds. As such, the severity of actions performed in correspondence with the various probability ranges may increase at a slower rate as the authorized operator probability decreases. According to at least some example embodiments, the adjustment of the one or more behavior thresholds may be performed based on a combination (e.g., a weighted combination) of operation factors such as those provided above.

According to at least some example embodiments, the aerosol-generating device 100 may output the notifications discussed above via the companion application (e.g., installed and executed on the UE 1510) and/or an operator interface on the aerosol-generating device 100 (e.g., the communication screen 140, the consumer interface panel 143 and/or the I/O interfaces 1130). For example, the aerosol-generating device 100 may output the notifications as push notifications to the companion application and/or operator interface. According to at least some example embodiments, outputting a notification via the companion application may include generating a wireless signal (e.g., a Bluetooth signal) containing the notification, transmitting the generated wireless signal to the UE 1510 (e.g., via the Bluetooth device 1218), and thereby causing the companion application to display the notification on an operator interface (e.g., screen) of the UE 1510. According to at least some example embodiments, the aerosol-generating device 100 may also output the notifications via email (e.g., using the companion application and/or UE 1510), a registered phone number, a registered messaging service, a registered social media account, or the like.

According to at least some example embodiments, the aerosol-generating device may output other notifications via the companion application, the operator interface on the aerosol-generating device 100, email, etc. For example, the other notifications may include notifications in response to detection of an uncommon operation pattern, an uncommon operation location, operation of a non-genuine capsule, over operation, under operation (e.g., in cases in which the capsule includes a medicine), performance of age verification, availability of a voucher and/or coupon, etc. According to at least some example embodiments, the companion application may include the functionality for the authorized operator to configure the aerosol-generating device 100 to output custom notifications. For example, the aerosol-generating device 100 may output notifications in response to events selected by the authorized operator such as, for instance, atypical operation of the aerosol-generating device 100, uncommon operation location, restricted operation location, etc.

According to at least some example embodiments, the operations of FIG. 7 may be performed with respect to an unauthorized operator probability level reflecting that the current operator is not the authorized operator, in addition to or alternatively to the authorized operator probability. In such an implementation, a positive behavior metric value may reflect that the various data forming the basis for the given behavior metric value corresponds to a lower unauthorized operator probability level. Also, a negative behavior metric value may reflect that the various data forming the basis for the given behavior metric value corresponds to a higher unauthorized operator probability level. Such an unauthorized operator probability level may be determined in operation 1920, and used to control the aerosol-generating device 100 in operation 1930, similar to how the authorized operator probability is determined and used. For example, operations associated with a higher authorized operator probability in operations 1920 and 1930 may be associated with a lower behavior score, and operations associated with a lower authorized operator probability in operations 1920 and 1930 may be associated with a higher behavior score.

According to at least some example embodiments, the operations of FIG. 7 may be performed with respect to a behavior score. As may be understood, whether higher or lower (or positive or negative) behavior metric values are representative of a higher or lower behavior score may depend on an implementation polarity of the behavior score (e.g., whether a higher behavior score is associated with a higher or lower authorized operator probability). As discussed in connection with at least some example embodiments below, the polarity of such a behavior score may be implemented as inverse with respect to the authorized operator probability. For example, as the authorized operator probability increases the behavior score decreases (e.g., proportionally), and as the authorized operator probability decreases the behavior score increases (e.g., proportionally). Such a behavior score may be determined in operation 1920, and used to control the aerosol-generating device 100 in operation 1930, similar to how the authorized operator probability is determined and used (albeit with inverted polarity). For example, operations associated with a higher authorized operator probability in operations 1920 and 1930 may be associated with a lower behavior score, and operations associated with a lower authorized operator probability in operations 1920 and 1930 may be associated with a higher behavior score.

Referring to FIG. 13, a diagram is provided illustrating a process for controlling the operation of an aerosol-generating device 100 using a plurality of thresholds according to at least some example embodiments. As shown in FIG. 13, in operation 1805, an operator may purchase the aerosol-generating device 100. According to at least some example embodiments, the probability that the current operator of the aerosol-generating device is an authorized operator (e.g., the unauthorized operator probability level) may be set to a lowest level (e.g., highest unauthorized operator probability level) upon purchase of the aerosol-generating device 100, but is not limited thereto. In operation 1810, an age verification process may be performed with respect to the operator.

According to at least some example embodiments, an initial age verification process may be performed upon purchase of the aerosol-generating device 100. For example, in operation 1805 the operator may purchase the aerosol-generating device 100 from a store (e.g., a brick-and-mortar store, a vending solution such as a manned kiosk or automated vending machine, etc.) and/or online (e.g., from a webpage, a web-based application, etc.). As discussed above, the aerosol-generating device 100 may determine a probability (e.g., behavior score) that a current operator of the aerosol-generating device is an authorized operator, and may update (e.g., increase or decrease) the probability based on a plurality behavior metrics.

Subsequent to the purchase of the aerosol-generating device 100, the operator may perform an initial age verification process. According to at least some example embodiments, in operation 1810, the operator may perform the initial age-verification process at the store (e.g., the brick-and-mortar store). In such cases, the age verification process may be performed by a clerk at a point-of-sale (POS), and/or automatically by processing circuitry of the POS device. A result of the age verification process (e.g., an indication that the operator has been successfully age-verified or an indication that the attempted age-verification of the operator has failed) may be transferred to the aerosol-generating device 100 from the POS device (e.g., POS device 1540) via wireless communication (e.g., using the RF device 1214, the Bluetooth device 1218, etc.), for example, short-range RF communication (e.g., Bluetooth, NFC, etc.).

According to at least some example embodiments, the operator may perform the initial age verification process online (e.g., from a webpage using a web browser, a web-based application, etc.). As another example, the operator may perform the age-verification process using the companion application installed and executed on the UE 1510, etc. In this approach, the result of the age verification process (e.g., an indication that the operator has been successfully age-verified or an indication that the attempted age-verification of the operator has failed) may be transferred to the aerosol-generating device 100 from the POS device via wireless communication (e.g., using the RF device 1214, the Bluetooth device 1218, etc.), for example, short-range RF communication (e.g., Bluetooth, NFC, etc.).

In operation 1815, the aerosol-generating device 100 may determine the probability (e.g., the unauthorized operator probability level) based on a result of the age verification process and other behavior metrics. For example, in response to receiving an indication that the operator has been successfully age-verified, the aerosol-generating device 100 may increase the probability that the current operator of the aerosol-generating device is an authorized operator (e.g., decrease unauthorized operator probability level). According to at least some example embodiments, the aerosol-generating device 100 may increase the probability by a larger increment based on a successful age verification performed at the store in comparison to an increment by which the probability may be increased based on successful age verification performed online. This difference in probability increments may be implemented by applying different weightings to age verification performed at the store and online and may be set by the system operator, an age verification service, etc.

According to at least some example embodiments, a capsule purchase process may be performed. For example, a capsule (e.g., a capsule 200) may be selected (e.g., by an operator of the aerosol-generating device 100) for purchase. According to at least some example embodiments, the capsule purchase process may be performed with respect to capsule purchases in a store (e.g., a brick-and-mortar store, a vending solution such as a manned kiosk or automated vending machine, etc.) or online (e.g., from a webpage, a web-based application, etc.). When purchasing the capsule in a store, the selection of the capsule may include manually retrieving the capsule from a shelf, requesting a clerk to retrieve the capsule from behind a purchase counter, etc. When purchasing the capsule online, the selection of the capsule may include indicating the capsule among products available for sale displayed on a graphical operator interface (e.g., an operator interface displayed on the companion application installed and executed on the UE 1510, an operator interface displayed on a web browser, an operator interface displayed on a shopping application of an online retailer, etc.).

The capsule selected may be purchased (e.g., by the operator of the aerosol-generating device 100). The selected capsule may be purchased in the store (e.g., using the POS 1540) or online (e.g., using the companion application, using a retailer website, using a shopping application of an online retailer, etc.). According to at least some example embodiments, operation 1810 may include performing an age verification process to verify the age of the current operator of the aerosol-generating device 100 when the selected capsule is purchased.

In cases in which the selected capsule is purchased at the store, the age verification process may be performed by a clerk at a POS, and/or automatically by processing circuitry of the POS device (e.g., POS device 1540). The result of the age verification process (e.g., an indication that the operator has been successfully age-verified or an indication that the attempted age-verification of the operator has failed) may be transferred from the POS device to a tag on the purchased capsule via wireless communication. For example, the POS device may include a wireless transmitter (e.g., a short-range RF transmitter) and the capsule may include a tag (e.g., an RF tag) capable of storing data. The tag may store such data on a register, a memory, etc. The POS device may also transfer store and/or clerk information to the tag via the wireless communication. For example, various certifying criteria may be provided for certifying stores (e.g., brick-and-mortar retailers) as trusted stores, and/or for certifying clerks (e.g., store employees) in such stores as trusted clerks. Also, various scoring criteria may be provided for associating a store score and/or a clerk score with the store and/or the clerk, respectively. The various certifying criteria and/or the various scoring criteria may reflect an ability and/or history of the store and/or the clerk to correctly age-verify the operator. The store and/or clerk information may include an indication of whether the store and/or clerk (e.g., the clerk that performed the age verification process) is a trusted store and/or a trusted clerk, and/or the store score and/or the clerk score. After completion of an age verification process at the store, the POS device may transfer store and/or clerk information along with the result of the age verification to the tag via the wireless communication for storage thereon.

In cases in which the selected capsule is purchased online, the age verification process may be performed using the companion application installed and executed on the UE 1510. The result of the age verification process (e.g., an indication that the operator has been successfully age-verified or an indication that the attempted age-verification of the operator has failed) may be stored in a memory of the UE 1510 (e.g., in connection with the companion application). Also, information regarding the purchased capsule (e.g., information identifying the capsule, etc.) may be stored in the memory of the UE 1510.

The result of the age verification process may be transferred to the aerosol-generating device 100. In cases in which the age verification process was performed at the store, result of the age verification process may be transferred to the aerosol-generating device 100 from the tag of the capsule using wireless communications (e.g., performing a read operation of the tag of the capsule using the RF device 1214). According to at least some example embodiments, the read operation of the tag of the capsule may be performed in response to insertion of the capsule into the aerosol-generating device 100 and/or in response to depression of the power button 142 while the capsule is inserted into the aerosol-generating device 100, detection of drawing of a vapor, etc. According to at least some example embodiments, in addition to the result of the age verification process, the store and/or clerk information (e.g., the indication of whether the store is a trusted store and/or the clerk is a trusted clerk) stored on the tag may be transferred to the aerosol-generating device 100 from the tag of the capsule using wireless communications during the read operation of the tag of the capsule.

In cases in which the selected capsule is purchased online, the result of the age verification process (e.g., an indication that the operator has been successfully age-verified or an indication that the attempted age-verification of the operator has failed) may be transferred to the aerosol-generating device 100 from the POS device via wireless communication (e.g., Bluetooth communication using the Bluetooth device 1218).

According to at least some example embodiments, in operation 1815 the aerosol-generating device 100 may update the probability that the current operator of the aerosol-generating device is an authorized operator (e.g., the unauthorized operator probability level) based on the obtained result of the age verification process. For example, the aerosol-generating device 100 may increase the probability (e.g., decrease the unauthorized operator probability level) in response to receiving an indication that the operator has been successfully age-verified. Also, the aerosol-generating device 100 may decrease the probability (e.g., increase the unauthorized operator probability level) in response to receiving an indication that the attempted age-verification of the operator has failed. An amount of the increase in the probability in response to a successful age verification may vary according to whether the age verification is performed at the store or online, with the amount of increase being greater when the age verification is performed at the store and less when the age verification is performed online.

The aerosol-generating device 100 may also update the probability that the current operator of the aerosol-generating device is an authorized operator (e.g., the unauthorized operator probability level) based on the store and/or clerk information in operation 1815. For example, the aerosol-generating device 100 may increase the probability (e.g., decrease the unauthorized operator probability level) in response to receiving an indication that the capsule was purchased from a trusted store and/or a trusted clerk, and/or from a store and/or clerk having a higher score (e.g., a score beyond a corresponding threshold value). Also, the aerosol-generating device 100 may decrease the probability (e.g., increase the unauthorized operator probability level) in response to receiving an indication that the capsule was purchased from and untrusted or unknown store and/or clerk, and/or from a store and/or clerk having a lower score (e.g., a score not beyond the corresponding threshold value).

According to at least some example embodiments, the tag of the capsule may store information representing a “chain of custody” of the capsule. The chain of custody may include purchase information (e.g., whether occurring at the store or online, date of purchase, time of purchase, capsule information, store information, clerk information, etc.), along with information identifying a transporter, a distributor, a manufacturer, etc. According to at least some example embodiments, the chain of custody may further include information regarding a producer of the aerosol-forming substrate included in the capsule, a producer of one or more subcomponents of the capsule, etc. Such chain of custody information may be scanned/stored to the tag at varying points before arrival at a retailer. In operation 1815, the aerosol-generating device 100 may increase the probability (e.g., decrease the unauthorized operator probability level) in response to successfully verifying the chain of custody of the capsule. For example, a chain of custody having missing or false portions may be used to determine that the capsule is a non-genuine capsule and/or an altered capsule, resulting in a decrease in the probability (e.g., increase in the unauthorized operator probability level) in operation 1815 as discussed further below. The chain of custody may be associated with an identifier of a capsule, a container of a plurality of capsules, etc., stored in a database (e.g., on an external server, blockchain, etc.). When a capsule is inserted into the aerosol-generating device 100, that capsule, along with other capsules in the container, may be associated with the aerosol-generating device 100 (e.g., in the companion application, blockchain, etc.).

In operation 1820, the aerosol-generating device 100 may monitor for newly collected behavior information corresponding to the behavior metrics. In operation 1830, the aerosol-generating device 100 may update the probability (e.g., update the behavior score) and/or one or more authorization threshold values (or one or more behavior threshold values). For example, the aerosol-generating device 100 may update at least one behavior metric based on the newly collected behavior information, and increase or decrease the probability (e.g., decrease or increase the unauthorized operator probability level) according to the updated behavior metric(s). According to at least some example embodiments, the aerosol-generating device 100 may also update the one or more authorization threshold values (or the one or more behavior threshold values). For example, the aerosol-generating device 100 may increase the one or more authorization threshold values (or decrease the one or more behavior threshold values) in response to detecting repeated instances of high-behavior operation of the aerosol-generating device, an instance of operation of the aerosol-generating device in a restricted area, etc. Also, the aerosol-generating device 100 may decrease the one or more authorization threshold values (or increase the one or more behavior threshold values) in response to, for example, detecting that the aerosol-generating device 100 has determined a low probability (e.g., a high behavior score) for an extended time period, or that the aerosol-generating device 100 has determined a high probability (e.g., a low behavior score) for an extended time period, etc.

According to at least some example embodiments, the aerosol-generating device 100 may utilize a plurality of authorization threshold values (or behavior threshold values). Each of the authorization threshold values (or behavior threshold values) may reflect a different level of probability (e.g., high, intermediate, low, etc., probability level) that the current operator is an unauthorized operator, and the aerosol-generating device 100 may control aerosol-generation functionality according to the results of a comparison between the probability (or unauthorized operator probability level) and the authorization threshold values (or behavior threshold values). For example, in operation 1835, the aerosol-generating device 100 may compare the updated probability to a first authorization threshold value. If the probability is less than or equal to the first authorization threshold value (“No” in operation 1835), the process performed by the aerosol-generating device may return to operation 1820.

If the probability is greater than the first authorization threshold value (“Yes” in operation 1835), the aerosol-generating device 100 may compare the probability to a second authorization threshold value in operation 1840. If the probability is less than or equal to the second authorization threshold value (“No” in operation 1840), the aerosol-generating device 100 (e.g., the controller 1105 of the aerosol-generating device 100) may reduce a performance level of the aerosol-generating device 100 in operation 1845. The reduction in performance level may include limiting a time duration for which the aerosol-generating device 100 is allowed and/or enabled to generate aerosol from a capsule, limiting a number of puffs in an aerosol generation session (e.g., a number of puffs within a given time period), only permitting aerosol generation in certain (e.g., known to be safe) location (e.g., aerosol generation limited to usage in the home of the current operator as determined according to wireless fingerprint discussed above), limiting usage of the aerosol-generation device 100 to certain types of capsules (e.g., plain, basic or longer-marketed flavors), etc., but at least some example embodiments are not limited thereto. According to at least some example embodiments, the reduction in performance may include any limitations to aerosol generation that may motivate the operator to perform an age verification. After performing operation 1845, the process performed by the aerosol-generating device may return to operation 1820. If the probability is greater than the second authorization threshold (“Yes” in operation 1840), the aerosol-generating device 100 may disable the aerosol-generation functionality of the aerosol-generating device 100 in operation 1850. The second authorization threshold value may be greater than the first authorization threshold value. After performing operation 1850, in operation 1855 the aerosol-generating device 100 may determine whether the operator of the aerosol-generating device 100 has successfully completed another age verification process during a time period following the disabling of the aerosol-generation functionality. For example, this other age verification process performed may be similar to one of the age verification processes discussed in connection with operation 1810.

If the aerosol-generating device 100 determines that the operator has successfully completed another age verification process during the time period after the aerosol-generation functionality has been disabled, the aerosol-generating device 100 may re-enable the aerosol-generation functionality in operation 1860. Otherwise, if the aerosol-generating device 100 determines that the operator has not successfully completed another age verification process during the time period after the aerosol-generation functionality has been disabled, the aerosol-generating device 100 may repeat operation 1855 while the aerosol-generation functionality remains disabled. After performing operation 1860, the process performed by the aerosol-generating device may return to operation 1820.

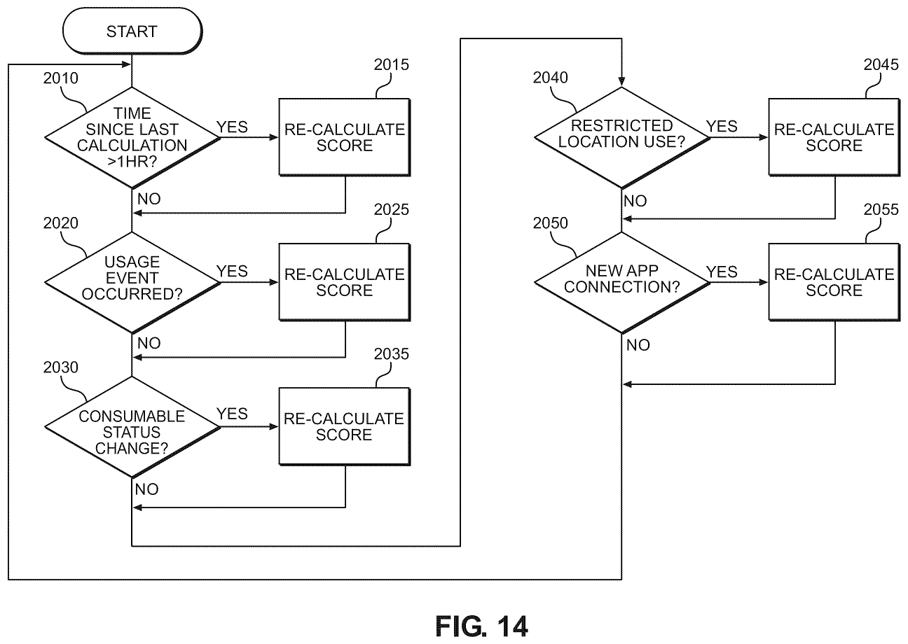

Referring to FIG. 14, a flowchart is provided illustrating example triggers for performing operations 1910, 1920 and/or 1930, according to at least some example embodiments. In operation 2010, the aerosol-generating device 100 may determine whether a period of time since operation 1920 was most recently performed exceeds a threshold (e.g., 1 hour). In response to determining the period of time exceeds the threshold (‘Yes’ in operation 2010), the aerosol-generating device 100 may re-perform operations 1910, 1920 and/or 1930 in operation 2015. After completing operation 2015, the aerosol-generating device 100 may advance to operation 2020 (e.g., possibly after a measured period of delay). In response to determining the period of time does not exceed the threshold (‘No’ in operation 2010), the aerosol-generating device 100 may advance to operation 2020.

In operation 2020, the aerosol-generating device 100 may determine whether an operation event (e.g., of a capsule) has occurred. In response to determining the operation event has occurred (‘Yes’ in operation 2020), the aerosol-generating device 100 may re-perform operations 1910, 1920 and/or 1930 in operation 2025. After completing operation 2025, the aerosol-generating device 100 may advance to operation 2030 (e.g., possibly after a measured period of delay). In response to determining the determining the operation event has not occurred (‘No’ in operation 2020), the aerosol-generating device 100 may advance to operation 2030.

In operation 2030, the aerosol-generating device 100 may determine whether a capsule status has changed (e.g., whether a new capsule has been inserted into the aerosol-generating device). In response to determining the capsule status has changed (‘Yes’ in operation 2030), the aerosol-generating device 100 may re-perform operations 1910, 1920 and/or 1930 in operation 2035. After completing operation 2035, the aerosol-generating device 100 may advance to operation 2040 (e.g., possibly after a measured period of delay). In response to determining the capsule status has not changed (‘No’ in operation 2030), the aerosol-generating device 100 may advance to operation 2040.

In operation 2040, the aerosol-generating device 100 may determine whether the aerosol-generating device 100 has been operated in a restricted area. In response to determining the aerosol-generating device 100 has been operated in a restricted area (‘Yes’ in operation 2040), the aerosol-generating device 100 may re-perform operations 1910, 1920 and/or 1930 in operation 2045. After completing operation 2045, the aerosol-generating device 100 may advance to operation 2050 (e.g., possibly after a measured period of delay). In response to determining the aerosol-generating device 100 has not been used in a restricted area (‘No’ in operation 2040), the aerosol-generating device 100 may advance to operation 2050.

In operation 2050, the aerosol-generating device 100 may determine whether the aerosol-generating device 100 has newly connected to the companion application. In response to determining the aerosol-generating device 100 has newly connected to the companion application (‘Yes’ in operation 2050), the aerosol-generating device 100 may re-perform operations 1910, 1920 and/or 1930 in operation 2055. After completing operation 2055, the aerosol-generating device 100 may return to operation 2010 (e.g., possibly after a measured period of delay). Accordingly, the operations of FIG. 14 may be repeated, periodically or continuously, for triggering re-calculation of the behavior score (e.g., a score inverse to the authorized operator probability). In response to determining the aerosol-generating device 100 has not newly connected to the companion application (‘No’ in operation 2050), the aerosol-generating device 100 may return to operation 2010.

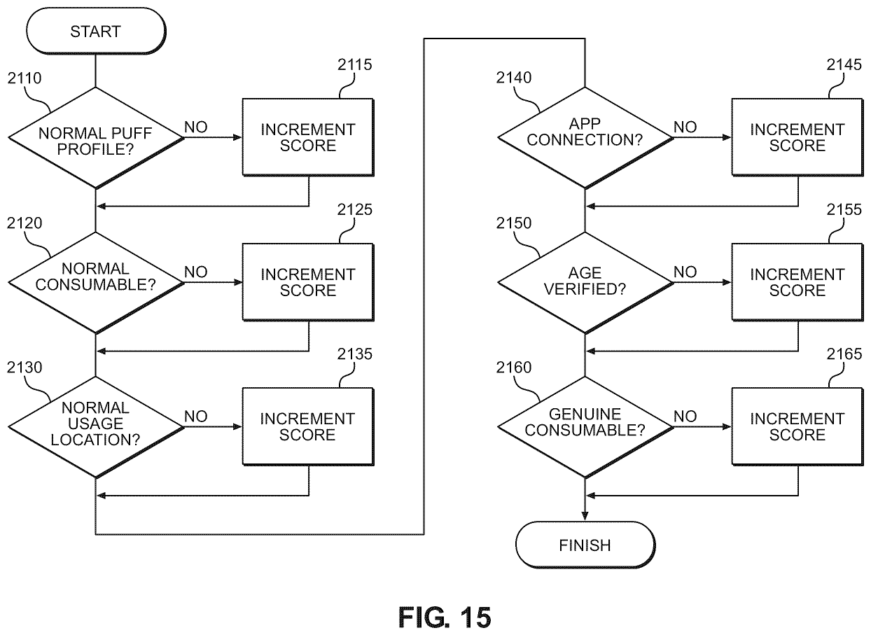

Referring to FIG. 15, a flowchart is provided illustrating an example process for iteratively adjusting a behavior score (e.g., a score inverse to the authorized operator probability) according to various behavior metrics as discussed further in connection with operations 1910 and 1920, according to at least some example embodiments. In operation 2110, the aerosol-generating device 100 may determine whether a normal puff profile is detected (e.g., based on and/or in comparison to the puff profile model corresponding to an authorized operator). In response to determining a normal puff profile is not detected (‘No’ in operation 2110), the aerosol-generating device 100 may increment the behavior score, for example, by re-performing operation 1920, in operation 2115. After completing operation 2115, the aerosol-generating device 100 may advance to operation 2120 (e.g., possibly after a measured period of delay). In response to determining a normal puff profile is detected (‘Yes’ in operation 2110), the aerosol-generating device 100 may advance to operation 2120.

In operation 2120, the aerosol-generating device 100 may determine whether a normal capsule is detected (e.g., using the operating pattern model corresponding to an authorized operator, also referred to herein as the authorized operating pattern model). In response to determining a normal capsule is not detected (‘No’ in operation 2120), the aerosol-generating device 100 may increment the behavior score, for example, by re-performing operation 1920, in operation 2125. After completing operation 2125, the aerosol-generating device 100 may advance to operation 2130 (e.g., possibly after a measured period of delay). In response to determining a normal capsule is detected (‘Yes’ in operation 2120), the aerosol-generating device 100 may advance to operation 2130.

In operation 2130, the aerosol-generating device 100 may determine whether a normal operation location is detected (e.g., using the location information corresponding to an authorized operator). In response to determining a normal operation location is not detected (‘No’ in operation 2130), the aerosol-generating device 100 may increment the behavior score, for example, by re-performing operation 1920, in operation 2135. After completing operation 2135, the aerosol-generating device 100 may advance to operation 2140 (e.g., possibly after a measured period of delay). In response to determining a normal capsule is detected (‘Yes’ in operation 2130), the aerosol-generating device 100 may advance to operation 2140.

In operation 2140, the aerosol-generating device 100 may determine whether a connection with the companion application is detected. In response to determining a connection with the companion application is not detected (‘No’ in operation 2140), the aerosol-generating device 100 may increment the behavior score, for example, by re-performing operation 1920, in operation 2145. After completing operation 2145, the aerosol-generating device 100 may advance to operation 2150 (e.g., possibly after a measured period of delay). In response to determining a connection with the companion application is detected (‘Yes’ in operation 2140), the aerosol-generating device 100 may advance to operation 2150.

In operation 2150, the aerosol-generating device 100 may determine whether an age verification process of a current operator has been successfully performed. In response to determining an age verification process has not been successfully performed (‘No’ in operation 2150), the aerosol-generating device 100 may increment the behavior score, for example, by re-performing operation 1920, in operation 2155. After completing operation 2155, the aerosol-generating device 100 may advance to operation 2160 (e.g., possibly after a measured period of delay). In response to determining an age verification process has been successfully performed (‘Yes’ in operation 2150), the aerosol-generating device 100 may advance to operation 2160.

In operation 2160, the aerosol-generating device 100 may determine whether a genuine capsule has been detected. In response to determining a genuine capsule has not been detected (‘No’ in operation 2160), the aerosol-generating device 100 may increment the behavior score, for example, by re-performing operation 1920, in operation 2165. After completing operation 2165, or in response to determining a genuine capsule has been detected (‘Yes’ in operation 2160), the process of FIG. 15 may end. As illustrated in FIG. 15, operations 1910 and 1920 may be performed on an iterative basis with respect to each of a plurality of different behavior metrics.

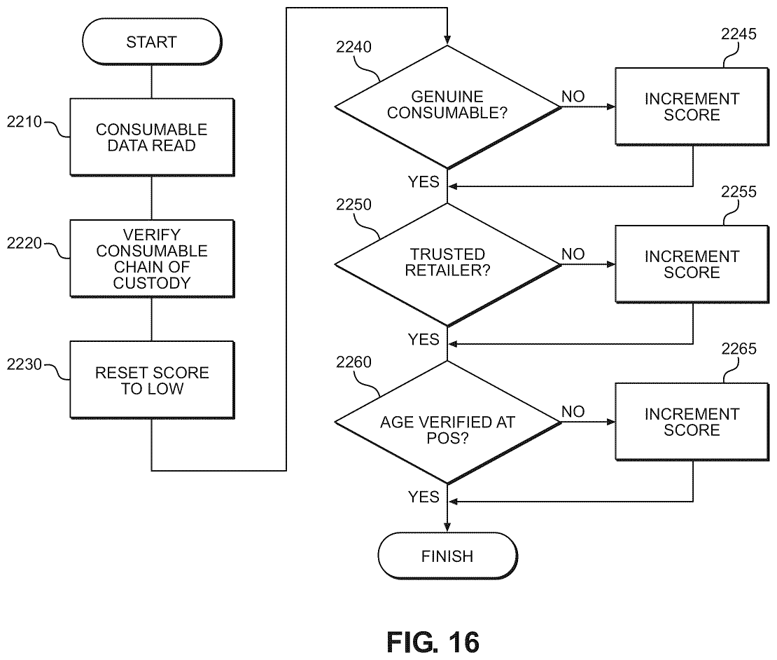

Referring to FIG. 16, a flowchart is provided illustrating an example process for iteratively adjusting a behavior score (e.g., a score inverse to the authorized operator probability) according to various behavior metrics in response to detection of a new capsule, according to at least some example embodiments. In operation 2210, the aerosol-generating device 100 may read data from a tag on a capsule (e.g., a new capsule inserted into the aerosol-generating device 100). In operation 2220, the aerosol-generating device 100 may verify a chain of custody read from the capsule tag. For example, the aerosol-generating device 100 may verify that the chain of custody does not contain missing or false parts. In operation 2230, the aerosol-generating device 100 may reset the behavior score to a lowest value.

In operation 2240, the aerosol-generating device 100 may determine whether the capsule is a genuine capsule. In response to determining the capsule is not a genuine capsule (‘No’ in operation 2240), the aerosol-generating device 100 may increment the behavior score, for example, by re-performing operation 1920, in operation 2245. After completing operation 2245, the aerosol-generating device 100 may advance to operation 2250 (e.g., possibly after a measured period of delay). In response to determining the capsule is a genuine capsule (‘Yes’ in operation 2240), the aerosol-generating device 100 may advance to operation 2250.

In operation 2250, the aerosol-generating device 100 may determine whether the capsule was purchased from a trusted retailer. In response to determining the capsule was not purchased from a trusted retailer (‘No’ in operation 2250), the aerosol-generating device 100 may increment the behavior score, for example, by re-performing operation 1920, in operation 2255. After completing operation 2255, the aerosol-generating device 100 may advance to operation 2260 (e.g., possibly after a measured period of delay). In response to determining the capsule was purchased from a trusted retailer (‘Yes’ in operation 2250), the aerosol-generating device 100 may advance to operation 2260.

In operation 2260, the aerosol-generating device 100 may determine whether the operator was age verified at the point-of-sale when the capsule was purchased (e.g., according to any of the methods discussed in connection with FIG. 4 above). In response to determining the operator was not age verified (‘No’ in operation 2260), the aerosol-generating device 100 may increment the behavior score, for example, by re-performing operation 1920, in operation 2265. After completing operation 2265, or in response to determining the operator was age verified (‘Yes’ in operation 2260), the process of FIG. 16 may end. As illustrated in FIG. 16, operations 1910 and 1920 may be performed on an iterative basis with respect to each of a plurality of different behavior metrics upon, for example, detecting a new capsule.

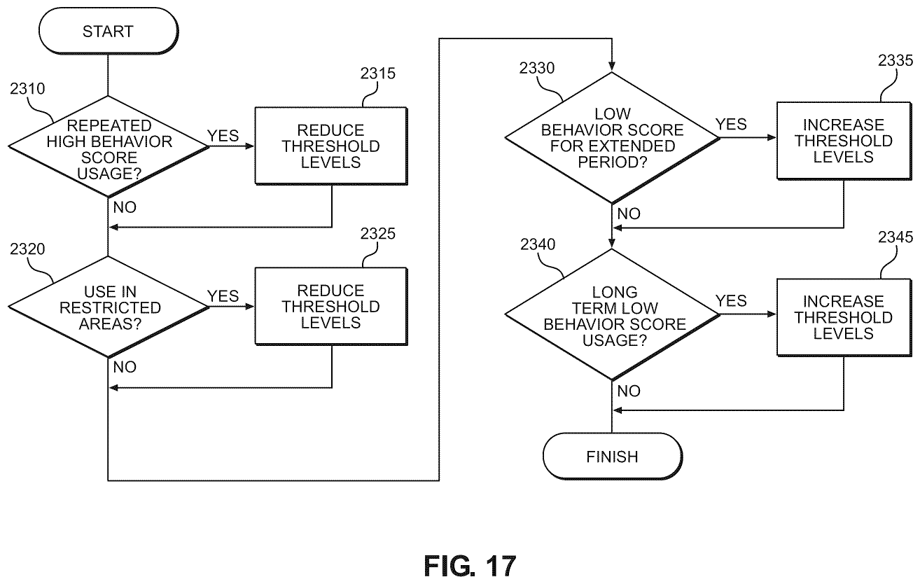

Referring to FIG. 17, a flowchart is provided illustrating an example process for adjusting one or more behavior thresholds (as discussed further in connection with operation 1920), according to at least some example embodiments. In operation 2310, the aerosol-generating device 100 may determine whether the aerosol-generating device 100 has been repeatedly operated while the behavior score is higher. In response to determining the aerosol-generating device 100 has been repeatedly operated while the behavior score is higher (‘Yes’ in operation 2310), the aerosol-generating device 100 may reduce the level(s) of the one or more behavior thresholds in operation 2315. After completing operation 2315, the aerosol-generating device 100 may advance to operation 2320 (e.g., possibly after a measured period of delay). In response to determining the aerosol-generating device 100 has not been repeatedly operated while the behavior score is higher (‘No’ in operation 2310), the aerosol-generating device 100 may advance to operation 2320.

In operation 2320, the aerosol-generating device 100 may determine whether the aerosol-generating device 100 has been operated in a restricted area. In response to determining the aerosol-generating device 100 has been operated in a restricted area (‘Yes’ in operation 2320), the aerosol-generating device 100 may reduce the level(s) of the one or more behavior thresholds in operation 2325. After completing operation 2325, the aerosol-generating device 100 may advance to operation 2330 (e.g., possibly after a measured period of delay). In response to determining the aerosol-generating device 100 has not been operated in a restricted area (‘No’ in operation 2320), the aerosol-generating device 100 may advance to operation 2330.

In operation 2330, the aerosol-generating device 100 may determine whether the behavior score has been lower for an extended time period. In response to determining the has been lower for an extended period of time (‘Yes’ in operation 2330), the aerosol-generating device 100 may increase the level(s) of the one or more behavior thresholds in operation 2335. After completing operation 2335, the aerosol-generating device 100 may advance to operation 2340 (e.g., possibly after a measured period of delay). In response to determining the behavior score has not been lower for an extended time period (‘No’ in operation 2330), the aerosol-generating device 100 may advance to operation 2340.

In operation 2340, the aerosol-generating device 100 may determine whether the aerosol-generating device 100 has been operated, while the behavior score has been lower, for an extended period of time (e.g., high-probability operation). In response to determining such high-probability operation (‘Yes’ in operation 2340), the aerosol-generating device 100 may increase the level(s) of the one or more behavior thresholds in operation 2345. After completing operation 2345, or in response to determining a lack of high-probability operation (‘No’ in operation 2340), the process of FIG. 17 may end.

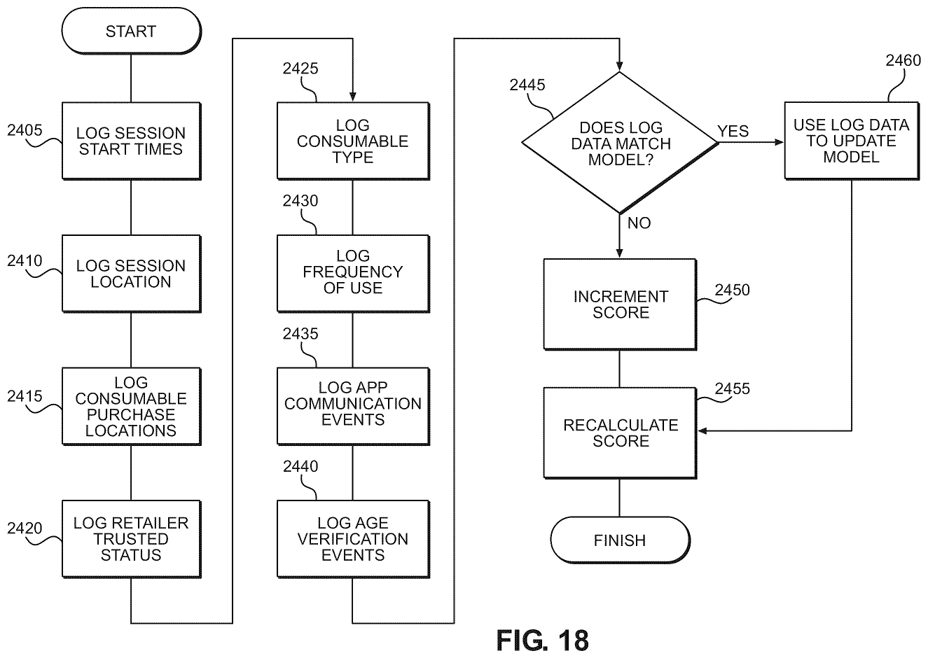

Referring to FIG. 18, a flowchart is provided illustrating an example process for determining the operation pattern metric based on the operating pattern model associated with an authorized operator (also referred to herein as the authorized operating pattern model), and performing operation 1920 based on the operation pattern metric, according to at least some example embodiments. Initially, for example, the process may include collecting an updated recent operating pattern of a current operator of the aerosol-generating device 100. For example, in operation 2405, the aerosol-generating device 100 may log session start times. In operation 2410, the aerosol-generating device 100 may log session location. In operation 2415, the aerosol-generating device 100 may log capsule purchase locations. In operation 2420, the aerosol-generating device 100 may log retailer trusted status. In operation 2425, the aerosol-generating device 100 may log capsule type. In operation 2430, the aerosol-generating device 100 may log a frequency of use of the aerosol-generating device 100. In operation 2435, the aerosol-generating device 100 may log companion application communication events. In operation 2440, the aerosol-generating device 100 may log age verification events. According to at least some examples embodiments, the updated recent operating pattern may include the data logged in operations 2405-2440.

In operation 2445, the aerosol-generating device 100 may determine whether the updated recent operating pattern of the current operator matches the operating pattern model of an authorized operator by, for example, using the trained machine learning process to generate a recent operating pattern model based on the updated recent operating pattern, and determining whether the recent operating pattern model matches the authorized operating pattern model. In response to determining the recent operating pattern model matches the authorized operating pattern model (‘Yes’ in operation 2445), in operation 2460 the aerosol-generating device 100 may use the updated recent operating pattern as an updated historical operating pattern and use the same for further training the machine learning process consistent with the training discussed above. After completion of operation 2460, the aerosol-generating device 100 may recalculate the behavior score in operation 2455 (e.g., re-perform operation 1920 by, for example, decreasing the behavior score consistent with the determination of the matching operating pattern).

In response to determining the recent operating pattern model does not match the authorized operating pattern model (‘No’ in operation 2445), in operation 2450 the aerosol-generating device 100 may increment the behavior score (e.g., by a fixed or alternatively, given amount), and in operation 2455 the aerosol-generating device 100 may recalculate the behavior score (e.g., re-perform operation 1920). According to at least some example embodiments, operations 2450 and 2455 may be combined into a single operation in cases in which the recent operating pattern model does not match the authorized operating pattern model. After operation 2455 is completed, the process illustrated in connection with FIG. 18 may end.

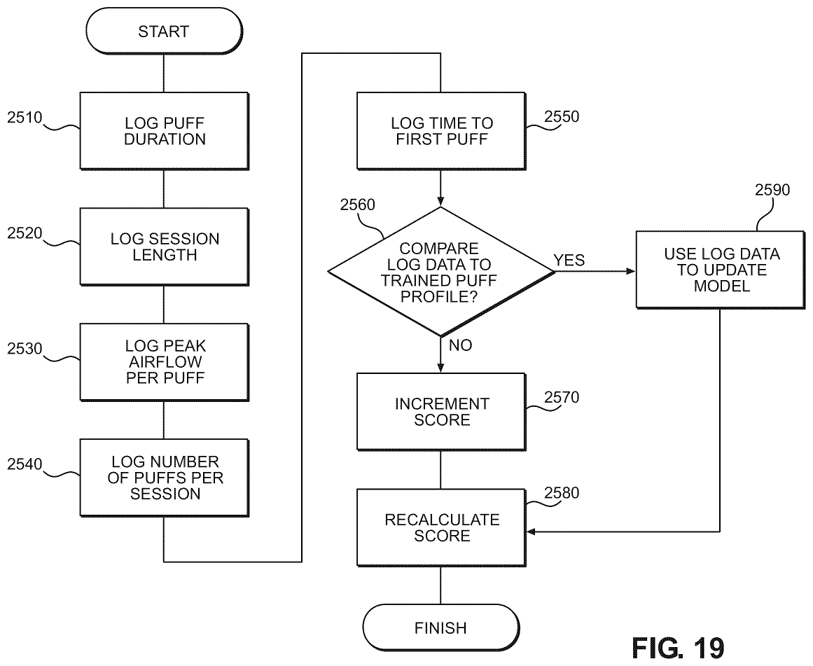

Referring to FIG. 19, a flowchart is provided illustrating an example process for determining the operation pattern metric based on the puff profile model associated with an authorized operator (also referred to herein as the authorized puff profile model), and performing operation 1920 based on the operation pattern metric, according to at least some example embodiments. Initially, for example, the process may include collecting an updated recent puff profile of a current operator. For example, in operation 2510, the aerosol-generating device 100 may log a puff duration. In operation 2520, the aerosol-generating device 100 may log a session length. In operation 2530, the aerosol-generating device 100 may log a peak airflow per puff. In operation 2540, the aerosol-generating device 100 may log a number of puffs per session. In operation 2550, the aerosol-generating device 100 may log a time to first puff. According to at least some examples embodiments, the updated recent puff profile may include the data logged in operations 2510-2550.

In operation 2560, the aerosol-generating device 100 may determine whether the updated recent puff profile associated with the current operator matches the puff profile model associated with an authorized operator by, for example, using the trained machine learning process to generate a recent puff profile model based on the updated recent puff profile, and determining whether the recent puff profile model matches the authorized puff pattern model. In response to determining the recent operating pattern model matches the authorized operating pattern model (‘Yes’ in operation 2560), in operation 2590 the aerosol-generating device 100 may use the updated recent puff profile as an updated historical puff information and use the same for further training the machine learning process consistent with the training discussed above. After completion of operation 2590, the aerosol-generating device 100 may recalculate the behavior score in operation 2580 (e.g., re-perform operation 1920 by, for example, decreasing the behavior score consistent with the determination of the matching puff profile).

In response to determining the recent puff profile model does not match the authorized puff profile model (‘No’ in operation 2560), in operation 2570 the aerosol-generating device 100 may increment the behavior score (e.g., by a fixed or alternatively, given amount), and in operation 2580 the aerosol-generating device 100 may recalculate the behavior score (e.g., re-perform operation 1920). According to at least some example embodiments, operations 2570 and 2580 may be combined into a single operation in cases in which the recent puff profile model does not match the authorized puff profile model. After operation 2580 is completed, the process illustrated in connection with FIG. 19 may end.

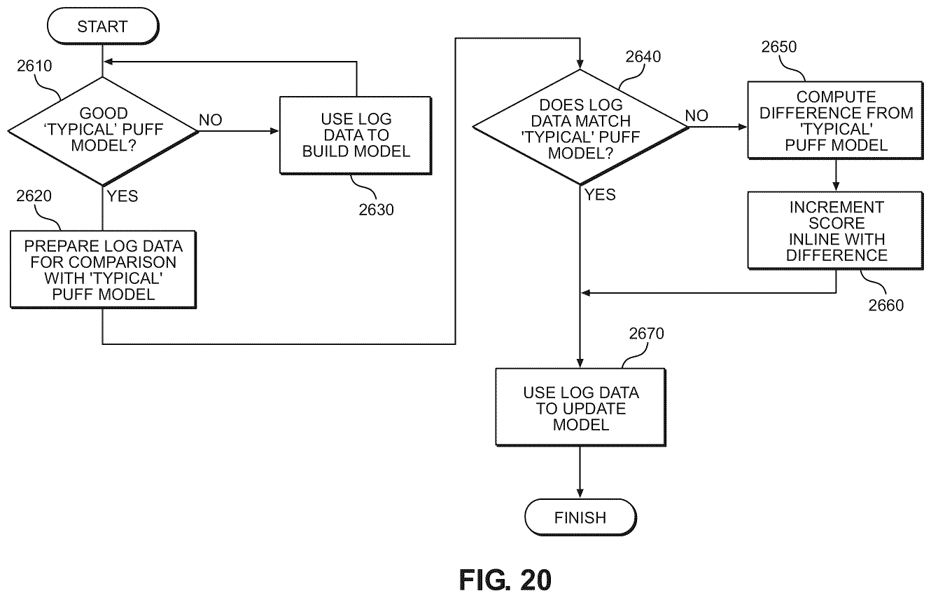

Referring to FIG. 20, a flowchart is provided illustrating an example process for generating the puff profile model associated with an authorized operator (also referred to herein as the authorized puff profile model), and performing operations 1910 and 1920 based on the authorized puff profile model, according to at least some example embodiments. Although the operations of FIG. 20 are discussed in connection with the puff profile model, similar operations may be performed for generating the authorized operating pattern model, and performing operations 1910 and 1920 based on the authorized operating pattern model.

In operation 2610, the aerosol-generating device 100 may determine whether the machine learning process used to generate the puff profile model associated with the authorized operator has been trained (e.g., to a sufficient level of accuracy). In response to determining the machine learning process has not been trained (e.g., due to the aerosol-generating device 100 having been newly purchases), the aerosol-generating device 100 may use recently logged data (e.g., the data logged in operations 2510-2550 used as historical puff information) to train the machine learning process to generate a puff profile model in association with the authorized operator in operation 2630. After operation 2630 has been completed, the process may return to operation 2610.

In response to determining the machine learning process used to generate the puff profile model associated with the authorized operator has been trained (‘Yes’ in operation 2610), the aerosol-generating device 100 may collect recently logged data (e.g., an updated recent puff profile including the data logged in operations 2510-2550) in operation 2620. In operation 2640, the aerosol-generating device 100 may determine whether a recent puff profile model generated by the trained machine learning process based on the updated recent puff profile of a current operator matches the puff profile model of the authorized operator. In response to determining the recent puff profile model matches the authorized puff profile model (‘Yes’ in operation 2640), in operation 2670 the aerosol-generating device 100 may use the updated recent puff profile as updated historical puff information and use the same for further training the machine learning process consistent with the training discussed above. After completion of operation 2670, the process illustrated in connection with FIG. 20 may end.

In response to determining the recent puff profile model of the current operator does not match the authorized puff profile model (‘No’ in operation 2640), in operation 2650 the aerosol-generating device 100 may compute a difference between the recent puff profile model and the authorized recent puff profile. In operation 2660, the aerosol-generating device 100 may increment the behavior score in line with the difference value computed in operation 2650. For example, the aerosol-generating device 100 may determine the operation pattern metric value to a higher behavior score in proportion to the difference value, and perform operation 1920 to update the behavior score based on the operation pattern metric value. After operation 2660 is completed, the process illustrated in connection with FIG. 20 may end.

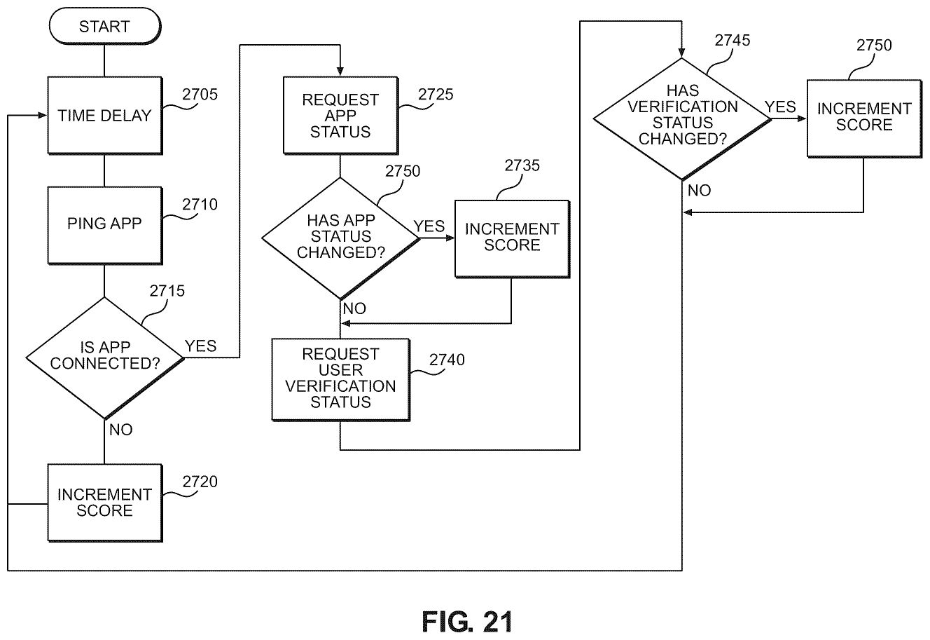

Referring to FIG. 21, a flowchart is provided illustrating an example process for determining the companion application connection metric, and performing operation 1920 based on the companion application connection metric, according to at least some example embodiments. In operation 2705, the aerosol-generating device 100 may measure (e.g., count, wait, etc.) a time delay (e.g., a fixed or alternatively, given time period). For example, the time delay may be measured from a most recent connection by the aerosol-generating device 100 with the companion application, a most recent adjustment of the behavior score, etc. In operation 2710, the aerosol-generating device 100, may ping the companion application (e.g., by transmitting a corresponding Bluetooth signal to the UE 1510). In operation 2715, the aerosol-generating device 100 may determine whether the companion application is connected to the aerosol-generating device 100 (e.g., based on whether an acknowledgement message was received in response to the ping). In response to determining that the companion application is not connected to the aerosol-generating device 100 (‘No’ in operation 2715), the aerosol-generating device may increment the behavior score (e.g., re-perform operation 1920) in operation 2720. After completion of operation 2720, the process may return to operation 2705.

In response to determining that the companion application is connected to the aerosol-generating device 100 (‘Yes’ in operation 2715), the aerosol-generating device 100 may request the companion application for a companion application status in operation 2725. In operation 2730, the aerosol-generating device 100 may determine whether the companion application status has changed. For example, the aerosol-generating device 100 may determine whether the companion application status has changed from reliable to unreliable. In response to determining that the companion application status has changed (‘Yes’ in operation 2730), the aerosol-generating device may increment the behavior score (e.g., re-perform operation 1920) in operation 2735. After completing operation 2735, or in response to determining that the companion application status has not changed (‘No’ in operation 2730), the process of FIG. 21 may advance to operation 2740.

In operation 2740, the aerosol-generating device may request the companion application for an operator verification status. For example, the operator verification status may refer to a status of an age verification process relating to the operator. In operation 2745, the aerosol-generating device 100 may determine whether the operator verification status has changed. For example, the aerosol-generating device 100 may determine whether a time period (e.g., a time period following a most recent successful age verification process, a time period since purchasing the aerosol-generating device 100, etc.) has expired without the operator having successfully performed an age verification process using the companion application, whether the operator has performed an unsuccessful age verification process, etc. In response to determining the operator verification status has changed (‘Yes’ in operation 2745), the aerosol-generating device 100 may increment the behavior score (e.g., re-perform operation 1920) in operation 2750. After completing operation 2750, or in response to determining that the operator verification status has not changed (‘No’ in operation 2745), the process of FIG. 21 may return to operation 2705.

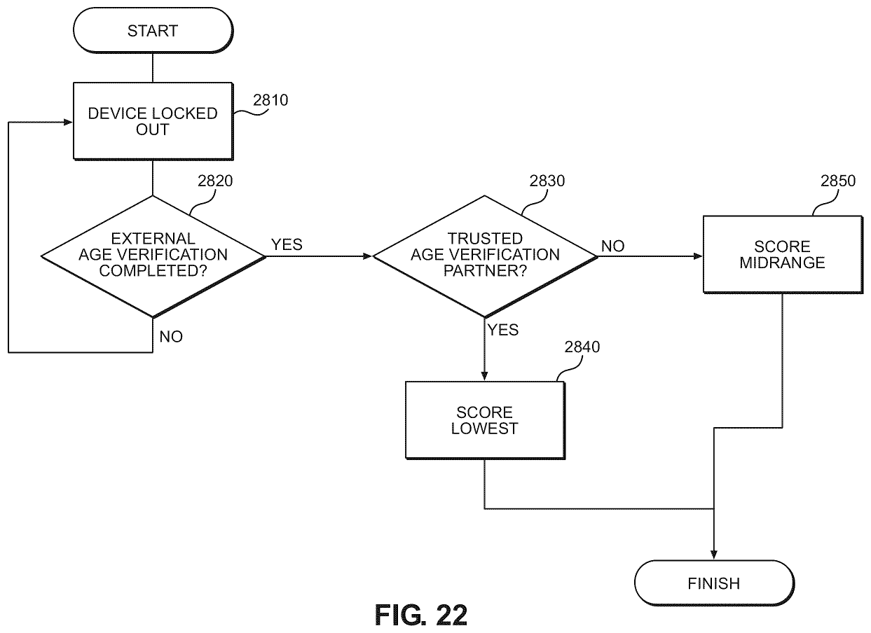

Referring to FIG. 22, a flowchart is provided illustrating an example process for restoring a disabled aerosol-generating device to operability, according to at least some example embodiments. In operation 2810, the aerosol-generating device 100 may disable the aerosol-generation functionality of the aerosol-generating device 100 (e.g., in response to determining the behavior score exceeds a behavior threshold). For example, the aerosol-generating device 100 may disable powering of the heater of the aerosol-generating device 100 while the aerosol-generation functionality remains in the disabled state. In operation 2820, the aerosol-generating device 100 may determine whether an (external) age verification process has been completed (e.g., at a store, online or using the companion application). In response to determining that the age verification process has been performed (‘Yes’ in operation 2820), the aerosol-generating device 100 may determine whether the age verification was performed by a trusted age verification partner (e.g., a trusted retailed and/or a trusted clerk) in operation 2830). In response to determining that the age verification process has not been performed (‘No’ in operation 2820), the process illustrated in FIG. 22 may return to operation 2810.

In response to determining that the age verification process has been performed (‘Yes’ in operation 2820), the aerosol-generating device 100 may determine whether the age verification was performed by a trusted age verification partner (e.g., a trusted retailed and/or a trusted clerk) in operation 2830. For example, the aerosol-generating device 100 may determine a trust score of the retailer and/or clerk that performed the age verification process. In response to determining that the age verification was performed by a trusted age verification partner (‘Yes’ in operation 2830), the aerosol-generating device 100 may return to normal operation (e.g., restore the aerosol-generation functionality of the aerosol-generating device 100), and set the behavior score to a lowest value, in operation 2840. In response to determining that the age verification was not performed by a trusted age verification partner (‘No’ in operation 2830), the aerosol-generating device 100 may return to normal operation (e.g., restore the aerosol-generation functionality of the aerosol-generating device 100), and set the behavior score to a midrange value, in operation 2850. Accordingly, upon the restoration of normal operation in response to a successful age verification process, the behavior score may vary depending on whether the retailer and/or clerk that performed the age verification process is/are considered trusted. After operation 2840 or 2850 is completed, the process illustrated in connection with FIG. 22 may end.

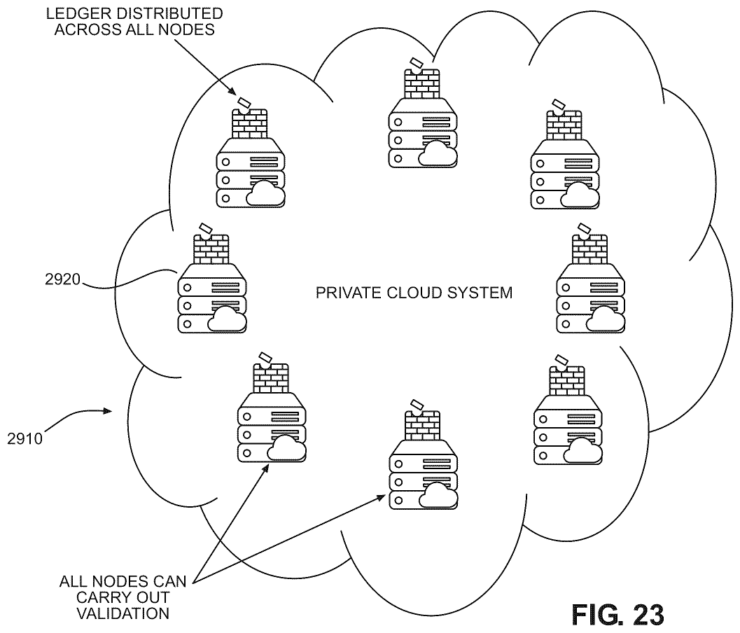

Referring to FIGS. 23-26, diagrams are illustrated representing an example blockchain implementation for use in connection with an aerosol-generating device. Referring to FIG. 23, for example, a diagram of a cloud system for use in implementing a blockchain is provided, according to at least some example embodiments. The blockchain may be based on a centralized ledger that is distributed over a cloud system (e.g., a privately owned cloud system, but not limited thereto) 2910. The cloud system 2910 (e.g., a cloud network) may include a plurality of nodes 2920, each node 2920 among the plurality of nodes may be capable of performing validation with respect to blocks of the blockchain.

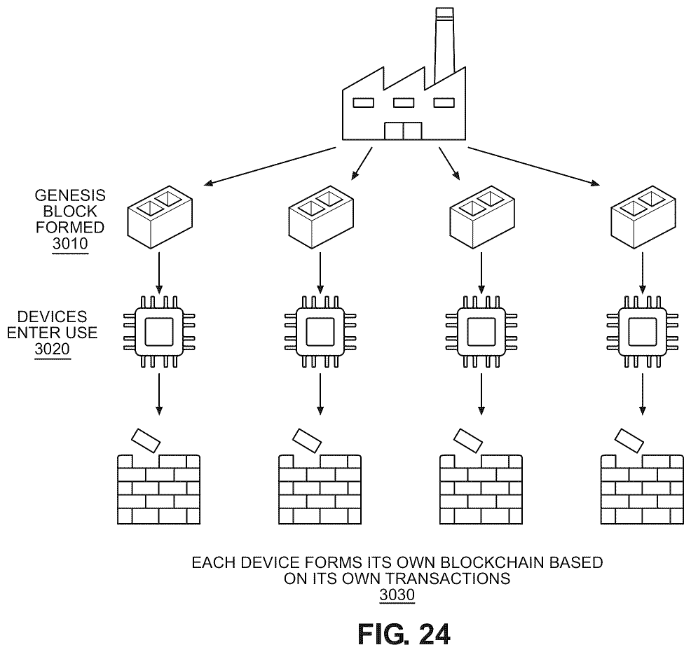

Referring to FIG. 24, a diagram illustrating a process for generating blocks of a blockchain is provided, according to at least some example embodiments. The blockchain (e.g., a single blockchain) may be specific to only one aerosol-generating device 100. The blockchain may be replicated on the companion application and/or the cloud system 2910. A first block of the blockchain (e.g., a genesis block) may be formed when the aerosol-generating device 100 is created (e.g., manufactured) in operation 3010. After the aerosol-generating device 100 enters use in operation 3020, subsequent blocks for the blockchain may be used to store transactions/events (e.g., indications of transactions) that occur with respect to the aerosol-generating device 100. For example, such transactions may include, but are not limited to, activation of a capsule (e.g., insertion of a new capsule), performance of an age verification process, a behavior score reaching a disablement/lockout behavior threshold, etc. The aerosol-generating device 100 may generate a new block to be added to the blockchain in response to a set or alternatively, given number of transactions having been performed (e.g., at an example rate of one block per week) in operation 3030. The new block may represent each of the transactions in the set. According to at least some example embodiments, the companion application may be usable as a portal for validating blocks (e.g., as discussed further below by, for example, calculating a proof), and may store and/or replicate the blockchain.

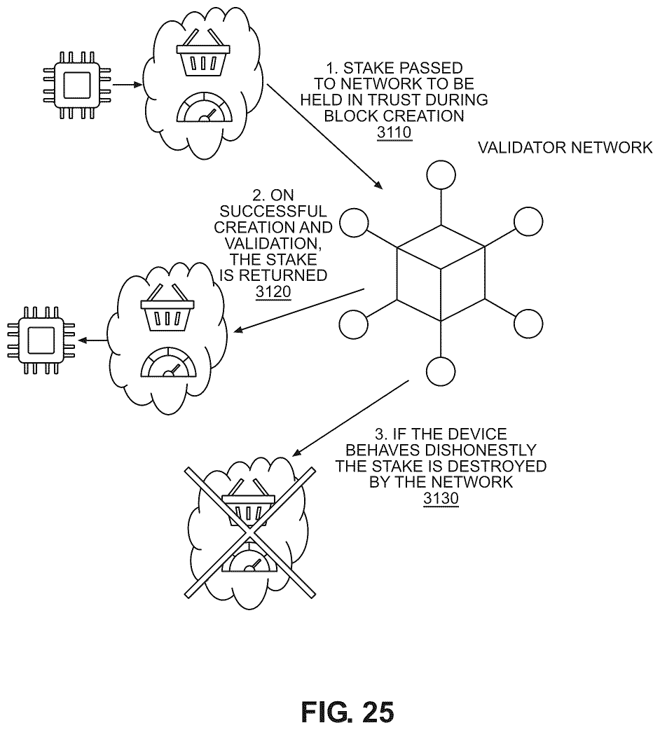

Referring to FIG. 25, a diagram illustrating a process for implementing a proof-of-stake blockchain validation is provided, according to at least some example embodiments. According to at least some example embodiments, the blockchain may be validated according to a proof-of-stake approach (e.g., rather than a proof-of-work approach). In accordance with this proof-of-stake approach, each validation node (e.g., the companion application) may stake a device's (e.g., the aerosol-generating device's) behavior score and remaining capsules when operating as a validator. For example, the device's stake (e.g., the behavior score and remaining capsules), or a representation thereof, may be provided to a network (e.g., the cloud system 2910 and/or a server contained thereof) in operation 3110. In operation 3120, if the device successfully creates and validates a new block of the blockchain, the stake (or the representation thereof) is returned to the device from the network.

However, if the validation node is determined to have behaved dishonestly during the creation of a block (e.g., such as by modifying a previous block, submitting contradictory attestations, submitting multiple blocks at once to equivocate, etc.), the device's behavior score and remaining capsules are forfeited (e.g., rendering the device unusable) in operation 3130. For example, in a scenario in which the companion application is operating as a validator and is determined to have behaved dishonestly while creating a new block to be added to the blockchain, the aerosol-generating device 100 may be disabled (e.g., by one or more among the companion application or the aerosol-generating device 100) and any remaining capsules of the aerosol-generating device 100 may be rendered unusable (e.g., by one or more among the companion application or the aerosol-generating device 100).

For instance, when a new capsule is inserted into the aerosol-generating device 100, the aerosol-generating device 100 may read the capsule's tag to obtain identification information for other capsules in the same (or a similar) container that held the new capsule. The identification information of the other capsules may be stored in the aerosol-generating device 100, and/or sent to the companion application (e.g., via Bluetooth signal) and stored. The aerosol-generating device 100 and/or the companion application may track which of the capsules from the container have been previously activated, and which are the remaining new capsules. In the event that the remaining capsules are rendered exhausted or inoperable, the aerosol-generating device 100 may not perform an aerosol-generating operation while a capsule is inserted having identification information matching that of an exhausted or inoperable capsule.

According to at least some example embodiments, the aerosol-generating device 100 may remain disabled until further operations were performed to reduce the behavior score. Also, upon return to normal operation, the aerosol-generating device 100 may only perform the aerosol-generating operation with respect to new capsules as the remaining capsules persist in the unusable state. According to at least some example embodiments, the aerosol-generating device 100 may remain disabled perpetually and could not be restored to normal operation with a reduction in the behavior score.

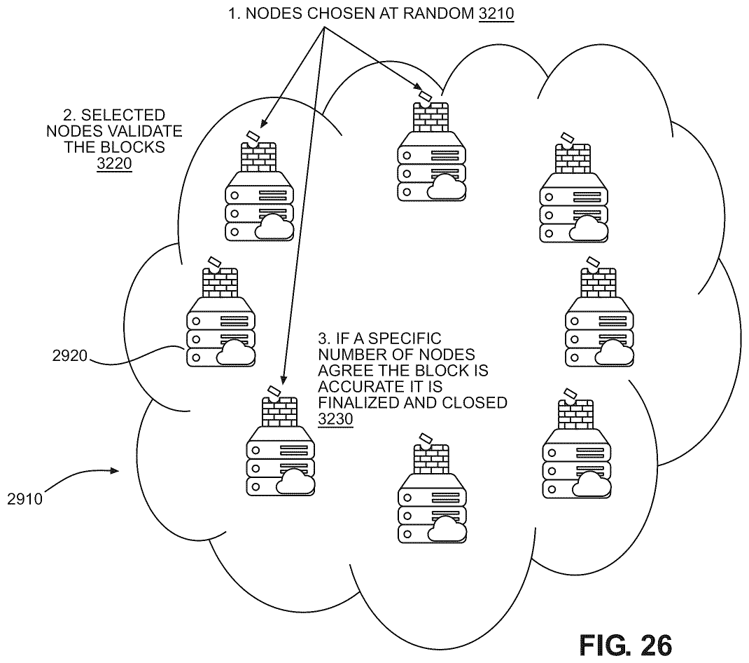

Referring to FIG. 26, a diagram illustrating block validation using the cloud network is provided, according to at least some example embodiments. According to at least some example embodiments, the validation of a block for the blockchain may be performed by multiple validation nodes (e.g., nodes 2920). In operation 3210, the multiple validation nodes may be selected (e.g., by the cloud system 2910 and/or a server contained thereof) from among nodes 2920 of the cloud system 2910. For example, the multiple validation nodes may be selected randomly or pseudo-randomly. In operation 3220, each of the multiple validation nodes may separately validate a block. In operation 3230, validation results of the multiple validation nodes are compared and, if a specific number of validation nodes (e.g., a set or alternatively, given number of validation nodes) agree that the block is accurate, the block is finalized and added to the blockchain in operation 3230. According to at least some example embodiments, one or more other nodes 2920 on the cloud system 2910 may be other aerosol-generating devices and/or corresponding other companion applications. In exchange for operating as validation nodes, the aerosol-generating device 100 (and/or the companion application) and the other aerosol-generating device (and/or other companion applications) may receive vouchers and/or coupons (e.g., for discounted or free capsules) as rewards.

The blockchain implemented as discussed above in connection with FIGS. 22-25 may provide increased security and/or traceability to the transactions of the aerosol-generating device 100. Also, the block validation approach discussed above may be less energy intensive than other approaches, and thus, may reduce power consumption of the aerosol-generating device 100 and/or UE 1510.

Illustrative Embodiment 1. A device, comprising: memory configured to store computer-readable instructions; and processing circuitry configured to execute the computer-readable instructions which causes the device to, determine a plurality of behavior metrics based on behavior information, determine a probability that a current operator of an aerosol-generating device is an authorized operator based on the plurality of behavior metrics, and disable an aerosol-generation operation of the aerosol-generating device in response to determining the probability is less than a threshold.

Illustrative Embodiment 2. The device of illustrative embodiment 1, wherein the processing circuitry is configured to execute the computer-readable instructions which causes the device to: collect new behavior information; update at least one behavior metric among the plurality of behavior metrics based on the new behavior information to obtain an updated at least one behavior metric; and decrease or increase the probability based on the updated at least one behavior metric.

Illustrative Embodiment 3. The device of illustrative embodiments 1 or 2, wherein the processing circuitry is configured to execute the computer-readable instructions which causes the device to: determine the plurality of behavior metrics including determining whether a set period of time has elapsed; and determine the probability including decreasing the probability in response to determining that the set period of time has elapsed.

Illustrative Embodiment 4. The aerosol-generating device of any one of illustrative embodiments 1-3, wherein the processing circuitry is configured to execute the computer-readable instructions which causes the device to: receive an age verification indication that an age verification of the authorized operator has been successfully performed; determine the plurality of behavior metrics including determining whether the age verification indication has been received; and determine the probability including increasing the probability in response to determining that the age verification indication has been received.

Illustrative Embodiment 5. The aerosol-generating device of any one of illustrative embodiments 1-4, wherein the processing circuitry is configured to execute the computer-readable instructions which causes the device to: receive capsule information corresponding to a capsule inserted into the aerosol-generating device; determine the plurality of behavior metrics including determining whether the capsule is genuine based on the capsule information; and determine the probability including, increasing the probability in response to determining that the capsule is genuine, and decreasing the probability in response to determining that the capsule is not genuine.

Illustrative Embodiment 6. The device of any one of illustrative embodiments 1-5, wherein the memory is further configured to store an operating pattern model, the operating pattern model generated based on a historical operating pattern of the aerosol-generating device; and the processing circuitry is configured to execute the computer-readable instructions which causes the device to, determine the plurality of behavior metrics including determining whether a recent operating pattern of the aerosol-generating device matches the operating pattern model, and determine the probability including decreasing the probability in response to determining that the recent operating pattern does not match the operating pattern model.

Illustrative Embodiment 7. The device of any one of illustrative embodiments 1-6, wherein the processing circuitry is configured to execute the computer-readable instructions which causes the device to: receive capsule information corresponding to a capsule inserted into the aerosol-generating device, the capsule information including an indication of whether the capsule was purchased from a trusted entity; determine the plurality of behavior metrics including determining whether the capsule was purchased from the trusted entity based on the capsule information; and determine the probability including, increasing the probability in response to determining that the capsule was purchased from the trusted entity, and decreasing the probability in response to determining that the capsule was not purchased from the trusted entity.

Illustrative Embodiment 8. The device of any one of illustrative embodiments 1-7, wherein the memory is further configured to store a plurality of identifiers, the plurality of identifiers corresponding to first communication signals transmitted by first communication networks or first communication-enabled devices; and the processing circuitry is configured to execute the computer-readable instructions which causes the device to, obtain signal traffic information corresponding to second communication signals transmitted by second communication networks or second communication-enabled devices, determine the plurality of behavior metrics including determining whether the signal traffic information corresponds to the plurality of identifiers, and determine the probability includes decreasing the probability in response to determining that the signal traffic information does not correspond to the plurality of identifiers.

Illustrative Embodiment 9. The device of any one of illustrative embodiments 1-8, wherein the processing circuitry is configured to execute the computer-readable instructions which causes the device to: determine the plurality of behavior metrics including determining whether the aerosol-generating device has connected with an application operating on an external device; and determine the probability including decreasing the probability in response to determining that the aerosol-generating device has not connected with the application.

Illustrative Embodiment 10. The device of any one of illustrative embodiments 1-9, wherein the threshold is a first threshold; and the processing circuitry is configured to execute the computer-readable instructions which causes the device to: disable the aerosol-generation operation in response to determining the probability is below the first threshold, output a notification, or reduce a capability of the aerosol-generating device, in response to determining that the probability is greater than the first threshold and less than a second threshold, the second threshold being greater than the first threshold, and enable the aerosol-generation operation in response to determining that the probability is greater than the second threshold.

Illustrative Embodiment 11. A method for controlling an aerosol-generating device, the method comprising: determining a plurality of behavior metrics based on behavior information; determining a probability that a current operator of the aerosol-generating device is an authorized operator based on the plurality of behavior metrics; and disabling an aerosol-generation operation of the aerosol-generating device in response to determining the probability is less than a threshold.

Illustrative Embodiment 12. The method of illustrative embodiment 11, further comprising: collecting new behavior information; updating at least one behavior metric among the plurality of behavior metrics based on the new behavior information to obtain an updated at least one behavior metric; and decreasing or increasing the probability based on the updated at least one behavior metric.

Illustrative Embodiment 13. The method of illustrative embodiments 11 or 12, wherein the determining the plurality of behavior metrics includes determining whether a set period of time has elapsed; and the determining the probability includes decreasing the probability in response to determining that the set period of time has elapsed.

Illustrative Embodiment 14. The method of any one of illustrative embodiments 11-13, wherein the determining the plurality of behavior metrics includes determining whether an age verification of the authorized operator has been successfully performed; and the determining the probability includes increasing the probability in response to determining that the age verification has been successfully performed.

Illustrative Embodiment 15. The method of any one of illustrative embodiments 11-14, wherein the new behavior information further includes capsule information corresponding to a capsule inserted into the aerosol-generating device; the determining the plurality of behavior metrics includes determining whether the capsule is genuine based on the capsule information; and the determining the probability includes, increasing the probability in response to determining that the capsule is genuine, and decreasing the probability in response to determining that the capsule is not genuine.

Illustrative Embodiment 16. The method of any one of illustrative embodiments 11-15, wherein the new behavior information further includes a recent operating pattern of the aerosol-generating device; the determining the plurality of behavior metrics includes determining whether the recent operating pattern matches an operating pattern model stored on the aerosol-generating device, the operating pattern model being generated based on a historical operating pattern of the aerosol-generating device; and the determining the probability includes decreasing the probability in response to determining that the recent operating pattern does not match the operating pattern model.

Illustrative Embodiment 17. The method of any one of illustrative embodiments 11-16, wherein the new behavior information includes capsule information corresponding to a capsule inserted into the aerosol-generating device; the determining the plurality of behavior metrics includes determining whether the capsule was purchased from a trusted entity based on the capsule information; and the determining the probability includes, increasing the probability in response to determining that the capsule was purchased from the trusted entity, and decreasing the probability in response to determining that the capsule was not purchased from the trusted entity.

Illustrative Embodiment 18. The method of any one of illustrative embodiments 11-17, further comprising: obtaining signal traffic information corresponding to first communication signals transmitted by first communication networks or first communication-enabled devices, wherein the determining the plurality of behavior metrics includes determining whether the signal traffic information corresponds to a plurality of identifiers stored on the aerosol-generating device, the plurality of identifiers corresponding to second communication signals transmitted by second communication networks or second communication-enabled devices, and the determining the probability includes decreasing the probability in response to determining that the signal traffic information does not correspond to the plurality of identifiers stored on the aerosol-generating device.

Illustrative Embodiment 19. The method of any one of illustrative embodiments 11-18, wherein the determining the plurality of behavior metrics includes determining whether the aerosol-generating device has connected with an application operating on an external device; and the determining the probability includes decreasing the probability in response to determining that the aerosol-generating device has not connected with the application.

Illustrative Embodiment 20. The method of any one of illustrative embodiments 11-19, wherein the threshold is a first threshold; the disabling includes disabling the aerosol-generation operation in response to determining the probability is below the first threshold; and the method further comprises, outputting a notification or reducing a capability of the aerosol-generating device in response to determining that the probability is greater than the first threshold and less than a second threshold, the second threshold being greater than the first threshold; and enabling the aerosol-generation operation in response to determining that the probability is greater than the second threshold.

Illustrative Embodiment 21. The device of any one of illustrative embodiments 1-10, wherein the aerosol-generating device comprises a heat-not-burn device.

Illustrative Embodiment 22. The device of any one of illustrative embodiments 1-10, wherein the aerosol-generating device comprises an e-vapor device.

Illustrative Embodiment 23. The device of any one of illustrative embodiments 1-10 or 21-22, wherein the behavior information is collected by the aerosol-generating device.

Illustrative Embodiment 24. The device of any one of illustrative embodiments 1-10 or 21-23, wherein the behavior information is stored in the memory.

Illustrative Embodiment 25. The device of any one of illustrative embodiments 1-10 or 21-24, wherein the device is the aerosol-generating device.

Illustrative Embodiment 26. The method of any one of illustrative embodiments 11-20, wherein the aerosol-generating device comprises a heat-not-burn device.

Illustrative Embodiment 27. The method of any one of illustrative embodiments 11-20, wherein the aerosol-generating device comprises an e-vapor device.

Illustrative Embodiment 28. The method of any one of illustrative embodiments 11-20 or 26-27, wherein the behavior information is collected by the aerosol-generating device.

Illustrative Embodiment 29. The method of any one of illustrative embodiments 11-20 or 26-28, wherein the method is performed by the aerosol-generating device.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with at least some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

At least some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

While some example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

Although described with reference to specific examples and drawings, modifications, additions and substitutions of example embodiments may be variously made according to the description by those of ordinary skill in the art. For example, the described techniques may be performed in an order different with that of the methods described, and/or elements such as the described system, architecture, devices, circuit, and the like, may be connected or combined to be different from the above-described methods, or results may be appropriately achieved by other elements or equivalents.

1. A device, comprising:
memory configured to store computer-readable instructions; and
processing circuitry configured to execute the computer-readable instructions which causes the device to,
determine a plurality of behavior metrics based on behavior information,
determine a probability that a current operator of an aerosol-generating device is an authorized operator based on the plurality of behavior metrics, and
disable an aerosol-generation operation of the aerosol-generating device in response to determining the probability is less than a threshold.

2. The device of claim 1, wherein the processing circuitry is configured to execute the computer-readable instructions which causes the device to:
collect new behavior information;
update at least one behavior metric among the plurality of behavior metrics based on the new behavior information to obtain an updated at least one behavior metric; and
decrease or increase the probability based on the updated at least one behavior metric.

3. The device of claim 2, wherein the processing circuitry is configured to execute the computer-readable instructions which causes the device to:
determine the plurality of behavior metrics including determining whether a set period of time has elapsed; and
determine the probability including decreasing the probability in response to determining that the set period of time has elapsed.

4. The aerosol-generating device of claim 2, wherein the processing circuitry is configured to execute the computer-readable instructions which causes the device to:
receive an age verification indication that an age verification of the authorized operator has been successfully performed;
determine the plurality of behavior metrics including determining whether the age verification indication has been received; and
determine the probability including increasing the probability in response to determining that the age verification indication has been received.

5. The aerosol-generating device of claim 2, wherein the processing circuitry is configured to execute the computer-readable instructions which causes the device to:
receive capsule information corresponding to a capsule inserted into the aerosol-generating device;
determine the plurality of behavior metrics including determining whether the capsule is genuine based on the capsule information; and
determine the probability including,
increasing the probability in response to determining that the capsule is genuine, and
decreasing the probability in response to determining that the capsule is not genuine.

6. The device of claim 2, wherein
the memory is further configured to store an operating pattern model, the operating pattern model generated based on a historical operating pattern of the aerosol-generating device; and
the processing circuitry is configured to execute the computer-readable instructions which causes the device to,
determine the plurality of behavior metrics including determining whether a recent operating pattern of the aerosol-generating device matches the operating pattern model, and
determine the probability including decreasing the probability in response to determining that the recent operating pattern does not match the operating pattern model.

7. The device of claim 2, wherein the processing circuitry is configured to execute the computer-readable instructions which causes the device to:
receive capsule information corresponding to a capsule inserted into the aerosol-generating device, the capsule information including an indication of whether the capsule was purchased from a trusted entity;
determine the plurality of behavior metrics including determining whether the capsule was purchased from the trusted entity based on the capsule information; and
determine the probability including,
increasing the probability in response to determining that the capsule was purchased from the trusted entity, and
decreasing the probability in response to determining that the capsule was not purchased from the trusted entity.

8. The device of claim 2, wherein
the memory is further configured to store a plurality of identifiers, the plurality of identifiers corresponding to first communication signals transmitted by first communication networks or first communication-enabled devices; and
the processing circuitry is configured to execute the computer-readable instructions which causes the device to,
obtain signal traffic information corresponding to second communication signals transmitted by second communication networks or second communication-enabled devices,
determine the plurality of behavior metrics including determining whether the signal traffic information corresponds to the plurality of identifiers, and
determine the probability includes decreasing the probability in response to determining that the signal traffic information does not correspond to the plurality of identifiers.

9. The device of claim 2, wherein the processing circuitry is configured to execute the computer-readable instructions which causes the device to:
determine the plurality of behavior metrics including determining whether the aerosol-generating device has connected with an application operating on an external device; and
determine the probability including decreasing the probability in response to determining that the aerosol-generating device has not connected with the application.

10. The device of claim 1, wherein
the threshold is a first threshold; and
the processing circuitry is configured to execute the computer-readable instructions which causes the device to:
disable the aerosol-generation operation in response to determining the probability is below the first threshold,
output a notification, or reduce a capability of the aerosol-generating device, in response to determining that the probability is greater than the first threshold and less than a second threshold, the second threshold being greater than the first threshold, and
enable the aerosol-generation operation in response to determining that the probability is greater than the second threshold.

11. A method for controlling an aerosol-generating device, the method comprising:
determining a plurality of behavior metrics based on behavior information;
determining a probability that a current operator of the aerosol-generating device is an authorized operator based on the plurality of behavior metrics; and
disabling an aerosol-generation operation of the aerosol-generating device in response to determining the probability is less than a threshold.

12. The method of claim 11, further comprising:
collecting new behavior information;
updating at least one behavior metric among the plurality of behavior metrics based on the new behavior information to obtain an updated at least one behavior metric; and
decreasing or increasing the probability based on the updated at least one behavior metric.

13. The method of claim 12, wherein
the determining the plurality of behavior metrics includes determining whether a set period of time has elapsed; and
the determining the probability includes decreasing the probability in response to determining that the set period of time has elapsed.

14. The method of claim 12, wherein
the determining the plurality of behavior metrics includes determining whether an age verification of the authorized operator has been successfully performed; and
the determining the probability includes increasing the probability in response to determining that the age verification has been successfully performed.

15. The method of claim 12, wherein
the new behavior information further includes capsule information corresponding to a capsule inserted into the aerosol-generating device;
the determining the plurality of behavior metrics includes determining whether the capsule is genuine based on the capsule information; and
the determining the probability includes,
increasing the probability in response to determining that the capsule is genuine, and
decreasing the probability in response to determining that the capsule is not genuine.

16. The method of claim 12, wherein
the new behavior information further includes a recent operating pattern of the aerosol-generating device;
the determining the plurality of behavior metrics includes determining whether the recent operating pattern matches an operating pattern model stored on the aerosol-generating device, the operating pattern model being generated based on a historical operating pattern of the aerosol-generating device; and
the determining the probability includes decreasing the probability in response to determining that the recent operating pattern does not match the operating pattern model.

17. The method of claim 12, wherein
the new behavior information includes capsule information corresponding to a capsule inserted into the aerosol-generating device;
the determining the plurality of behavior metrics includes determining whether the capsule was purchased from a trusted entity based on the capsule information; and
the determining the probability includes,
increasing the probability in response to determining that the capsule was purchased from the trusted entity, and
decreasing the probability in response to determining that the capsule was not purchased from the trusted entity.

18. The method of claim 12, further comprising:
obtaining signal traffic information corresponding to first communication signals transmitted by first communication networks or first communication-enabled devices, wherein
the determining the plurality of behavior metrics includes determining whether the signal traffic information corresponds to a plurality of identifiers stored on the aerosol-generating device, the plurality of identifiers corresponding to second communication signals transmitted by second communication networks or second communication-enabled devices, and
the determining the probability includes decreasing the probability in response to determining that the signal traffic information does not correspond to the plurality of identifiers stored on the aerosol-generating device.

19. The method of claim 12, wherein
the determining the plurality of behavior metrics includes determining whether the aerosol-generating device has connected with an application operating on an external device; and
the determining the probability includes decreasing the probability in response to determining that the aerosol-generating device has not connected with the application.

20. The method of claim 11, wherein
the threshold is a first threshold;
the disabling includes disabling the aerosol-generation operation in response to determining the probability is below the first threshold; and
the method further comprises,
outputting a notification or reducing a capability of the aerosol-generating device in response to determining that the probability is greater than the first threshold and less than a second threshold, the second threshold being greater than the first threshold; and
enabling the aerosol-generation operation in response to determining that the probability is greater than the second threshold.
